(19) United States
(12) Patent Application Publication
(10) Pub. No.: US 2006/0224496 A1
(43) Pub. Date: Oct. 5, 2006

(54) System for and method of expressive sequential auctions in a dynamic environment on a network

(75) Inventors: Tuomas Sandholm, Pittsburgh, PA (US); David C. Parkes, Cambridge, MA (US); Craig E. Boutilier, Toronto (CA)

Correspondence Address: THE WEBB LAW FIRM, P.C., 700 KOPPERS BUILDING, 436 SEVENTH AVENUE, PITTSBURGH, PA, 15219, US

(73) Assignee: CombineNet, Inc., Pittsburgh, PA (US)

(21) Appl. No.: 11/396,410

(22) Filed: Mar. 31, 2006

Related U.S. Application Data
(60) Provisional application No. 60/667,249, filed on Mar. 31, 2005.
(60) Provisional application No. 60/680,894, filed on May 13, 2005.
(60) Provisional application No. 60/697,775, filed on Jul. 8, 2005.

(51) Int. Cl. G06Q 40/00

(52) U.S. Cl. 705/37

(57) ABSTRACT

In an on-line ad auction, bids for the right to display at least one advert on a display of a computer of a computer network in response to the bid being allocated a query received from the computer are received via a computer network. At a time t, at least one rule or decision variable for allocating queries to bids is determined based on the bids received before time t and an estimate of at least one of: an estimate of queries to be received after time t; an estimate of events to occur in response to the display of adverts after time t; and/or an estimate of bids to be received after time t. After time t, a query received from the computer is allocated to at least one of the received bids based on the at least one rule or decision variable.

### CROSS REFERENCE TO RELATED APPLICATIONS

The present application claims priority from U.S. Provisional Patent Application No. 60/667,249, filed Mar. 31, 2005, 60/680,894, filed May 13, 2005, and 60/697,775, filed Jul. 8, 2005, all of which are incorporated herein by reference.

### FIELD OF THE INVENTION

The present invention relates to expressive auctions for the allocation of differentiated supply in dynamic environments with uncertainty about future supply and future demand. The invention will be disclosed for the context of ad auctions, i.e. auctions for the display of advertisements on computer devices, but applies more broadly.

### DESCRIPTION OF RELATED ART

Contextual information about a user that describes what a user is currently looking for and thinking about when online is valuable for advertisers. Search engines provide valuable contextual information, because a user directly submits information that relates to her context via keywords included in a query. Electronic auctions can be used to allocate the right to display an advert to a user, with bidders competing to have an advert displayed and determining their bid price based on keywords used in a search query.

The prior art, as implemented for example by Google, is for a bidder to state maximal willingness-to-pay per click-through for different keyword queries. Current forms of expressiveness are limited in allowing bidders to describe values per unit of allocation, i.e. a language is provided to allow a bidder to express her willingness-to-pay for different search terms in a query. However, the only sequential expressiveness provided in the prior art is that related to budget constraints. Namely, a bidder is able to place a constraint on the total amount she is willing to spend, perhaps defined in some temporal way, e.g. “I will pay $0.10 for each query with search terms “basketball+betting” but no more than $200 each 24 hours. In other words, expressiveness is at the level of an individual search.

Whether or not a bid will be allocated a query depends on the probability of click-through, which is information that the search engine auctioneer has via statistical modeling. Based on this modeling, bids are typically prioritized in terms of the expected revenue that they will generate, whereupon bids that will generate higher revenue are preferentially allocated queries over bids that will generate lower revenue. Supply of queries in ad auctions can be modeled in terms of either exposure, i.e. the number of times an advert is displayed to a user, or click-through, i.e. the number of times an advert is clicked-on by a web user.

A typical bid defines the context in which the bid is valid, via keywords, a bid price which defines the maximal amount that will be paid in the case of an exposure or click-through, and a list of negative words that disqualify a bid from consideration for a particular query. While a bidder can submit multiple such bids, the expressiveness on individual queries is limited.

It would be desirable to provide a new bid language that is more expressive, and new forms of expressiveness in ad auctions that enables expressiveness at the level of an advertising campaign, versus at the level of individual searches. It would also be desirable to provide a new architecture for optimizing decisions about which queries to allocated to which bidder in a dynamic environment, wherein long-term optimization problems are solved periodically within a so called optimizer module to facilitate short-term decision making within a so called dispatcher module.

### SUMMARY OF THE INVENTION

The present invention is a method of conducting an ad auction comprising: (a) receiving a plurality of bids via a computer network, wherein: each bid is for the right to display at least one advert associated with the bid on at least one display of the computer network in response to the bid being allocated at least one query; each bid includes at least one word, term, phrase or string of characters that is used as a basis for allocating at least one query to the bid; and each bid further includes at least one constraint on a sequential allocation of queries to the bid; (b) determining at time t at least one rule or decision variable for allocating queries to bids, wherein the at least one rule or decision variable is determined based on the bids received before time t and at least one of the following: an estimate of queries to be received after time t; an estimate of events to occur in response to the display of adverts after time t; and/or an estimate of bids to be received after time t; (c) receiving a query via the computer network after time t; and (d) allocating the query received in step (c) to at least one of the bids based on the at least one rule or decision variable and the at least one word, term, phrase or string of characters.

The method can include (e) in response to allocating the query in step (d) and in response to the satisfaction of the at least one constraint, causing an advert associated with the bid allocated the query to be displayed on the display.

Step (d) can include allocating the query to a plurality of bids. Step (e) can include displaying an advert associated with each bid allocated the query on the display.

At least one advert can be displayed at a position on the display based on a position constraint associated with the bid that is associated with the advert.

The query can include at least one of the following properties: at least one word, term, phrase or string of characters; time of day; date; and demographic data regarding a submitter of the query. The allocation in step (d) can be further based on at least one of the properties of the query.

Step (c) can include sequentially receiving at least one query via each of a plurality of different displays of the computer network during a time period p. Step (d) can include allocating each sequentially received query to at least one of the bids during the time period p. Step (e) can include causing an advert associated with each bid allocated at least one sequentially received query to be displayed on the display of the computer from which the query was received. The method can further include (f) repeating step (b) at least once during the time period p to determine at least one new rule or decision variable that is utilized for allocating a query received after said at least one new rule or decision variable has been determined.

In step (d) each sequentially received query can be allocated substantially in real-time.

Each bid can have associated therewith at least one word, term, phrase or string of characters that is used as a basis for allocating a query to the bid; and at least one of the following: at least one constraint on the bid; and a value for at least one of the following: for causing at least one advert associated with the bid to be displayed; or for receiving a click-through on at least one advert associated with the bid that was caused to be displayed in response to the allocation of a query to the bid.

The at least one constraint can include at least one of the following: an aggregate volume constraint on the total volume of queries that can be allocated to the bid; a temporal constraint on the bid or on one or more constraints associated with the bid; a demographic constraint on the demographic(s) of a user of the computer that must be valid for a query received from the computer to be allocated to the bid; a budget constraint on the payment of a total value associated with the bid; a frequency constraint on the frequency that queries are allocated to the bid; a joint allocation constraint on the allocation of one or more queries to the bid based on the allocation of said one or more queries to at least one other bid; a user volume constraint that has at least one prerequisite that must be satisfied as a condition to payment of the value; a query volume constraint that has at least one prerequisite that must be satisfied as a condition to payment of the value; and a value-adjustment constraint that has at least one prerequisite that must be satisfied as a condition to adjusting the value.

A payment associated with a bid can be determined based on the value associated with the bid, and a least one of the following: (a) a number of queries allocated to the bid; (b) a value associated with at least one other bid; (c) at least one constraint associated with the bid. The payment associated with the bid can include at least one of the following: a fixed payment, a payment that changes incrementally with each allocation, and a payment that changes in response to satisfaction of the at least one constraint.

The method can further include at least one seller (i.e., an entity that receives payment in response to allocating queries to bids) determining at least one of the following on the sequential allocation of queries to at least one bid: at least one constraint on at least one attribute of at least one bidder; at least one constraint on at least one property of a query; at least one temporal constraint; at least one volume constraint; at least one frequency constraint; and a value for satisfying at least one constraint on the sequence of allocations of queries.

The user volume constraint can include the prerequisite that a user of the computer submit a predetermined number of queries, each of which can include at least one word, term, phrase and/or string of characters of a predetermined set of word(s), term(s), phrase(s) and/or string(s) of characters, as a condition of payment of the value.

The query volume constraint can include the prerequisite that the bid be allocated a number of queries that is greater than, less than and/or equal to a predetermined number of queries or a predetermined percentage of queries received from computers of the computer network as a condition of payment of the value.

The predetermined percentage of queries can be queries in a particular class.

The query volume constraint can be used in combination with the temporal constraint that prerequisites that the bid be allocated queries during a predetermined period of time.

The at least one word, term, phrase or string of characters can include at least one of the following: a first set of word(s), term(s), phrase(s) and/or string(s) of characters that a query must contain for it to be allocated to the bid; a second set of word(s), term(s), phrase(s) and/or string(s) of characters that the query may contain for it to be allocated to the bid; and a third set of word(s), term(s), phrase(s) and/or string(s) of characters that disqualify the query from being allocated to the bid.

The string(s) of characters of at least one of the first, second and third sets can include a URL.

The one or more constraints can include a bonus value constraint that prerequisites the payment of a bonus value included in the bid on at least one query allocated to the bid having at least one word, term, phrase and/or string of characters that is also in the second set of word(s), term(s), phrase(s) and/or string(s) of characters.

The at least one rule or decision variable can include at least one of the following parameters: a budget target for a total payment associated with at least one bid; a query volume target associated with a predetermined number of queries to be allocated to at least one bid; a virtual price associated with at least one bid; and at least one weight associated with at least one bid to adjust a priority assigned to the bid for making an allocation of a query to the bid. The allocation in step (d) can be made based on an auction for the query that is based on at least one of the parameters.

The at least one rule or decision variable can include at least one rule for allocating a first percentage of the queries to at least one bid of a first set of bids and a second percentage of the queries to at least one bid of a second set of bids. Each bid of the first set of bids can require plural allocations of queries to satisfy its constraint(s). Each bid of the second set of bids can require a single query allocation to satisfy its constraint(s). Step (d) can include allocating the query to either a bid of the first set of bids or a bid of the second set of bids based on the at least one rule for allocating. When the query is allocated to a bid of the second set of bids, said allocation can be made based on an auction among bids of the second set of bids.

The at least one rule or decision variable can include a plurality of rules for allocating a first percentage of the queries to at least one bid of a first set of bids and a second percentage of the queries to at least one bid of a second set of bids. Each bid of the first set of bids can require plural allocations of queries to satisfy its constraint(s). Each bid of the second set of bids can require a single query allocation to satisfy its constraint(s). Step (d) can include allocating the query to either a bid of the first set of bids or a bid of the second set of bids based on at least one of the plurality of rules, the selection of which is contingent on events caused by allocation(s) occurring after time t and before allocation of the query. When the query is allocated to a bid of the second set of bids, said allocation can be made based on an auction among bids of the second set of bids.

The at least one rule or decision variable can include at least one of the following: a value schedule to be associated with a bid that conditions the total value of the bid on the fractional allocation of the total supply of queries, over some period of time; a value schedule to be associated with a bid that conditions the total value of the bid on the uniform fractional allocation of the total supply of queries, over some period of time; and/or a value schedule that is contingent on events caused by allocation. The allocation in step (d) can be made based on at least one of the value schedules.

The invention is also a method of conducting an ad auction comprising: (a) receiving via a computer network a bid for the right to display at least one advert associated with the bid on a display of a computer of the computer network in response to the bid being allocated a query received from the computer, wherein said bid includes a value and a constraint that prerequisites payment of the value based on satisfaction of a condition associated with the constraint; (b) receiving queries from computers of the computer network; (c) allocating a subset of the received queries to the bid; and (d) making or withholding payment of the value based on the condition being satisfied or dissatisfied, respectively.

The condition can require the bid be allocated some number of queries that is greater than, less than and/or equal to a predetermined number of queries or a predetermined percentage of a total number of queries received from computers of the computer network.

The bid can further include at least one of the following: a constraint that queries be allocated to the bid only during a predetermined period of time; and a constraint that only queries in a predetermined query class be allocated to the bid.

Step (c) can include allocating the subset of queries to the bid based on at least one rule or decision variable, wherein the at least one rule or decision variable is determined based on: bids received before the queries in step (b); and at least one of the following: an estimate of queries to be received after the at least one rule or decision variable is determined; an estimate of click-throughs on adverts to be displayed after the at least one rule or decision variable is determined; and/or an estimate of the bids to be received after the at least one rule or decision variable is determined.

The invention is also a system of conducting an ad auction that includes: means for electronically receiving a plurality of bids via a computer network, wherein each bid is for the right to display at least one advert associated with the bid on at least one display of the computer network in response to the bid being allocated at least one query; each bid includes at least one word, term, phrase or string of characters that is used as a basis for allocating at least one query to the bid; and each bid further includes at least one constraint on a sequential allocation of queries to the bid; means for electronically determining at a time t at least one rule or decision variable for allocating queries to bids, wherein the at least one rule or decision variable is determined based on the bids received before time t and at least one of the following: an estimate of queries to be received after time t; an estimate of events to occur in response to the display of adverts after time t; and/or an estimate of bids to be received after time t; means for electronically receiving one or more queries via the computer network after time t; and means for electronically allocating each query received after time t to at least one of the bids based on the at least one rule or decision variable and the at least one word, term, phrase or string of characters.

The system can further include means responsive to the allocation of at least one query to at least one bid and to the satisfaction of the at least one constraint associated with the bid for electronically causing an advert associated with the bid to be displayed on the display.

The means for electronically allocating can allocate at least one query to a plurality of bids.

The means for electronically causing an advert to be displayed can cause at least one advert to be displayed at a position on the display based on a position constraint included in the bid associated with the advert.

Each query can include at least one of the following properties: at least one word, term, phrase or string of characters; time of day; date; and demographic information regarding a user of the computer. The means for electronically allocating can allocate each query based on at least one of the properties of the query.

The means for electronically receiving queries can sequentially receives at least one query via each of a plurality of different displays of the computer network during a time period p. The means for electronically allocating can allocate each sequentially received query to at least one of the bids during the time period p. The means for electronically determining can determines at least one new rule or new decision variable during the time period p that the means for electronically allocating utilizes for allocating at least one query received after said at least one new rule or new decision variable has been determined.

The means for electronically allocating can allocate each sequentially received query substantially in real-time.

Each bid can have the following associated therewith that the means for electronically allocating utilizes for allocating each query: at least one word, term, phrase or string of characters that is used as a basis for allocating a query to the bid; and at least one of the following: at least one constraint on the bid; and a value for at least one of the following: for causing at least one advert associated with the bid to be displayed; or for receiving a click-through on at least one advert associated with the bid that was caused to be displayed in response to the allocation of a query to the bid.

The one or more constraints can include at least one of the following: an aggregate volume constraint on the total volume of queries that can be allocated to the bid; a temporal constraint on the bid or on one or more constraints associated with the bid; a demographic constraint on the demographic(s) of a user of the computer that must be valid for a query received from the computer to be allocated to the bid; a budget constraint on the payment of a total value associated with the bid; a frequency constraint on the frequency that queries are allocated to the bid; a joint allocation constraint on the allocation of one or more queries to the bid based on the allocation of said one or more queries to at least one other bid; a user volume constraint that has at least one prerequisite that must be satisfied as a condition to payment of the value; a query volume constraint that has at least one prerequisite that must be satisfied as a condition to payment of the value; and a value-adjustment constraint that has at least one prerequisite that must be satisfied as a condition to adjusting the value.

The system can further include means for determining a payment associated with a bid is determined based on the value associated with the bid, and a least one of the following: (a) a number of queries allocated to the bid; (b) a value associated with at least one other bid; (c) at least one constraint associated with the bid, wherein the payment associated with the bid includes at least one of the following: a fixed payment, a payment that changes incrementally with each allocation, and a payment that changes in response to satisfaction of the at least one constraint.

The system can further include means for enabling at least one seller (i.e., an entity that receives payment in response to allocating queries to bids) to impose at least one of the following on the sequential allocation of queries to at least one bid: at least one constraint on at least one attribute of at least one bidder; at least one constraint on at least one property of a query; at least one temporal constraint; at least one volume constraint; at least one frequency constraint; and a value for satisfying at least one constraint on the sequence of allocations of queries, wherein each seller is an entity that receives payment in response to allocating queries to bids.

The user volume constraint can include the prerequisite that a user of the computer submit a predetermined number of queries, each of which can include at least one word, term, phrase and/or string of characters of a predetermined set of word(s), term(s), phrase(s) and/or string(s) of characters, as a condition of payment of the value.

The query volume constraint can include the prerequisite that the bid be allocated a number of queries that is greater than, less than and/or equal to a predetermined number of queries or a predetermined percentage of queries received from computers of the computer network as a condition of payment of the value.

The predetermined percentage of queries can be queries in a particular class.

The query volume constraint further can include the prerequisite that the bid be allocated queries during a predetermined period of time.

The at least one word, term, phrase or string of characters can include at least one of the following: a first set of word(s), term(s), phrase(s) and/or string(s) of characters that a query must contain for it to be allocated to the bid; a second set of word(s), term(s), phrase(s) and/or string(s) of characters that the query may contain for it to be allocated to the bid; and a third set of word(s), term(s), phrase(s) and/or string(s) of characters that disqualify the query from being allocated to the bid.

The string(s) of characters of at least one of the first, second and third sets can include a URL.

The at least one constraint can include a bonus value constraint that prerequisites the payment of a bonus value included in the bid on at least one query allocated to the bid having at least one word, term, phrase and/or string of characters that is also in the second set of word(s), term(s), phrase(s) and/or string(s) of characters.

The at least one rule or decision variable can include at least one of the following parameters: a budget target for a total payment associated with at least one bid; a query volume target associated with a predetermined number of queries to be allocated to at least one bid; a virtual price associated with at least one bid; and at least one weight associated with at least one bid to adjust a priority assigned to the bid for making an allocation of a query to the bid. The allocation in step (d) can be made based on an auction for the query that is based on at least one of the parameters.

The at least one rule or decision variable can include at least one rule for allocating a first percentage of the queries to at least one bid of a first set of bids and a second percentage of the queries to at least one bid of a second set of bids. Each bid of the first set of bids can require plural allocations of queries to satisfy its constraint(s). Each bid of the second set of bids can require a single query allocation to satisfy its constraint(s). Step (d) can include allocating the query to either a bid of the first set of bids or a bid of the second set of bids based on the at least one rule for allocating. When the query is allocated to a bid of the second set of bids, said allocation can be made based on an auction among bids of the second set of bids.

The at least one rule or decision variable can include a plurality of rules for allocating a first percentage of the queries to at least one bid of a first set of bids and a second percentage of the queries to at least one bid of a second set of bids. Each bid of the first set of bids can require plural allocations of queries to satisfy its constraint(s). Each bid of the second set of bids can require a single query allocation to satisfy its constraint(s). Step (d) can include allocating the query to either a bid of the first set of bids or a bid of the second set of bids based on at least one of the plurality of rules, the selection of which is contingent on events caused by allocation(s) occurring after time t and before allocation of the query. When the query is allocated to a bid of the second set of bids, said allocation can be made based on an auction among bids of the second set of bids.

The at least one rule or decision variable can include at least one of the following: a value schedule to be associated with a bid that conditions the total value of the bid on the fractional allocation of the total supply of queries, over some period of time; a value schedule to be associated with a bid that conditions the total value of the bid on the uniform fractional allocation of the total supply of queries, over some period of time; and/or a value schedule that is contingent on events caused by allocation. The allocation in step (d) is made based on at least one of the value schedules.

The invention is also a method of conducting an expressive auction in a dynamic environment comprising: (a) receiving a plurality of bids via a computer network, wherein each bid is for the right to be allocated units of a supply of a differentiated resource, wherein each bid further includes at least one constraint on a sequential allocation of units of supply to the bid; (b) determining at a time t at least one rule or decision variable for allocating the units of supply to at least one bid, wherein the at least one rule or decision variable is determined based on bids received before time t and at least one of the following: an estimate of the units of supply to be received after time t; an estimate of events to occur in response to allocation of units of supply after time t; and/or an estimate of bids to be received after time t; (c) following step (b), receiving one or more units of supply; and (d) allocating the one or more units of supply received in step (c) to at least one of the bids based on the at least one rule or decision variable.

The method can further include (e) responsive to allocating the one or more units of supply in step (d) and to satisfaction of the at least one constraint, causing an event to occur.

The invention is also a method of conducting an ad auction comprising: (a) receiving a plurality of bids via a computer network, wherein each bid is for the right to display at least one advert associated with the bid on at least one display of the computer network, and each bid further includes a constraint on a sequential allocation of the right to display based on context data associated with at least one user accessing the computer network to the bid; (b) determining at a time t at least one rule or decision variable for allocating the right to display an advert on at least one display associated with the computer network in response to receiving the context data, wherein the at least one rule or decision variable is determined based on the bids received before time t and at least one of the following: an estimate of context data to be received after time t; an estimate of events to occur in response to displaying adverts after time t; and/or an estimate of bids to be received after time t; (c) following step (b), receiving context data from the computer network; and (d) allocating the right to display based on the context data received in step (d) and the at least one rule or decision variable.

The method can further include (e) responsive to allocating the right to display in step (d) and to satisfaction of the at least one constraint, causing an advert associated with the bid allocated the right to display to be displayed on the display.

The invention is also a method of conducting an ad auction comprising: (a) receiving a plurality of bids via a computer network, wherein each bid is for the right to display at least one advert associated with the bid on at least one display of the computer network, and each bid further includes a constraint on a sequential allocation of the right to display based on content data regarding content begin displayed on a display of the computer network and/or being reproduced by an audio device associated with the display to the bid; (b) determining at a time t at least one rule or decision variable for allocating the right to display an advert on at least one display associated with the computer network in response to receiving the content data, wherein the at least one rule or decision variable is determined based on the bids received before time t and at least one of the following: an estimate of content data to be received after time t; an estimate of events to occur in response to displaying adverts after time t; and/or an estimate of bids to be received after time t; (c) following step (b), receiving content data from the computer network; and (d) allocating the right to display based on the content data received in step (d) and the at least one rule or decision variable.

The method can further include (e) responsive to allocating the right to display in step (d) and to satisfaction of the at least one constraint, causing an advert associated with the bid allocated the right to display to be displayed on the display.

The context data can include data in at least one of the following: a search engine query; an email; and an article.

The at least one rule or decision variable can include at least one of the following parameters: a budget target for a total payment associated with at least one bid; a query volume target associated with a predetermined number of queries to be allocated to at least one bid; a virtual price associated with at least one bid; and at least one weight associated with at least one bid to adjust a priority assigned to the bid for making an allocation of a query to the bid. The allocation in step (d) can be made based on an auction for the query that is based on at least one of the parameters.

The at least one rule or decision variable can include at least one rule for allocating a first percentage of the queries to at least one bid of a first set of bids and a second percentage of the queries to at least one bid of a second set of bids. Each bid of the first set of bids can require plural allocations of queries to satisfy its constraint. Each bid of the second set of bids can require a single query allocation to satisfy its constraint. Step (d) can include allocating the query to either a bid of the first set of bids or a bid of the second set of bids based on the at least one rule for allocating. When the query is allocated to a bid of the second set of bids, said allocation is made based on an auction among bids of the second set of bids.

The at least one rule or decision variable can include a plurality of rules for allocating a first percentage of the queries to at least one bid of a first set of bids and a second percentage of the queries to at least one bid of a second set of bids; each bid of the first set of bids can require plural allocations of queries to satisfy its constraint; and each bid of the second set of bids can require a single query allocation to satisfy its constraint. Step (d) can include allocating the query to either a bid of the first set of bids or a bid of the second set of bids based on at least one of the plurality of rules, the selection of which is contingent on events caused by allocation(s) occurring after time t and before allocation of the query. When the query is allocated to a bid of the second set of bids, said allocation can be made based on an auction among bids of the second set of bids.

The at least one rule or decision variable can include at least one of the following: a value schedule to be associated with a bid that conditions the total value of the bid on the fractional allocation of the total supply of queries, over some period of time; a value schedule to be associated with a bid that conditions the total value of the bid on the uniform fractional allocation of the total supply of queries, over some period of time; and/or a value schedule that is contingent on events caused by allocation. The allocation in step (d) can be made based on at least one of the value schedules.

The invention is also a bidding language for an ad auction comprising: at least one query, each query having associated therewith at least one of the following: at least one word, term, phrase or string of characters; time of day; date; and demographic information; and at least one bid, each bid having associated therewith: at least one advert for display on a display of a computer in response to allocation of at least one query to the bid; a value; and a constraint that prerequisites payment of the value based on satisfaction of a condition associated with the constraint.

Lastly, the invention is a user interface for an ad auction displayable on the display of each of a plurality of bidder's computer of a computer network having a server computer, said user interface for enabling a user of the corresponding bidder's computer to create at least one bid for processing by the server computer, the user interface comprising at least one data entry field for: associating at least one word, term, phrase or string of characters with the bid; associating with the bid at least one advert for display on the display of a query computer in response to allocation of at least one query received from the query computer to the bid based on the at least one word, term, phrase or string of characters associated with the bid; associating a value with the bid; and associating with the bid a constraint on allocation of the bid.

### BRIEF DESCRIPTION OF THE DRAWINGS

FIG. 1 is a schematic illustration of a computer system which implements computer software embodying the present invention;

FIG. 2 is a schematic illustration of a computer network including bidder computers and query computers connected to a server computer, wherein each computer of the computer network can be one of the type shown in FIG. 1;

FIG. 3 is a diagrammatic illustration of an exemplary user interface and related bid data that can be displayed on a display of a bidder computer of the computer network of FIG. 2;

FIG. 4 is a diagrammatic illustration of an exemplary user interface and related query data that can be submitted to the server computer by one of the query computers of the computer network shown in FIG. 2;

FIG. 5 is an exemplary Google search results page including search results and adverts on opposite sides thereof; and

FIG. 6 is a schematic illustration of an optimizer module and a dispatcher module implemented within server computer 24.

### DETAILED DESCRIPTION OF THE INVENTION

The present invention brings the benefits of expressive markets (improved efficiency, simplified bidding experience, improved seller revenue) to dynamic environments, in which there is both uncertain supply and uncertain demand and the clearing rules of the markets are designed to provide optimizing behavior, such as maximizing the expected revenue of a seller.

The types of expressiveness described hereinafter allows bidders to express the desirability of properties and events associated with an entire sequence of allocations over multiple periods rather than with individual allocations within a single period as is the case of the prior art.

Motivating applications for expressive sequential auctions include, but are not limited to: (ad-auctions) the allocation of the right to display adverts on web browsers alongside the results from a search engine such as the Internet; (flexible-manufacturing) auctions for the allocation of flexible manufacturing capacity to competing firms; (on-demand computing) auctions for the allocation of computational and network resources to bidders, e.g., the dynamic allocation of a server farm in support of the e-commerce business of various bidders; and (virtual organizations) auctions for the allocation of temporary staff to various clients of a staffing agency.

The ad-auctions example will be adopted for illustrative purposes hereinafter but is not to be construed as limiting the invention. For the purpose of describing the invention, units of supply are queries, which are search queries executed in a search engine by a user. Bidders are advertisers, wishing to manage an advertising campaign and with willingness-to-pay (or bid values) that depend on properties of the sequence of queries assigned within the auction. For example, a bidder might be willing to pay $500 for a campaign in which 500 queries with property P₁ (including key-words, location of user, socio-economic attributes, etc.) are assigned (or allocated) during week one and then 500 queries with property P₂ are assigned (or allocated) during week two. A seller in the application of ad auctions is a party such as Google or Yahoo, or a third party serving content that is used to provide context information to guide the provision of adverts in the web browsers of its customers.

Since the supply of queries in a dynamic environment is uncertain and realized online, specific queries cannot be allocated to bids in advance. For instance, if a bidder requests the allocation of K queries satisfying a certain property P (e.g., queries for “football+betting”) during some time period T (e.g., 9 am-10 am), the auction cannot categorically assign this supply to the bidder at period T until the actual queries are realized (i.e., received). As a result, the allocation of queries to bids must be realized dynamically online. Any method by which the realized queries at period T are allocated to bids at period T is also called a dispatch method. Dispatch methods can take many forms, for example, a set of simple rules, or a complicated and somewhat computationally intensive algorithm. However it is critical that any dispatch method be implementable in real-time.

The present invention combines periodic, long-term optimization decisions (e.g., a generalization of winner determination in static combinatorial auctions) with short-term, fast dispatch decisions. The long-term decision module, called the optimizer, is called periodically to provide high-level guidance to promote good decisions by the short-term decision module, called the dispatcher.

The requirement that the dispatcher be real-time makes it quite difficult to engage in complex decision making. However, the need to consider the long-term effects of any current allocation decision becomes apparent when one considers that expressive bids will generally express willingness to pay in terms of the outcome of an entire sequence of allocations. In other words, if the dispatcher is to assign the realized queries at period T in an optimal manner then it must consider future contingencies: how will the dispatcher assign supply at future periods to the same bids, and what other bids might arrive into the system?

In all but the most trivial cases, it will be impossible to run any dispatch algorithm in real-time that is adequately able to reason about future contingencies and reason about how the contingencies should impact allocation decisions in the current period. For this reason, the optimizer is used to provide information to the dispatcher that will influence its current allocation decisions based on considerations of future contingencies.

The optimizer runs periodically and takes as input the set of current bids that are active, any information allowing it to estimate future supply and demand (e.g., distributional information), and information reflecting the goals of the seller (e.g., preferences for some kinds of bids over others, constraints on the kinds of allocations the seller is willing to accept etc.), and uses this input to compute specific information that can be passed to the dispatcher, enabling the dispatcher to make allocation decisions in real-time.

The optimizer is generally viewed as doing its computation off-line, in the sense that it does not need to have real-time performance. The dispatcher is generally viewed as doing its computation and decision-making online, in that it needs to have real-time or substantially real-time performance. The role of the optimizer is to allow the dispatcher, and thus the overall method for expressive sequential auctions, to have optimizing behavior while allowing the dispatcher to be defined with a simple (essentially myopic) decision methodology. The optimizer can be re-run periodically to recompute and update the information used by the dispatch method.

Four typical instantiations of optimize and-dispatch include:

Parameterized Dispatch Auctions: The optimizer sets parameters in the dispatcher that indirectly reflect the long-term value of an allocation to a bid, and the dispatcher runs a sequence of instantaneous auctions as supply (queries) are realized, but with bids modified by the dispatcher; e.g., to bias the dispatch auctions in favor of some bids over other bids, to set target volume quotas and budget quotas on bids, etc.;

Long-term and Spot Market: The optimizer decides which long-term expressive bids to accept and which portions of future supply (queries) to allocate to competition in the spot market. The dispatcher is simple: it uses rule(s) set by the long-term market (implemented by the optimizer) to decide whether realized supply (queries) goes to the long-term bids or to the spot market;

Rule based: Like the long-term and spot-market variation except that the optimizer computes a contingent plan, i.e., it computes rules that assign a fraction of the realized supply (queries) to different bids in a way that is conditioned on the history of supply (queries) realized by the dispatcher, i.e. the rules are contingent. The optimizer may also allocate some of the supply (queries) to the spot market, as in the long-term and spot-market variation. The dispatcher in the rule-based optimize-and-dispatch architecture is a more general version of the dispatcher in the long-term and spot-market variation; and

Value-based: The optimizer considers expressive bids (“long-term” bids) and determines which expressive bids should be competitive for supply (queries). Heuristic value information (“value schedules”) is computed in the optimizer for each bid, to estimate the total payment that will be made by the bid when a specific allocation of supply (queries) is made to the bid in a specific period, considering future contingencies. This heuristic value information is then used to represent the expressive bids within the dispatcher. The dispatcher can be considered to operate a “spot market” with values assigned to expressive bids within the optimizer used to define a competitive process to determine the allocation of supply (queries) between these bids and non-expressive (i.e., short-term) bids.

Each variation of optimize-and-dispatch has a different pairing of an optimizer module with a dispatch module. The modules work hand-in-hand and should be understood as a pair.

In general, the optimize-and-dispatch architecture allows decision making by the dispatcher upon realization of supply to be made myopically, i.e., as though in a non-sequential environment: the optimizer abstracts away the sequential aspect of the problem in reformulating it for the benefit of the dispatcher. Whether aspects of the expressiveness of a bid are considered in the optimizer, in the dispatcher, or in both, depends in part on the level of complexity of the decision (with hard decisions made in the optimizer where there is more time) and on when uncertainty is resolved. For instance, the optimizer can make high level decisions and set goals and directives based on statistical information, but only the optimizer can ensure that hard constraints—such as budget constraints—are respected because this depends on the actual realization of supply (queries).

Similarly, the total payment that will accrue to the seller because of a sequence of allocations can be determined within the optimizer, the dispatcher, or in a combination of the two. Bonus (i.e., one-time) payments that are made when particular aggregate properties of supply (queries) to a bid are achieved (e.g., $100 when 5000 units of supply (or queries) with property P₁ allocated in 1 hour) can be considered in the optimizer, while incremental payments (e.g., $0.10 when each unit of supply (or query) with property P₂ is allocated) can be considered within the dispatcher.

A general overview of the present invention will now be described with reference to the accompanying figures where like reference numbers correspond to like elements.

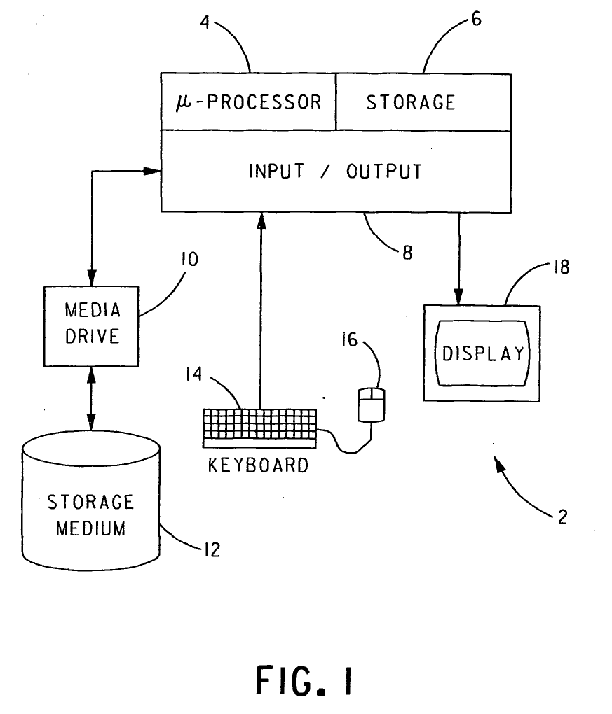

With reference to FIG. 1, the present invention is embodied in computer readable program code which executes on one or more computer systems 2. Each computer system 2 includes a microprocessor 4, a computer storage 6 and input/output system 8. Each computer system 2 can also include a media drive 10, such as a disk drive, a CD ROM drive, and the like. Media drive 10 can be operated under the control of the computer readable program code that resides in a computer useable storage medium 12. The computer readable program code is able to configure and operate computer system 2 in manner to implement the present invention.

Input/output system 8 can include a keyboard 14, a mouse 16 and/or a display means 18, such as a video monitor, a printer, or any other suitable and/or desirable means for providing a visually perceptible image. Computer system 2 is exemplary of computer system(s) capable of executing the computer readable program code of the present invention and is not to be construed as limiting the invention.

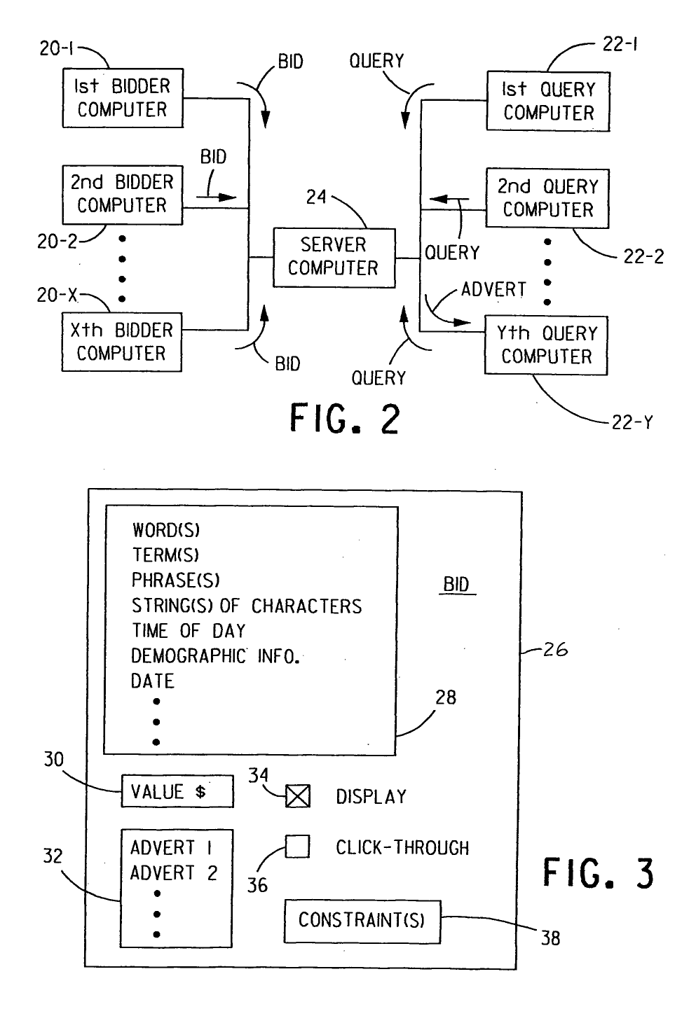

With reference to FIG. 2 and with continuing reference to FIG. 1, in accordance with conducting an online ad auction in accordance with the present invention, one or more bidder computers 20-1-20-x and one or more query computers 22-1-22-y are connected to a server computer 24. Each computer 20, 22 and 24 can be an instantiation of computer 2 shown in FIG. 1. However, this is not to be construed as limiting the invention since each computer 20, 22 and 24 can be of any suitable and/or desirable configuration that facilitates conducting an online ad auction in accordance with the present invention.

With reference to FIG. 3 and with continuing reference to FIGS. 1 and 2, under the control of a user thereof, each bidder computer 20 can be caused to display a suitable bid user interface 26 on the display thereof. Each bid user interface 26 can include one or more of the following: one or more data entry field(s) 28; one or more value fields 30; one or more advert fields 32; a display check-box 34; a check-through check-box 36; and one or more constraint fields 38.

By way of the one or more data entry field(s) 28, a user of each bidder computer 20 can enter data that is utilized as a basis for allocating a query to bid 26. This data can include, without, limitation, one or more words, one or more terms, one or more phrases, one or strings of characters (such as URLs), one or more times of day the bid is active, demographic information (such as, without limitation, geographic information, income range, or any other suitable and/or desirable information regarding a user submitting a query via a query computer 22) date, and any other suitable and/or desirable information that can be utilized as a basis for allocating a query to bid 26.

By way of value field 30, a user of a bidder computer 20 can input one or more values that are to be paid upon the occurrence of one or more predetermined events. For example, value field 30 can be populated with a value that is to be paid when an advert field 32 is displayed on the display of a query computer 22, (i.e., an exposure) in response to a query from said computer 22 being allocated to bid 26. Also or alternatively, value field 30 can include a value to be paid upon the occurrence of a click-through by a user of query computer 22 on the display of an advert included in advert field 32 in response to bid 26 being an allocated a query from said query computer 22. Also or alternatively, value field 30 can include a bonus value to be paid upon the satisfaction of a constraint included in constraint field 38.

Advert field 32 includes one or more links to adverts that will be caused to be on a query computer 22 displayed in response to allocation of a query from said query computer 22 to bid 26. If one or more links to adverts are included in advert link field 32, the display of each advert on a display of a query computer can be controlled by one or more constraints included in constraint field 38.

To facilitate selection of whether a value included in value field 30 is to be paid upon display of an advert or a click-through on a displayed advert, bid user interface 26 can include display check-box 34 and click-through check-box 36, only one of which can be selected at a time to indicate whether payment of a value included in value field 30 is to be made upon display of an advert or click-through of an advert that has been displayed.

Lastly, bid user interface 26 includes one or more constraint fields 38 to facilitate entry of any suitable and/or desirable constraints on the allocation of the bid. Non-limiting examples of suitable constraints that can be included in the one or more constraint fields 38 include, without limitation: an aggregate volume constraint on the total volume of queries that can be allocated to the bid; a temporal constraint on the time the bid is active; a demographic constraint on the demographic(s) of a user of the computer that must be valid for a query received from the computer to be allocated to the bid; a budget constraint on the payment associated with the bid; a frequency constraint on the frequency that queries are allocated to the bid; a joint allocation constraint on the allocation of one or more queries to the bid based on the allocation of said one or more queries to at least one other bid; a user volume constraint that has at least one prerequisite that must be satisfied as a condition to payment of the value; a query volume constraint that has at least one prerequisite that must be satisfied as a condition to payment of the value; and a value-adjustment constraint that has at least one prerequisite that must be satisfied as a condition to adjusting the value.

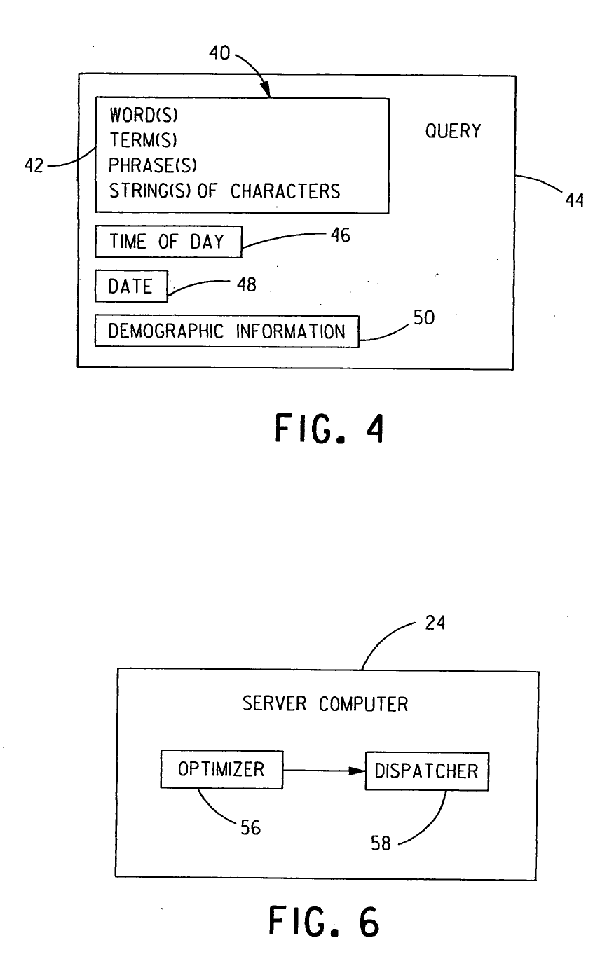

With reference to FIG. 4 and with continuing reference to FIGS. 1-3, under the control of a user thereof, each query computer 22 can be caused to display a query user interface 40 that includes one or more data entry fields for user entry of one or more words, one or more terms, one or more phrases, one or more strings of characters, etc., of a query that the user of query computer 22 desires to have server computer 24 provide a response. An example of a well-known query user interface is the Google query user interface which can be found at www.Google.com.

In response to submission of the data included in each data entry field 42 of query user interface 40, the server computer 24 returns to the query computer 22 where the query originated the results of a search made based on the data included in the one or more data entry field(s) 42 of query user interface 40.

Each query 44 made by a query computer 22 to server computer 24 can include, in addition to the data included in the one or more data entry field(s) 42 of query user interface 40, shadow data that was not directly entered into the one or more data entry field(s) 42. This shadow data can include time of day 46, date 48, and/or any suitable and/or desirable demographic information such as, without limitation, demographic information regarding a user of the query computer 22, the geographical location of computer 22, and/or any other suitable and/or desirable demographic information.

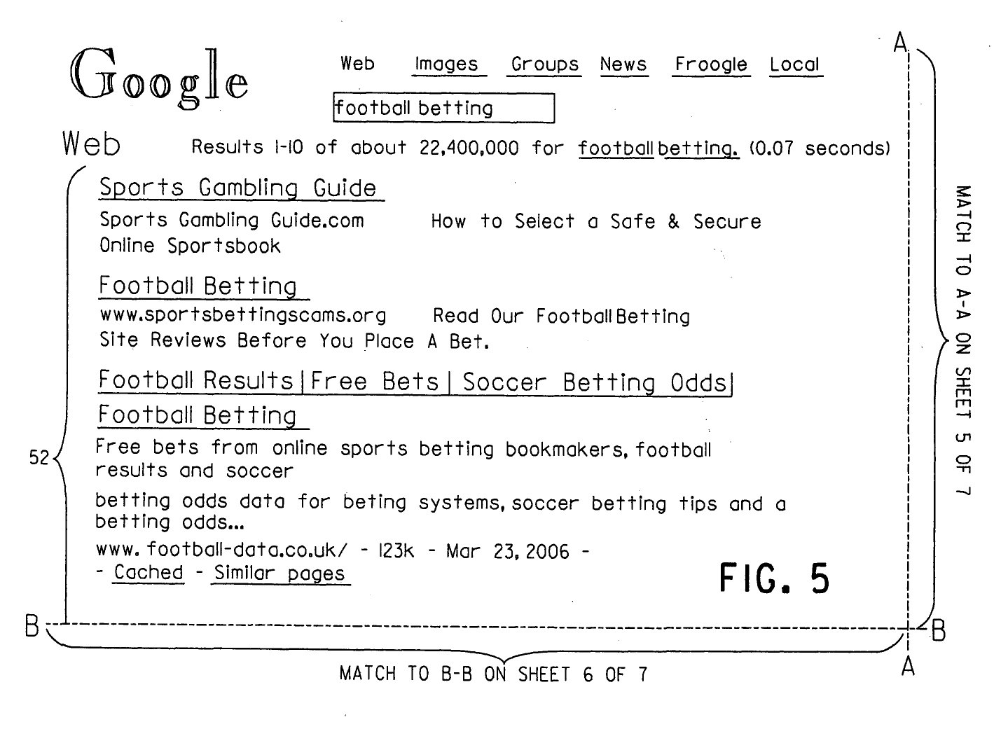

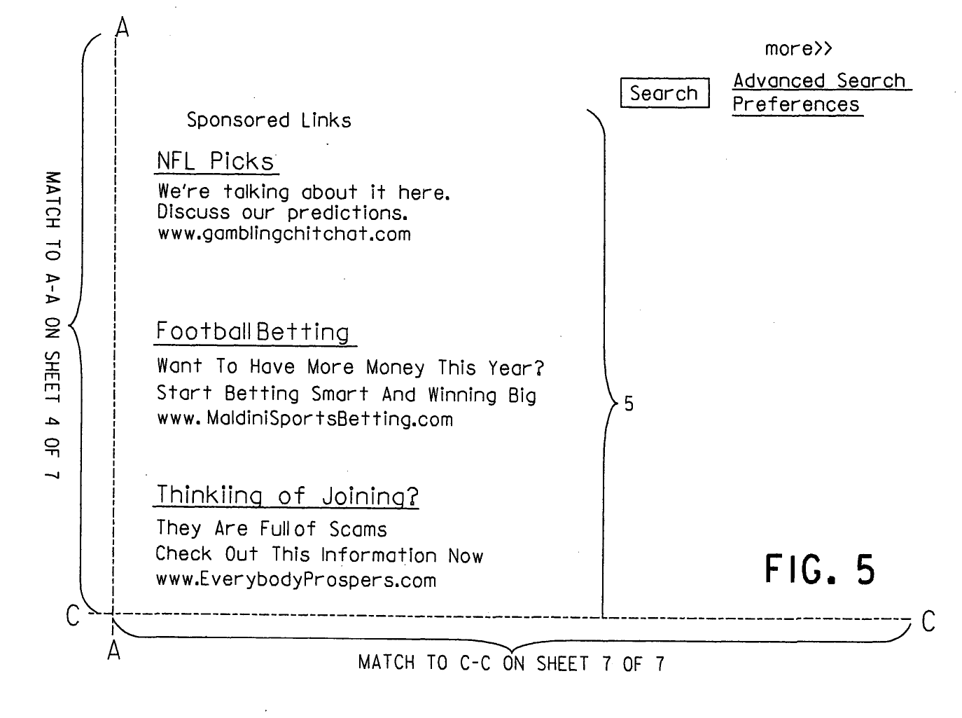

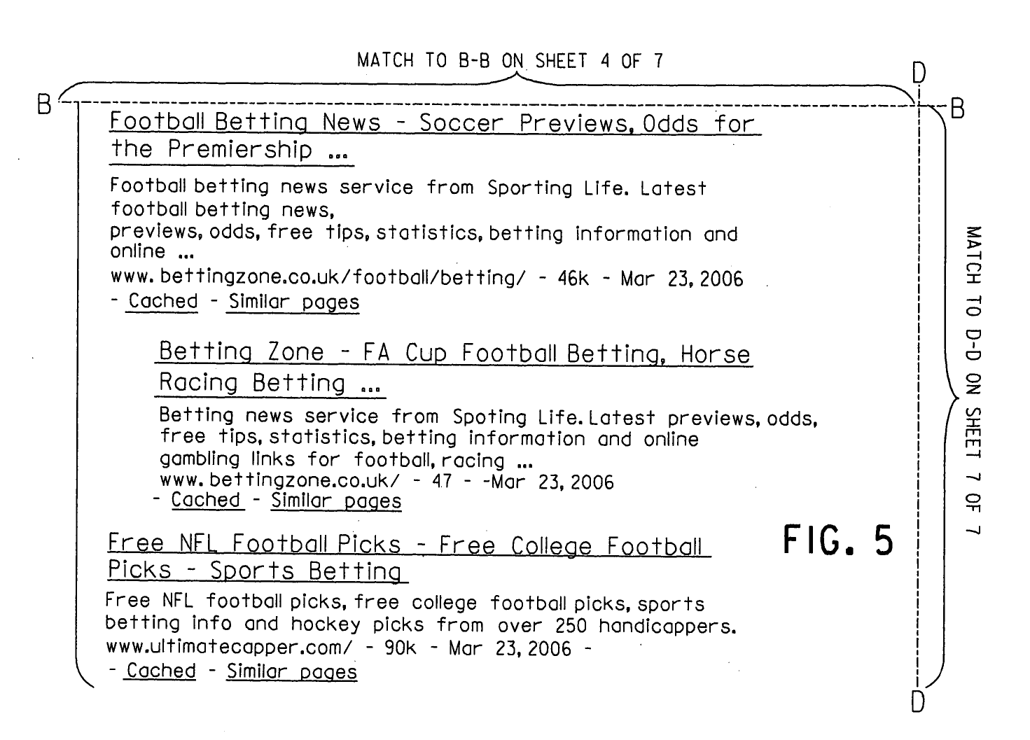

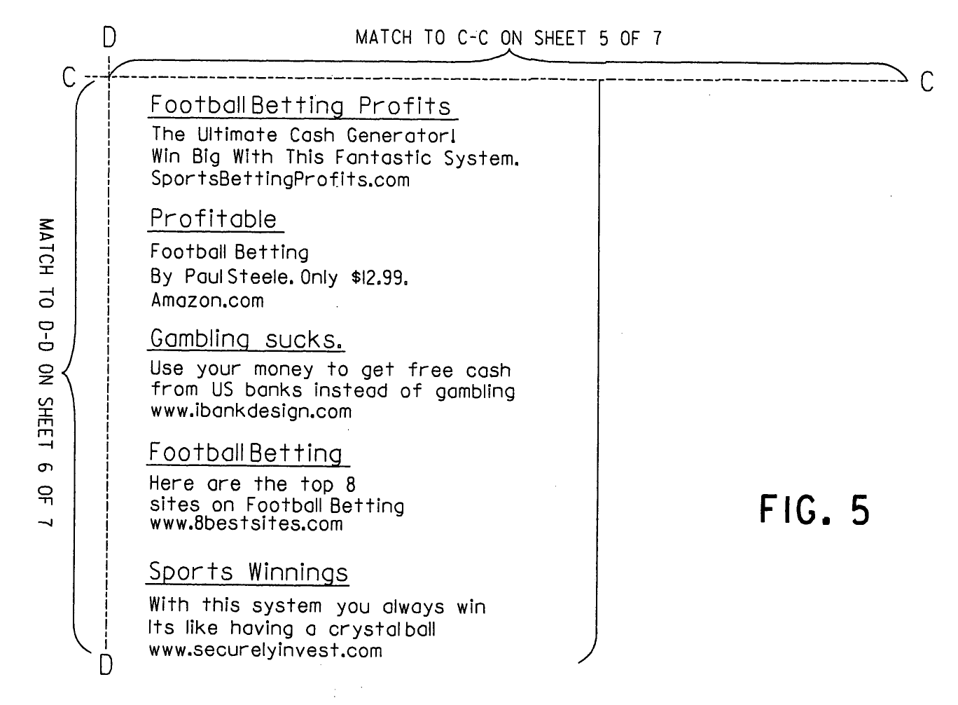

In addition to providing search results back to a query computer 22 issuing a query, like query 44, server computer 24 can also return to query computer 22 advertisements or adverts for goods or services that may be of interest to the user of query computer 22. FIG. 5 shows a typical webpage returned in response to a Google search of “Football” and “Betting” wherein search results 52 appear on one side of the page and adverts 54 appear on the other.

Adverts can take the form of sponsored links as shown in FIG. 5 or can be actual advertisements for goods or services. Accordingly, the illustration of adverts 54 being sponsored links is not to be construed as limiting the invention.

In order to determine which adverts 54 to display in response to receiving a query 44, server computer 24 compares data included in the various fields 42, 46 and 48 and 50 of query 44 to data included in the one or more data entry fields 28 of one or more bids 26 received by server computer 24 from one or more bidder computers 20 and allocates the query 44 to one or more bids 26 based on this comparison and satisfaction of any constraints, if provided, included in one or more constraint field(s) 38 of each bid 26 in manner to be described in greater detail hereinafter.

As described above and as to be described in greater detail hereinafter, server computer 24 is configured to receive a plurality of bids from one or more bidder computers 20 of the computer network that includes each bidder computer 20, each query computer 22 and server computer 24. Each bid 26 is for the right to display at least one advert associated with bid 26 on a display of a query computer 22 in response to server computer 24 allocating to bid 26 a query 44 received from query computer 22. As shown in FIG. 6, server computer 24 can include an optimizer module 56 and a dispatcher module 58. Optimizer module 56 is configured to determine at least one rule or decision variable based on (1) a set of bids received before a time t and (2) at least one of the following: (i) an estimate of queries to be received after time t, (ii) an estimate of click-throughs on adverts to be displayed after time t, and/or (iii) an estimate of bids to be received after time t.

Server computer 24 is configured to receive queries from one or more query computers 22 of the computer network. Dispatcher 58 is configured to allocate each query received after time t to at least one of the received bids based on at least the least one rule or decision variable determined by optimizer 56 and provided to dispatcher 58 in a manner to be described hereinafter.

Optimizer 56 and dispatcher 58 can be implemented as software modules in or operating under the control of the computer readable program code executing on server computer 24. Use of optimizer 56 and dispatcher 58 in connection with expressive bidding in accordance with present invention will now be described.

As discussed above, the present invention is in general an expressive bidding language for sequential allocations, a dispatcher module, and an optimizer module, details and examples of which are described hereinafter.

The dispatcher module and the optimizer module are tightly coupled, with the optimizer making long-term decisions via solutions of combinatorial optimization problems, while the dispatcher is short-term in its focus but is equipped with some optimizing behavior.

The expressive bidding language provides expressiveness on sequences of allocations, i.e., users can express values for different allocation trajectories in a concise and expressive form. At a high-level the expressive bidding language allows for long-term bids that leverage this expressiveness over sequences of allocations. Of course, as a special case, non-sequentially-expressive short-term bids can be supported and additional expressiveness in the context of ad-auctions in that setting can be provided as well. Realize that short-term bids can themselves be active for some period of time: it is only that the short-term bids do not utilize forms of sequential expressiveness.

Bidders can define rich information to define their willingness to pay for different sequences of allocations, including, but not limited to: (a) volume based constraints; (b) requirements on allocations provided to competing bidders; (c) temporal constraints (e.g., smoothness requirements, such that (s.t.) supply is not bunched together in one time period); (d) bonuses for satisfying long-term properties; and (d) price-adjustments that depend on volume of allocation.

New forms of expressiveness for willingness-to-pay for instantaneous demand are also described. In the context of ad-auctions described is an expressive language to allow users to represent their values across goods with unbounded variety (i.e., queries to a search engine). In one desirable instantiation, the bidding or user interface will be designed to allow a bidder to create and refine bids at any time, but will restrict a bidder to only commit new bids to the system periodically (for instance once per day). This is designed to help to mitigate anti-competitive practices such as dynamic shilling to drive up the payments made by other competing firms.

In general, the parameters or rules used within the dispatcher interact with the decisions made in the optimizer. The optimizer models the potential for revenue from the seller or bidder from high-level decisions, the high-level requirements stated by a bidder (e.g., at the level of an overall advertising campaign), and defines an appropriate parameterization or rules for the dispatcher. For instance, if using a simple second- price rule in the dispatcher for each realization of supply (or query), the optimizer can parameterize the decisions made in the dispatcher by setting weights on bids and reservation prices on different units of supply (or queries). This has an effect on the allocation of queries by biasing the outcome of the sequence of dispatch auctions in the favor of particular bids on particular parts of the query space. This is but one form of dispatcher parameterization that is considered in the present invention (i.e., within the parameterized dispatch auctions variation.)

The problem can be made more concrete by considering several examples of dispatch methods and types of information that the optimizer could provide to each of these. For example, the dispatcher can be “parameterized” with information or data passed from the optimizer to the dispatcher being the “parameters” of the dispatch method.

The dispatcher must assign realized supply (e.g., queries) in each period T to bids. The bids may be either expressive, or may arise as part of the realization of additional demand (i.e., within a spot market). A dispatch method instantiated by the dispatcher is any algorithm that takes as input: the current set of (active) bids at period T; the state of each active bid; the supply (or queries) at period T, as it is realized; and information provided by the optimizer to parameterize the performance of the dispatcher.

The dispatcher then assigns each query in the realized supply to one of the active bids (for simplicity, some null bid can be provided that is always active to represent an unallocated query). The so-called state of a bid refers to any past allocations or events that have occurred that impact the conditions expressed by the bid regarding willingness to pay (e.g., have certain targets been met, has a budget constraint been exceeded or is it being approached?). The types of information that could be provided by the optimizer will be described below.

The allocation of realized supply does not assume that the dispatcher knows the actual realized supply at period T before it makes any allocation decisions. The allocation, even within a single period, will generally be online in real-time.

Dispatch methods may vary in their local decision-making rules and thus also in their parameterization. Three typical instantiations of dispatch methods will now be described (the rule-based dispatcher applies to both the long-term and spot-market and rule-based high-level variations on the optimize-and-dispatch architecture):

Parameterized Dispatch Auctions: In this dispatch method, the dispatcher operates a sequence of auctions, one auction as each unit of supply (or query) is realized. The dispatcher uses information provided by the optimizer to weight (i.e., bias) the auction in favor of particular bids (presumably in satisfying long-term requirements expressed by such bids), and also includes a local control method to meet various aggregate targets for the allocation, as defined by the optimizer. Possible targets include assigning a volume target to each bid over some period of time, e.g., allocate 100 “basketball+betting” queries to a bid over the next 24 hours.

Rule-Based: In this dispatch method, the dispatcher receives a set of rules from the optimizer module that specify how to allocate supply to bids in real time. In the simple version of this, the rules are unconditional and the dispatcher is particularly simple: the same rules are used throughout the period of dispatch. For instance, a simple rule might say “allocate all basketball queries to bid 1 and all soccer queries to the spot market.” The full version of the rule-based dispatcher implements conditional rules (i.e., the optimizer defines a complete contingent plan) where decisions later in the dispatch period change in response to realized supply in earlier periods. One aspect of the rule-based dispatcher is a spot market, in which short-term (non-expressive) bids compete in real-time for supply.

Value-Based: In this dispatch method, the dispatcher makes a sequence of value-based decisions, whereby short-term “spot” demand competes with heuristic value information assigned by the optimizer to expressive bids. This so-called value information provides a different form of parameterization than the weights and targets of the parameterized dispatch auctions method, and is used to represent the long-term requirements of expressive bids in a short-term competitive setting.

In the context of ad auctions the dispatcher makes a sequence of decisions about which adverts to display to a user in response to a key-word search or query from the user, as well as any incremental payment to collect from an advertiser in response to displaying an advert or the event of click-through on the displayed advert. The optimizer module will also decide long-term payments to collect from an advertiser. Depending on the sophistication of the dispatcher, it may need to track the history of allocation decisions in order to monitor the state of the long-term bids; e.g., in the parameterized dispatch auction targets such as click-through rates and exposure (advert display) rates, need to be tracked, to enable adjustments in the flow of bids to auctions in order to meet the goals set by the optimizer.

The optimizer module is executed periodically and does not need to provide instantaneous responses. To provide another example, in the context of ad auctions, the optimizer can be used to determine a subset of keywords on which each bid will be eligible to compete during dispatch. In this context, decisions are made on the basis of a statistical model of the exposure and/or click-through rate of adverts and a distribution on search terms.

The information that the optimizer passes to the dispatch method determines how supply (queries) is (are) dispatched over some finite number of periods. This information reflects long-term considerations about the expected value of an entire of sequence of allocations that the dispatch module will make given the information provided by the optimizer. Thus, there is a tight connection between the dispatcher itself, what information the optimizer provides to the dispatcher, and the optimization problem faced by the optimizer.

This optimizer, which is executed periodically, makes decisions about which parameters to specify for the dispatcher in order to optimize expected revenue. Specifics will depend on the particular instantiation of the optimizer and dispatcher. The information that the optimizer passes to the dispatcher determines how supply is dispatched over some finite number of periods. This information reflects long-term considerations about the expected value of an entire of sequence of allocations that the dispatcher will make given the information provided by the optimizer.

The optimize and dispatch architecture is illustrated through four example instantiations. These map to four instantiations of the optimizer: (a) optimizing the parameters and targets in defining the sequence of dispatch auctions; (b) defining simple rules to allocate realized supply (queries) between long-term bids and the spot market; (c) defining contingent rules to allocate realized supply (queries) between long-term bids and the spot market; (d) assigning value information to long-term bids to drive a real-time competitive process within the dispatcher between long-term and short-term bids.

The optimizer can be conceptualized as follows: its task is to provide good guidance to the dispatcher about how to make rapid decisions about the allocation of supply to bids as supply is realized (queries are received) in real-time. The goal of the optimizer is not one of providing perfect guidance in some parts of the decision space faced by the dispatcher and no advice elsewhere. Rather, the optimizer seeks to provide guidance so that the dispatcher can always make a decision even though the quality of the decision will be necessarily sub-optimal, sometimes because of the complexity of the general problem of online resource allocation in the kind of combinatorial setting that the optimizer is modeling.

The optimizer requires a statistical model to guide decision making, e.g., to model future supply and demand in order to reason about the effect of various parameterizations. In application to ad-auctions, the model might provide information about: e.g., without limitation, the exposure and/or click-through rate on an advert, information about the advert (e.g., URL, company name, ad words, ad headline), and information about the search or query content (e.g., key words, time of day, user profile (user demographic information), etc.); and/or the distribution of searches performed by users.

Given distributional information over future supply and demand, the optimizer computes the optimal parameters or rules to convey to the dispatcher in order to maximize the expected revenue achieved by the dispatcher over some time horizon of interest. . More specifically, given the model of supply and demand and, thus a model of the decisions that will be made by the dispatcher for parameterization z given realized supply (S¹, . . . , S^{T}) and realized demand (D¹, . . . , D^{T}) and given the willingness-to-pay specified in bids and thus the relation between allocation and seller revenue, the optimizer provides the dispatcher with parameters (e.g., rules, weights on bids, etc.) to maximize expected revenue.

In accordance with the present invention, an expressive language enables bidders to characterize their willingness-to-pay for sequences of allocations. The expressiveness can take various forms, including: constraints, conditional price adjustments, temporal requirements, budget information, requirements on the joint allocation (i.e., constraints on the allocation of resources to other bidders), and so on. This expressiveness can be realized in terms of willingness-to-pay as a function of observable consequences of an allocation, such as whether or not there is an exposure and/or “click-through” on an advert in the context of auctions for advertising space on web browsers. The expressive bid information is used to guide the sequential decision making of the auction.

On top of the expressiveness, a bidder can submit multiple bids. Each bidder Aᵢ can submit multiple bids Bids(i), with bids connected via logical statements such as exclusive-or constraints (XOR), i.e., at most one bid can be selected by the auctioneer, or additive-or constraints (OR), i.e., any number of bids can be selected by the auctioneer, or conjunctive-constraints (AND), i.e., the conditions of every bid must be satisfied by the auctioneer, or other logical or constraint-based connectives. A set of bids can also have shared constraints, or constraints per bid, in placing conditions that limit whether or not the bidder is willing to make a payment to the seller.

The general form of sequential expressiveness provided in the bidding language allows for:
hard constraints, i.e., constraints to define when conditions for the bid are satisfied, for instance based on the total units of supply (queries) allocated to a bid over some period of time or based on allocations of units of supply (queries) to other bidders (e.g., “I must receive at least 1000 “Football+Betting” queries in each 24 hour period for the next 7 days for my bid to be valid”);
one-time payments made when particular conditions are met (e.g., “I will pay $2000 for 100 “Football+Betting” queries in each of two weeks”); and
adjustments to the per-unit-of-supply (or per-query) willingness-to-pay that are made on the basis of certain properties being met by the allocation. For instance, based on volume targets for particular classes of units of supply or based on receiving exclusive access to some part of the total units of supply for some period of time (e.g., “I will pay $0.20 per query of “Football+Betting” queries if I receive (or a m allocated) 100-200 of said queries each week (and zero for less than this), and $0.10 per query if I receive more than 200 of said queries in any particular week.”)

Generic information associated with a bid, and useful in providing sequential expressiveness includes:
the time period for which the bid is valid;
the class of units of supply (queries) upon which the bid is conditioned, i.e., subsets of queries for which the bidder is willing to make payments. Each bid Bⱼ may be associated with multiple such TargetClasses(j). All bids from a single bidder may be associated with some super set of classes BidderTargetClasses(i);
budget information, namely, each bidder Aᵢ can associate a maximal budget Budget(i) that she will spend in total (within both the dispatcher and the optimizer) during the time period of the bids.
   Each bid, Bⱼ, can also define a bid-level maximal budget Budget(i, j) that can be spent in total (within both the dispatcher and the optimizer) during the time period of this particular bid.
   Each bidder Aᵢ can also define Budget(i, t), for different classes t ε BidderTargetClasses(i), to restrict the maximal payment across all bids associated with the bidder on goods in class t.
   Each bid Bⱼ can also define a limit, Budget(j, t), for t ε TargetClasses(j), to restrict the maximal payment that the bidder will make for queries in this class during the time period of the bid.
   In the context of ad auctions: a bid can state a budget constraint, “I will spend a maximum of $100 per day on advert A in the morning and a maximum of $200 per day on advert B in the afternoon.”
   This can be further broken down and defined by time-of-day or search category. For instance, a bidder can state: “I will spend a maximum of $100 per day on advert A in the morning and a maximum of $200 per day on advert B in the afternoon.”
Aggregate constraints on the total volume of unit(s) of supply (or queries) that should be allocated to the bid, i.e., upper and lower limits on the absolute volume or fractional volume allocated to the bid, and restricted to some subset of the total time period of the bid. These targets can be further broken down and defined by target class of units of supply (or queries).

So-called hard constraints (also called “side constraints”) can be utilized to provide expressiveness on sequences of allocations. Hard constraints enable a bidder to define subsets of sequences of allocations that are acceptable (in the sense that the bidder will make some payment) and other subsets of sequences of allocations that are unacceptable. These side constraints are considered within the high-level decisions made by the optimizer, and are ultimately used to guide the dispatcher in its decisions.

Generally, the language is designed to allow a bid to define conditions which trigger based on conditions on the supply of queries, temporal conditions, and other constraints and generate “OK” or “NotOK” in return.

A bid can be associated with some logical combination of these constraints (e.g., “any one of these must be OK”, or “all of these must be OK”, or “some number of these must be OK”, etc.) Illustrations of this general method to provide constraints are described below.

A so called volume-based side constraint can restrict the conditions under which the bid is valid based on the total quantity of queries allocated to the bid. These volume-based constraints may be broken down into different constraints for different kinds queries and for different time periods. For example:
a bid can include a MINIMAL side constraint to state the bid is only valid if the bid achieves at least an average of 1000 units of supply (queries) in some set C (e.g., “football+betting) per-day for the period of a campaign;
a bid can include a MAXIMAL side constraint to state the bid is only valid if the bid achieves no more than an average of 1000 units of supply (queries) in some set C per-day for the period of a campaign;
a bid can require that a schedule of volume is provided over some period of time, e.g., 1000 units of supply (queries) for the first week of an advertising campaign increasing to 2000 units for the second week.

In general, in addition to expressing the volume constraint as an average over a period of time, the constraint can be expressed as an absolute requirement. For example, a bid can include a MINIMAL side constraint to state the bid is only valid if the bid achieves at least 1000 units of supply (queries) in some set C on every day for the period of a campaign (and similarly for MAXIMAL).

A number of variations are possible. For example, these volume constraints can be stated in terms of some property of the allocation when that can be observed and, hence, recorded by the dispatcher and thus used to validate whether or not constraints were met. In the context of an application to ad auctions, an exemplary observable property is whether or not an advert received a click-through when it was displayed to a user.

A so called frequency side constraint can restrict the bid in terms of the frequency with which supply or queries are allocated to the bid. For instance, a bidder might want to constrain the allocation so that the allocation of queries is fairly smooth over some period of time. For example:
the bid is only valid if it receives at least 1000 units of supply (queries) in some class C in every hour during the next 8 hour period;
the bid is only valid if it receives at least 50% of the total units of supply (queries) in some class C in every hour during the next 8 hour period;
the bid is only valid if it receives at least 1000 units (or some fraction) of supply (queries) in all but some number (or some fraction) of hour periods during the next 8 hours, i.e., providing for a relaxed requirement; and
targets of this kind may also be defined on smaller intervals of time to provide smoothness, e.g., a bidder might place “per-day” targets in addition to “per-hour” and “per-minute” targets where very close control over the sequence of allocations is desired.

Again, these frequency-based constraints can be stated in terms of observable properties that occur as a result of an allocation such as an exposure and/or a click-through in the context of ad auctions. All of these constraints can also be stated, in the context of the parameterized-dispatch-auctions instantiation of the optimize-and-dispatch framework, on requirements of the eligibility of a bid to compete in the dispatch auctions for queries. By this is meant that a bid can have volume and/or frequency constraints on how often the bid is considered for allocation of a query thereto. Whether or not the bid wins (i.e., is allocated a query) will depend on the relative price associated with the bid in comparison with bids defined by other users.

A so called constraint on properties of a joint allocation can enable a bidder to place restrictions on properties of a joint allocation, i.e., the allocation of resources to ALL current bidders (not just herself).

In the context of an ad auction setting, a bidder may want to constrain aspects of the allocation of adverts to competing bidders, e.g., placing exclusivity requirements. More generally, a bidder might wish to place restrictions on the allocations to other bidders if the bidder's bid is to be valid. Bidders can't just arbitrarily restrict aspects of the joint allocation, but are able to place restrictions that must hold conditional on a bid being successful, i.e., “if you accept my bid then I will not pay you unless you don't accept bids from other bidders of the following kind”.

These constraints can take one or more of the following forms:
This bid is valid only when constraints on the sequence of allocations of queries to the bid and the sequence of allocations of queries to other bids are satisfied, for some period of time, e.g., in the context of an ad auction, a bid may only be valid if the advert receives the exclusive right to advertise (display adverts) in response to queries in some particular class for some period of time with no other bids receiving the right to advertise.
   This can be defined by defining subclasses of the overall target class of a bid on which an exclusive allocation of queries is required: define a special class of supply, AbsoluteExclusive(j) for bid Bⱼ, such that t ε AbsoluteExclusive(j) is the query or queries that is/are exclusively allocated to the bid throughout the time period during which the bid, and hence, the constraint on the bid is active.
   Additional variations can include: (a) the bid is an exclusive winner either in a class A of queries or class B of queries; and/or (b) the bid is an exclusive winner for some period of time, such as a month or a week.
This bid is only valid when joint constraints on the sequence of allocations provided to the bid and the other bids are satisfied every time an allocation is made, or for some other set of temporal requirements, e.g., in the context of ad auctions, the bid is only valid if an advert associated with the bid appears in one of the top N positions in a display of adverts in response to a search query, or if the bid satisfies some other properties that implies constraints on the attributes of the allocation that can be provided to other bidders.
   In the context of ad auctions, a bid Bⱼ can be associated with a special class of queries, TopNPosition(j), and when the current query is in this class, then the bid must be within some position PosBid (j) (e.g., {0, 1, 2, 3, . . . }) of the top-ranked bid.
As a variation on the above, a bid may only be valid if it is the exclusive winning bid in a particular category of unit of supply (query) for some period of time, e.g., a month; i.e., even if the budget has been used up and, thus, I am no longer able to pay for queries, no other bidder should receive a query for my overall bid (and thus willingness-to-pay) to be valid.
As another variation on the above, a bid may only be valid if no other bid(s) receive a simultaneous allocation that satisfies some properties in relation to the allocation to the bid; e.g., in the context of ad auctions, “neither of firms A or B can receive the right to advertise (display an advert) within some proximity metric of my own advert for an entire week.”

A bidder can also express adjustments to its own payment terms when certain conditions are satisfied by the sequential allocation. First described are kinds of one-time payments (or bonus payments) that are facilitated by the present invention.

Generally, the present invention allows a bid to define adjustments that trigger on the basis of properties on the supply of queries, temporal conditions, and other constraints and define a one-time payment.

Adjustments can be defined as overall modifications to willingness-to-pay when conditions are met, with these modifications either described as absolute changes in payment or proportional changes.
For instance, a bidder can state a total bonus of some amount when joint properties are satisfied by the allocation of queries over some period of time; e.g., “I will pay an additional $10 every time no advert associated with a bid of bidder A is shown in a particular class of supply for some period of time, such as a week.”
Exclusivity-based adjustments are allowed as a special case of this; e.g., “I will pay an additional $5000 every time my bid receives exclusive right to all queries in class C for some period of time.” Bid Bⱼ can be associated with a bonus payment function, vE(t, j), for class t ε TargetClasses(j), which defines a one-time payment that is available to the auctioneer if the bid receives the exclusive allocation of queries in class t during the time period during which the bid is active.

To further illustrate this idea: a bid Bⱼ can define a special set of queries and associated “competing” bids, NotWin(j): A member (t, bs) ε NotWin(j), describes a class of queries for which bonuses are available if the volume of clicks to bids bs of other bidders is restricted in a particular way (typically restricted to a small enough number, e.g., zero). The bid function defined on this class is vNotWin(t, bs, j, y). For each such (t, bs) ε NotWin(j), this defines a value function to provide a bonus in terms of the volume of supply y allocated to bids bs during the time the bid is active.

A so called volume-based adjustments to payment terms can adjust the absolute payment made by an amount that depends on meeting volume targets. For instance, “I will make an additional payment of $100 if at least 100 units of supply (queries) in some class C are in all (or some fraction of) time periods during an interval of time.” Such conditions may also be stated in terms of observable properties that occur because of an allocation, for instance whether or not an exposure and/or a click-through occurred in the context of an ad auction.

For instance, the bonus function vBonus(t, j, y), for each t ε TargetClasses(j), on bid Bⱼ, defines an additional payment in the case of achieving particular volume targets and depends on the volume of supply (queries) y allocated to a bid during the period of time the bid is active.

So called frequency-based adjustments to payment terms can make either absolute or proportional adjustments to a one-time payments if temporal properties of supply (queries) are satisfied. For instance, a bidder might condition an adjustment on whether or not some desired volume of supply (queries) is allocated in each of some sequence of periods, of if some total percentage of the supply (queries) of some class of queries is allocated over the next week.

In addition to defining these one-time payments (or “long-term” adjustments), an expressive bid can also condition changes to the per-unit-of-supply (or query) payment that depends on properties defined on the sequence of allocations (or “short-term” adjustments). These adjustments can be absolute (e.g., an increase of $0.10 per unit of supply (or query) allocated) or fractional (e.g., an increase by 5% per unit of supply (or query) allocated).

Generally, the language is designed to allow a bid to define adjustments that are conditioned on properties of individual queries, temporal conditions and other constraints, and define an adjustment to the per-unit payment.

The constraints are defined on properties of the sequence of allocations, and thus the payment made by a bid per unit of supply (query) allocated is adaptive during a sequence of allocations. This allows a bidder to express bid schedules, where the per-unit of supply (or query) bid price changes based on the smoothness of allocation across time, or based on the total volume of allocation in some class during some period of time.

Hereafter, an expressive language for describing the “base price” in the context of ad auctions is disclosed. This base price is the non-adjusted price that is a bidder's willingness-to-pay in response to being allocated to a particular query. The base price is further adjusted, as defined here. Consider the following illustrations of this idea:
(on properties of the joint allocation) For instance, a bid can include the adjustment that an additional payment per-unit of supply (or per-query) allocated to the bid of $4 will be made each time the query would have been allocated to another bid but this latter allocation was not made and when this is done for an entire week; and
(on properties of the joint allocation) For instance, a bid can include the adjustment that an additional payment per-unit of supply (or per-query) allocated to the bid of $4 will be made each time a joint property of the allocation is satisfied for an entire week (such as, no other bidder is allocated a query with property P at the same time as I receive queries with property P₁)

The short-term adjustments to the payments can also be allowed to depend on the properties defined on the volume of allocation, and again broken down by the class of queries. For instance, a bidder can define a payment schedule such as a piecewise linear function that depends on the total volume.

For instance, the payment schedule can define an increase in price as the volume of queries allocated increases, such as 0-100 queries allocated gives $0.00 per query, 100-200 queries allocated gives $0.05 per query, and 200-400 queries allocated gives $0.07 per query, etc. All of these volume quantities may be stated for some period of time such as a week.

The per click-through payment can also be defined to depend on the frequency with which the bid is allocated a query. For instance, a bid might be eligible for a 5% increase in click-through payment if it is eligible to be allocated queries both during the morning and during the afternoon. For instance, a bid might be eligible for a $0.20 increase in click-through payment if it is eligible to be allocated at least 60% of the queries having a particular category of search terms.

Next, the present invention will be described in connection with new expressiveness on bids for real-time allocation of queries in the context of ad auctions.

Current ad auction methods allow a bidder to describe sets of searches for which the bid is valid, but do not allow a bid to condition the payment made in a way that depends (e.g., in a linear, or non-linear way) on the combinations of query terms in the user's search.

Search terms (or queries) entered by a user into a search engine of a web browser accessing the Internet provide information about the attentional state of a user, and thus can provide information about how receptive a user is likely to be to a particular advert at a particular point in time given her current context.

The ad-auction system can also be applied to other Internet applications, for instance to serve adverts to content providers or to serve adverts on email systems. In an application to an email system, the textual content in the email takes the role of the search terms. In an application to a content provider such as a newspaper web site, the content on the page can play the role of the search terms. Standard methods from information retrieval can be adopted to generate a signature of a large amount of content, for instance an abstraction to provide a set of important words that can be used to provide summarization information. In an email application, the subject line of an email can be weighted to have additional importance, while an email thread can provide useful information.

In this context, the query can be defined by: (a) the search terms entered by a user, and (b) context information about the current user. This context information might include:
whether the user is engaged in a stateful session of interaction and has executed a sequence of search terms and clicked on a sequence of URLs; and
any additional profile or demographic information about a user, for instance profile information that is available because the search engine is a subscription service that requires the provision of some personalized information.

For an application to adverts displayed in response to queries on an Internet search engine, the results from the search, i.e., the ordered list of search results to augment the attentional state, can also or alternatively be used. In an application to an auction for adverts in a less personalized space, such as adverts to a group of customers in a grocery store, the attentional information might instead refer to information about the group of users. In another application, for instance displaying adverts to a user in a car, for instance about restaurants in the vicinity, then context information can also include information about the location of the user (for instance via GPS), and information about the current neighborhood in which a user is driving.

In addition, all forms of expressiveness described above for bids in an ad-auction application can describe the attributes of the advert. For instance:
semantic key words, whether the advert is a “banner ad” or “click-through ad” (i.e., whether the bid is for a number of exposures or for a number of click-throughs); and
whether the advert is textual, graphical or will appear in its own “pop-up” window, etc.

These attributes will be domain specific, but can provide additional contextual information to feed into the statistical model within the optimizer and dispatcher. For instance, in a grocery-store, an ad attribute might state the length of time for which the advert must be displayed on a display.

The sequential expressiveness described above allows for a bidder to state: (a) a bonus payment will be due if the bidder is the exclusive advertiser for a particular category; (b) an additional payment will be due if a particular number of click-throughs are achieved over a period of time; (c) payments due to the number of users that click-through an advert (the number of “click-throughs”) or the number of users that see an advert (the number of “exposures”); (d) whether the advert is the only one displayed in response to a particular search term.

Here, additional expressiveness, such as allowing the price, can be conditioned on the results of search from the search engine, and also the results of “shadow searches” (described below).

It is typical in current ad auctions to provide a bidding language that allows a bidder to provide constraints on the kinds of search queries that are acceptable to the bidder. For instance, this is done by defining one or more sets of “good words” (words that must be in the user's search), one or more sets of “bad words” (words that should not be in the user's search), and smart-matches whereby a search engine tries to automatically decide which kinds of queries are relevant for an advert. For instance, a seller of vacations to Central America might view search terms that include capitals in Central America (with additional terms such as “hotel”) as positive evidence, but additional terms such as “political regime” as negative evidence.

However, none of these allow for the bid price to vary as a property of the key words that define the current unit of supply. This is provided in the present invention.

As a simple model, the base price dependence on search terms can be defined as:
1. any one word in the set of {CORE_WORDS} has value base;
2. an additional value v is introduced for each word in the set of {GOOD_WORDS}, but up to a maximum value of (base+L*v), for some constant L; and
3. zero value if any word in {BAD_WORDS} appears in the search.

A more sophisticated model can allow for phrases, still with additional bonuses for other good words:
1. any phrase in the set of {{PHRASES}} has value base;
2. an additional value v is allowed for each word in the set of {GOOD_WORDS}, but up to a maximum value of (base+L*v), for some constant L; and
3. zero value if any word in {BAD_WORDS} appears in the search.

Another variation is to allow for active assistance from the search engine. For example, suppose that there is access to semantic classes of words, as grouped by statistical information available to the search engine. Given key-word (θ_{w}), a semantic class of terms Class (θ_{w}) can be defined. This is the set of words that convey similar meaning to the original key word. As a variation, the semantic class can be based on pairs, or more generally, sets of key words. Given this, the base price can now be defined as follows:
1. any one key word in the semantic class Class (θ_{w}) as words θ_{w}={CORE_WORDS} has value base;
2. an additional value v is allowed for each word in the set of Class (θ_{w}), up to a maximum value (base+L*v) for some constant L; and
3. zero value if any word in {BAD_WORDS} appears in the search.

The advantage of this “semantic-class” based bidding language is that it brings a tremendous simplification to the bidding problem facing a bidder. The information readily available to a search engine is used to automatically make a bid more widely applicable.

Another variation is to allow the bid price to be defined in terms of the URLs that are returned in response to the search term, rather than the search term itself. This method is powerful because it leverages the focal nature of certain web sites and the power of search engines to make ad auction bids more accurate.

For instance, a book store might be interested in advertising its online book store whenever www.amazon.com is in the first few (e.g., five) hits of the search engine. In this approach, the base price can now be defined as:
1. any one URL in the top five returned by the search engine that is in the set of {CORE_URLs} has value base;
2. an additional value v is allowed for each URL in the top ten returned by the search engine that is a member of the set of {GOOD_URLs}, but up to a maximum value of, (base+L*v) for some constant L; and
3. zero value if any URLs in {BAD_URLs} appears in the top 10 results returned by the search engine.

Naturally, all variations or combinations of using key words, using semantic classes of key words, and using URLs are perfectly valid ways to construct a bid language. A general logic can be used to define combinations. For instance, a bid might be defined where:
the base price is valid if some URL in the set {GOOD_URLs} is in the first five URLs or the key word is in the set {CORE_WORDS};
the base price is valid if some URL in the set {GOOD_URLs} is in the first five URLs and the key word is in the set {CORE_WORDS}; and/or
the base price is valid if two URLs in the set {GOOD_URLs} are in the first five URLs returned by the search and the key word is in the set {CORE_WORDS}.

Another variation is to allow an “active” approach to determining the context of the current search by running shadow queries to the search engine. A shadow query is defined as a variation in which the user's search term θ is augmented by a term of interest to the advertiser. For example, if the advertiser is trying to distinguish between a user that is researching the history of London versus a user that is interested in visiting London then it can be useful to augment the search that is employed by the user with an additional term such as “vacation”. The number of hits returned by the engine in response to this “shadow query” (which is likely never displayed to the user) can provide evidence for whether the search the user is performing is consistent or inconsistent with the concept of going on a vacation.

So, in this active approach, a search term θ is augmented with an additional advertiser-defined search phrase, θ_{advertiser}, and execute the shadow query θ+θ_{advertiser} is executed. Based on the URLs in the response, the advertiser can define a base price that is valid if the quantity of evidence (as represented by the number of hits to the shadow query) is high enough, or if one of the set of {GOOD_URLs} is in the top few URLs returned in response to the shadow query. A variation on this would allow a user to state “if my web page appears in the top one or two slots of search then don't pay to advertise.” i.e., this allows a bidder to use bids to augment search results without replicating search results.

Another variation uses the recent history of search. This can be modeled as a user that has executed a sequence of queries, θ₁, θ₂, . . . , θₜ. A bid can now define conditions to trigger base price and adjustments that are instantiated across this set of search terms. For instance, we can consider that a bid is defined where:
1. the base price is valid if some proportion (e.g., ≧50%) of the last five searches fit within a criteria, such 50% or more of the last five searches the search term included a word in the set {CORE_WORDS};
2. zero value if any word in {BAD_WORDS} occurs in any of the past five searches; and
3. an additional value v is allowed for each additional word in the set of {CORE_WORDS} that occurs in any of the past five searches, again up until some max base+L*v.

More generally, the bid price can be defined as a function of the bid price that would be defined based on the previous N search terms. For instance, the bid price for an advert given current search term θₜ from a user can be defined as the maximum over the bid price defined for the past five search terms, as long as no {BAD_WORDS} occurred in any of those past searches.

As an additional extension, all previous methods can be generalized to define the bid price as a general functional form over key words. For instance, the additional bonus for words in {CORE_WORDS} need not be a linear sum such as v·x where there are x additional words, but can be a general function of the number of additional and relevant words.

The present invention can also provide automated query class abstraction, by allowing a user to type in several example queries and then automatically create the concept class (e.g., using clustering techniques to automatically generalize what the user wants). Part of this can include showing multiple alternatives to a user: i.e., via preference elicitation. Automatic niche creation is another useful tool to create a class that does not overlap much with others' queries (or other queries from the same bidder.) This use of “fuzzy matching” can provide a concise way to allow a bidder to bid on large numbers of queries with different prices based on how close the match is. It can be useful to make matches broad so that all important classes of supply are covered sufficiently enough in the market. One useful tool could be a suggestion in terms of bids from others, e.g., “bidders who bid this also bid on . . . ”

An advertiser can also express additional adjustments and restrictions to the base price that are determined on the basis of additional contextual information about the user and about the search environment. For instance, they can depend on:
the user profile; and
the search context (e.g., time of day, location, . . . )

The bid price can depend on information about the user profile. For instance, a search engine might have profile information about the user (e.g., because the user has to register with the search engine, or because there is some broader desktop presence that allows the search engine to track a user's online presence over time.) The user profile can also be augmented through knowledge of other services provided to the same user. For instance, this information could be the text in the body of email messages or historical information about the kinds of sites that a user likes to visit.

For instance, a bid can place additional restrictions that only considers users with profiles that fit within class {GOOD_PROFILE}. This profile can be defined in terms of demographics, location, and also in terms of an aggregate classification of the kinds of sites that a user visits online. Desirably, there will only be a small set of user demographic and online-usage classifications from which bidder advertiser can simply pick out the user types in which they are interested to restrict over.

The bid price can also depend on additional context such as the time of the day or the location of a user. One method to handle the time of day information, for instance, is to break the day down into periods such as morning, afternoon, and night and have separate bid prices for each period. As a special case, a bid can be restricted to a particular time of day, or a bid can state “my bid is valid if the local time is within 2 hours of 10 pm.” Similarly, this can be extended to allow a price adjustment that depends on time of day, with the most general form including either a price-bonus (which can be positive or negative) that triggers based on the time of day as a piece-wise linear function. The price-bonus can be applied in an additive or multiplicative way to the base price.

To handle locational information, location can be broken into geographical regions such as US Zip codes or larger aggregated regions. Again, as a special case a bid can be restricted to a particular location such as “within 10 miles of Zip code 02139.” Similarly, this can be extended to allow a price adjustment that depends on location, with the most general form including either a price-bonus (which can be positive or negative) that triggers based on the location as a piece-wise linear function from interesting locations (such as all major metropolitan locations in the US). The price bonus can be applied in an additive or multiplicative way to the base price.

In one variation of the optimize-and-dispatch architecture know as parameterized dispatch auction, a dispatcher runs a sequence of simple local auctions to determine the allocation. Each time that new supply (i.e., query or queries) is received the dispatcher: (a) determines the eligibility of bids to compete for each query; and (b) uses a parameterized auction to determine the allocation of each query to one or more bids. The decision about eligibility, and the parameters of the auction (e.g., weights on bids) are either defined directly in parameters passed by the optimizer to the dispatcher or determined via a simple local control mechanism that aims to meet any targets (e.g., on the volume of allocation, or budget targets) set by the optimizer.

The optimizer sets parameters in the dispatcher to reflect the long term value of an allocation. Such parameters may include factors such as budget and volume targets, biases for different bids (e.g., weights to use as multipliers on bids to reprioritize decisions in favor of some bids, virtual prices to associate with bids with only one-time payments to enable the bids to be represented in the dispatch module auction), reserve prices for different types of queries, etc. The winner determination problem solved in the dispatcher in allocating each new unit of supply (query) can be formulated as a simple greedy algorithm (in the case of a single unit of an item to allocate to bids), or with a simple mixed-integer program (MIP) and then solved using tree-search algorithms (when there are multiple units of an item to allocate to bids). For example, there are typically multiple bids associated with each search query in an ad auction application, i.e., one bid for each slot that is available to display an advert to a user.

The kinds of targets that can be defined by the optimizer include budget targets, volume targets (both absolute and as a fraction of total supply), targets on observable effects caused by an allocation (e.g., targets on click-through in our application to ad auctions), etc. All targets can be described in combination with temporal information, for instance required to hold each hour, or to hold in aggregate during the course of day. Targets can also be disaggregated so that they are defined for different classes of resources.

The dispatcher can be equipped with a simple control algorithm that is used to throttle bids so that only a subset of the bids that are eligible to compete for supply (as defined by the optimizer ) are actually considered in the current auction. The idea of throttling is that it provides an example of a simple control method that can adjust the level of competition to meet these targets, which can be conceptualized as goals provided to the dispatcher by the optimizer. Due to this simple local control, a bid that is provided with a non-zero weight for queries in some class by the optimizer will not necessarily partake in the auction for every query that is received while the bid is active. On the other hand, a lack of eligibility (e.g., via a zero weight) precludes a bid from consideration in the dispatcher.

Throttling can be done continuously to meet budget constraints, and other targets set by high-level decision making in the optimizer. Throttling and other simple control methods within the dispatcher are aspects of this instantiation of the optimize and dispatch architecture. Bidders are giving up the minute-by-minute control on which queries to bid for in favor of the convenience of expressive bids and access to an automated bidding system. But for this reason the bidders need additional controls to constrain the space of allocations, e.g., to make sure that budget constraints are not exceeded. In general, the dispatcher can handle some of these hard constraints more effectively than the optimizer because the dispatcher processes received queries while the optimizer is working based on predictions of queries to be received.

In the context of an application to ad auctions, throttling can be used to ensure that competition remains fairly smooth during the course of a day. For instance, one concern could be that bids slowly become inactive as time passes since a call to the optimizer, because the budget of a bid is exceeded. This would lead to systematic changes in prices across this period of time causing potential concerns about fairness to sellers, and also raising the possibility that bidders can behave strategically and try to time their entry into the market or submit a lower bid price than they would otherwise with the intention of losing early, competitive auctions and then winning later, less competitive, auctions.

The output of the optimizer provides the following parameterization to the auction process in the dispatcher. These are parameters set within the optimizer, which will adopt a longer time horizon than the time T of the final period to be handled by the dispatcher before an additional call back to the optimizer.

As discussed hereinafter, it is important for the optimizer to adopt a longer time horizon in order to make good decisions about bid weights to best meet the long-term expressiveness in bids, for instance bonus payments for some total volume of supply over a period of time.

It is helpful to sub-divide the parameters into two groups. The first group of parameters defines overall targets that the dispatcher will meet via a local control algorithm, such as the throttling mechanism, that is used to control the flow of bids to auctions within the dispatcher:
Budget targets: \tilde{B}ᵢ(c), \tilde{B}ᵢⱼ(c), \tilde{B}ᵢ and \tilde{B}ᵢⱼ, define the target budget for bidder i on queries in class c, for bid j from bidder i on queries in class c, for bidder i overall, and for bidder i on bid j overall. All of these can be adjusted from the budgets defined in the bid submitted to the expressive auction system, for example based on bonuses already anticipated within the optimizer module; and
Volume targets: volfracᵢⱼ(c)ε[0, 1] defines the fraction of volume of resources in class c that bid j from bidder i should win. Similarly, volᵢⱼ(c)≧0 defines the absolute target volume to bid j from bidder i.
   The volume targets can also be defined on observable effects that result from an allocation of resources, e.g., in the context of ad auctions, an observable effect is an ad exposure and/or a click-through on an advert. In this case, we can also define clickthroughfracᵢⱼ(c) and clickthroughvolᵢⱼ(c), which associate a fractional or absolute target on this click-through property.
   Volume targets can also be soft, for example associated with a range of information; e.g., a lower and upper limit to guide the dispatcher into this range, or a mean target and guidance on acceptable variance from that mean.

Each budget and volume target can also be associated with temporal conditions, which further restrict the sequence of auctions on which the targets must be met. (The default would be to make all auctions during the period of dispatch, T, to be relevant in defining the target.) For example, the optimizer can specify one budget constraint to meet between 11 pm and 5 am, and another to meet between 5 am and 11 pm.

The second group of parameters are used to modify the rules used to clear each auction in the dispatcher. The optimizer is also responsible for associating a “virtual price” with each bid, which is useful in the case of expressive bids with associated one-time payments. This price is what represents the bid in the auction. An example of how this works will be discussed hereinafter. In addition to this price-which represents the per-unit (or per-query) value that the optimizer estimates will accrue from assigning the next unit of supply (or query) to the bid—the optimizer also specifies weights to further bias the decision of the dispatcher (for example in controlling the interaction between the expressive bids and the spot market bids, and also in providing the dispatcher with the ability to control the allocation of supply via the throttling mechanism.)
Virtual prices: Virtual prices vpᵢⱼ(c, E)≧0 are associated with each bid j from bidder i on queries in class c perhaps further conditioned on environment information E. If the expressive bid provides a per-unit (or per-query) willingness-to-pay (that is only valid conditional on the bid meeting a target) then this will form the virtual price. On the other hand, if the expressive bid provides a one-time payment when a target is met, then this will form the virtual price when distributed across the total supply that will be allocated in meeting the target;
Bid weights: Weight wᵢⱼ(c, E)≧0. This is the priority given to a bid j from bidder i on queries in class C, perhaps further conditioned on environment information e. This environment information can include properties observable by the dispatcher, e.g., the current time of day, or other relevant events that could affect the dynamics of supply and demand. The weight is used within the dispatcher to adjust the bid price in determining which bid wins the right to supply an advert or receive a click-through in response to the dispatcher allocating a query to the bid. As discussed hereinafter, it provides a multiplier on the bid's value. As a special case the weight can be zero, which indicates no eligibility, or infinity to indicate that the bid should always receive absolute priority for resource in a particular class;
Reserve prices: Reserve(c,E)≧0 defines a reservation price that the dispatcher can apply when auctioning supply on queries in class c. The effect is that supply is not assigned to bids with (weighted) willingness-to-pay less than this reserve price. In addition, the effect of this reserve price is to increase the payment received by the auction in the case that the payments are determined via a second-price method;
Constraints on Joint Properties of Allocations: The optimizer can also place constraints on the allocation that should be determined within the dispatcher each time a new allocation of queries is provided to bids. For instance, in the case of ad auctions, one typical constraint will limit the number of adverts that can be displayed, max(c,E), in response to a query in class c and for environment conditions E. Another example is maximal rank information, maxrankᵢⱼ(c,E), which defines the maximal rank that an advert j from bidder i can have in response to a query in class c and for environment E.

These parameters, such as weights, reserve prices, and other constraints can also be associated with temporal conditions, which further restrict the sequence of auctions on which the targets must be met. (The default would be to make all auctions during the period of dispatch, T, to be relevant in defining the target.) For example, the optimizer can specify one set of weights for a period of time between 11 pm and 5 am and another between 5 am and 11 pm.

Realize that as a special case that weights allow the optimizer to provide a bid with an exclusive right to win, by setting its weight to 1 and the weights of other bids to 0 for some class. As another special case, this allows bids that are eligible to compete to be systematically controlled during the day through the use of temporal conditions.

The dispatcher executes a sequence of real-time auctions to allocate resource to bids. The main control mechanism adopted within the dispatcher is to throttle the rate at which each bid can compete for resources in order to implement the targets specified by the optimizer.

Given the realization of supply of some resource (e.g., one or more queries), the basic decision facing the dispatcher, before running a simple auction, is to decide which bids to allow to compete to be allocated each query.

It is this simplicity of the dispatcher that allows for real-time or near real-time response and thus enables the optimize-and-dispatch architecture. Once the bids that are eligible to compete for a query are determined, the auction can be cleared, respecting and utilizing information on bid weights, budget targets, and other constraints such as the maximal number of bids that can be simultaneously allocated queries and the reservation price.

The optimizer is used to fold any constraints or bonuses (or similar global expressiveness) that was defined within bids within the parameters assigned to the dispatcher by the optimizer. Thus, the goal of the dispatcher is now limited to that of meeting the targets set by the optimizer while respecting other parameters.

Throttling by the dispatcher will now be described. Let eligib (S, E)⊂∪ᵢBᵢ denote the bids that are eligible to compete for supply S (of queries) given environment E. The dispatcher uses a simple throttling rate, αᵢⱼ(c, E)ε[0,1] for bid j from bidder i on supply in class c and given environment E. This defines the probability with which bid j is eligible to compete.

Given supply S and environment E, each bid that is interested in the query (i.e., with some non-zero base price) is eligible to compete with probability αᵢⱼ(c, E) where S ε c.

A simpler version could define some throttling parameter αᵢⱼ(c) that depends only on the class of resources, or even αᵢⱼ that is the same for bidder i across all resources.

A number of methods can be used to adjust the throttling rate within the dispatcher. For instance, the dispatcher can estimate the frequency of auctions that bid j from bidder i wins when allocated queries in class c and then update the throttle parameters such that the expected amount of queries allocated (if this is the target) will track the target. An example of this is provided hereinafter. On the other hand, if the target to track is a budget target, then the dispatcher will keep an estimate of the average payment made by the bid when it is allocated one or more queries and throttle the bid accordingly.

Sometimes conflicts might arise between different targets that were unanticipated within the optimizer. These can be handled through a simple prioritization scheme. For instance, the dispatcher can adopt the following prioritization for breaking conflicts between the various kinds of targets:
budget target [symbol] volume target
   where [symbol] =“has priority over”.

In the case that there are various kinds of volume targets, for instance volume targets that are defined both on the allocation directly and also on indirect (but observable) properties that result from the allocation then further tie-breaking can be required. For instance, in the context of ad auctions, then the following rule can be adopted:
budget target [symbol] volume target [symbol] click-through target

The dispatcher would first strive to keep within the budget target and then, from all decisions that achieve this, choose that which best meets the volume target, and then, within all that also achieve this, choose that which best meets the click-through target.

In place of the simple control technique outlined above, which makes decisions based on online estimates of the percentage of queries allocated to a bid when it competes, or the payment made by a bid when it competes, the dispatcher can also adopt control techniques to adjust the throttle rates. For example, using proportional-integral-derivative (PID) style control, or some combination of a proportional control, an integrated control and a derivative control, to keep targets within some bound of that defined by the optimizer, for each bid and for each class. For instance, the dispatcher can adopt bounds on acceptable behavior in tracking a target during a day, and then take corrective measure(s) when the behavior falls outside this acceptable range. (With the strength of the corrective(s) measure depending on the amount of error and the trend in the actual target vs. the required target.)

In an Individual Dispatcher Auction, once the set of competing bids eligib(S,E) is determined for query S and environment E, these bids are considered within a simple auction for the query. In most cases the decision is simple: assign the unit of supply (or query) to one or more bids with the maximal weighted bid price(s), using an associated virtual price where necessary. Different pricing methods are described hereinafter.

Also disclosed is how to allocate queries when multiple bids are allocated simultaneously, as in the case of ad auctions where multiple adverts can be displayed to a user at the same time: each query can be allocated across multiple bids -with each bid receiving its own “slot” k on the displayed web browser of a user executing the query. More generally, queries might not be received simultaneously such that the dispatcher can not make joint decisions about allocation. Here, the constraints specified by the optimizer on joint allocations should be respected.

The winner determination problem in this multi-query setting can be formulated and solved using a number of different techniques. When the problem is small enough it can be solved optimally using tree-search techniques via a formulation, such as a mixed-integer program (MIP). This is described hereinafter. When the problem is too large or the time constraints to tight to allow for an optimal decision, any number of heuristics can be used. For example, local search methods, greedy methods based on assigning a rank to each bid, linear programming with rounding to generate integer solutions, etc.

An example MIP formulation in the application to ad auctions will now be described. Suppose that the current supply (or query) falls in class c and that a determination is being made of the allocation of each eligible bid to a slot k on the displayed web browser of a user. Suppose that there are M slots available in total. One possible MIP formulation for this winner determination problem is:

$${max}_{{x}_{{i}_{k}}} {\sum }_{i = 1}^{N} {\sum }_{k = 1}^{M} {w}_{ij} ( c , E ) \cdot {price}_{i} ( k ) \cdot {x}_{i , k} + {\sum }_{k = 1}^{M} {x}_{0 , k} reserve ( c , E )$$

$$\begin{matrix}s . t . {\sum }_{i = 0}^{N} {x}_{ik} \leq 1 , & ∀ k \leq M & ( \text{constraint} 1 ) \\ {\sum }_{i = 1}^{N} {x}_{i , k + 1} \leq {\sum }_{i = 1}^{N} {x}_{i , k} , & ∀ k < M & ( contraint 2 ) \\ {\sum }_{i = 1}^{N} {x}_{ik} \leq 1 , & ∀ k & ( contraint 3 ) \\ {\sum }_{i = 1}^{N} {\sum }_{k = 1}^{M} {x}_{ik} \leq max ( c , E ) & & ( constraint 4 ) \\ {x}_{ik} = 1 , & ∀ i \geq 1 , ∀ k > {maxrank}_{ij} ( c , E ) & ( constraint 5 ) \\ {x}_{ik} ∈ \{ 0 , 1 \} , & & \end{matrix}$$

where xᵢₖ indicates whether bid i wins slot k (with a smaller k indicating a higher rank), where wᵢⱼ(c,E) is the weight as defined for bid j from advertiser i that is relevant for the current query and environment (and similarly for max(c,E) and maxrankᵢⱼ(c,E)). Constant priceᵢ(k) is the expected payment from the bid if it is allocated a query, defined as the minimal of the bid-price associated with the bid for rank k (or the virtual price, when assigned) and the remaining budget, and then multiplied by the probability of click-through. Bidder 0 simulates the role of the reserve price reserve(c,E) for this query, and is willing to buy any number of slots for this price.

Constraint 1 ensure that no slot is sold more than once. Constraint 2 ensure that slots are allocated highest-rank first. Constraint 3 ensure that no bid is allocated more than one slot. Constraint 4 respects the condition from the optimizer that might limit the total number of winners. Constraint 5 respects the limit from the optimizer on the rank that an advertiser is willing to accept. Additional constraints, for instance to provide for exclusivity, or separation to competitors, etc. can also be introduced.

The clearing decision can be priced in a variety of ways. For example, a simple “first price” rule could be used whereby the payment by a winning bid is equal to the bid price. In the case of a second-price auction and a single unit of supply (or query) the pricing works as follows. With weights wₑ on each bid j, the winner of the auction is the bid with max wⱼbⱼ (where bⱼ is the bid price) and makes payment wᵢbᵢ/wⱼ where bid i has the second highest weighted bid price. When the weights are all set to one this is equivalent to the Vickrey auction.

Payments can also be collected in a way that depends on some observable property that occurs as a result of the allocation. For example, in ad auctions one can charge bids only in the case that a click-through and/or an exposure) occurs. Now, when there is probability pⱼ of click-through (or exposure) on a bid the decision about which bid wins is made in terms of expected payment and the payment, which is made contingent on click-through (or exposure), is defined so that the expected payment of the winner is equal to the expected payment in the second-highest bid.

Consider an example with the following bids, with weights, probability of click-through, and bid-price as defined:
bid 1: weight 2, probability 0.1, bid-price $30;
bid 2: weight 1, probability 0.2, bid-price $20; and
bid 3: weight 1, probability 0.5, bid-price $4

The bid with the highest expected weighted bid-price is bid 1, because its expected weighted price is $6, compared with $4 and $2 from bids 2 and 3. Then, the payment from the winning bid is (4·(½)) /(0.1), which is $20. This is the second-highest expected weighted payment rescaled by the weights of bidder 1 and 2, and then normalized for the probability of click-through on bid 1. The final expected payment is guaranteed to be less than the maximum willingness-to-pay.

Here are some additional simple examples of pricing rules.

1. First Price, no Weights on Bids

Suppose the bids have the following bid prices, and probabilities of click-through 0.1, 0.2 and 0.5 (from the statistical model). The expected values are:
bid 1: 0.1 $30 Expected value: $3;
bid 2: 0.2 $20 Expected value: $4; and
bid 3: 0.5 $4 Expected value: $2.

A first-price auction would clear so that bid 2 wins (greatest expected value), and the bidder would pay $20 in the case that the user clicks on the ad.

2. First-Price, Weights on Bids

Now, suppose there is a weight of 2 on bid 1 and a weight of 1 on bids 2 and 3. The bids are as follows:
bid 1: weight 2, probability 0.1, bid $30;
bid 2: weight 1, probability 0.2, bid $20; and
bid 3: weight 1, probability 0.5, bid $4.

Now, the weighted expected value is determined:
bid 1: $6;
bid 2: $4; and
bid 3: $2.
   and the winner is bid 1. The bidder would still pay $20 (not $40) in the case that the user clicks on the advert.
   3. First-Price, Multiple Winners

With multiple winners (e.g., 2), then the first-price auction will select bid 2 and bid 1 to be winners (with bid 2 in rank 1, bid 1 in rank 2). Many variations are possible:
a bid that states it can only appear in rank 2 or higher can be handled by introducing a simple constraint into the winner determination decision; and
a bid that has a different bid price for different rank positions can be handled by introducing multiple decision variables to represent that bid, together with a mutually—exclusive constraint.
   4. First-Price, with a Reserve Price

To give a simple example to illustrate how the a reserve price factors into this analysis, consider the same example (again with no bidder eligibility weights):
bid 1: 0.1 $30 Expected value: $3;
bid 2: 0.2 $20 Expected value: $4; and
bid 3: 0.5 $4 Expected value: $2.

Given a reservation price of $5 (this is defined in terms of Expected value), then the auction would decline to accept any bids. Given a reservation price of $3.50, the auction would accept bid 2 and charge than bid $20 on the event of a click-through.

5. Second-Price, No Weights, Reservation Price

Suppose the bids have the following bid prices, and probabilities of click-through 0.1, 0.2 and 0.5 (from the statistical model). The expected values are:
bid 1: 0.1 $30 Expected value: $3;
bid 2: 0.2 $20 Expected value: $4; and
bid 3: 0.5 $4 Expected value: $2.

First, with no reserve price the winner is determined by considering both the bid rice and the probability of click-through. So, the winner would again be bidder 2. In this case, the bidder would pay less than its bid price. The adjusted amount is determined so that the expected revenue from the winning bid is exactly that of the expected revenue at the bid price of the second-highest bid. So, bidder 2 would pay $3/0.2=$15 (expected payment equal to the second-highest expected payment, or the minimal price could have bid to win) in the case that the user clicks on the ad. Given a reservation price of $5 (this is defined in terms of Expected value), then the auction would decline to accept any bids. Given a reserve price of $3.50, then the auction would accept the bid from bidder 2, which would then pay $3.50/0.2=$17.50 (because the reserve price takes the role of the second-highest bid).

Combining the above ideas, one can compute second-price payments for multi-units of supply and with weights. This a form of generalized Vickrey auction payment. Let V (N) define the revenue with all bids, and V (N\i) define the revenue without bid i. The (expected) generalized Vickrey payments are defined for winners as, p_{gva,i}=

$$\frac{1}{{w}_{ij} ( c , E )} [ V ( N \backslash i ) - {\sum }_{{i}^{′} \neq i} {\sum }_{k} {w}_{{i}^{′} j} ( c , E ) {price}_{{i}^{′}} ( k ) {x}_{{i}^{′} k}^{*} ] \qquad ( 6 )$$

where x* denotes the allocation computed in the solution to V(N) with all bids; the final click-through payment is then defined by dividing through by the probability of click-through for bid i.

In further connection with throttling, control variable, αᵢⱼ(c, E) on bid j from bidder i for queries in class c given environment E, define the probability that the bid is selected to be eligible for supply in class c. Given this, the bids are throttled into winner determination for an auction that occurs for supply S ε c by making a random draw from a uniform distribution on (0,1) with the bid considered eligible if and only if z1≦α(j,t). Then, setting the throttle on a bid to one makes a bid always eligible to compete.

The dispatcher can introduce additional control variables to over-ride this throttling decision in the case that other targets are not being met. For example, βᵢⱼ(c, E)ε[0,1] and βᵢ(c, E)ε[0,1], which can be used to modify the decision: in the case that z1≦α(j, t), then additional draws are made z2 distributed uniform[0,1] and z3 distributed uniform[0,1], and the bid is allowed if z2≦β(i, t) and z3≦β(i). So, these over-rides have no effect when the β variables are set to one.

Control variables α and β, defined in this way for each bid and each bidder, define a method to determine the set of bids that are eligible to compete for each query received by the dispatcher.

Standard control techniques can be adopted to adjust the control variables α and β and keep the budget, volume and other targets for each bid within the guidance set by the optimizer when possible. For instance, the dispatcher can set bounds on acceptable variance from the target set by the optimizer, and only use the controls as corrective methods when the performance of a bid falls outside of the bounds. A typical bound can linearly extrapolate based on the period T being handled by the dispatcher and the end-of-period guidance provided in the target set by the optimizer.

Next, the optimizer will be described.

The optimizer module is executed periodically, and does not need to provide instantaneous responses. It is used to parameterize the dispatcher, by providing eligibility weights wᵢⱼ(c,E), virtual prices, as well as budget and volume targets, reserve prices, and other joint constraint information (e.g., constraints on maximal rank, maximal slots, etc. in the case of ad auctions.)

Let x ε X denote the output of the optimizer, defining all of the information that is used to parameterize the dispatcher (including eligibility weights, virtual prices, and targets). Given a set of bids, bids, the most general problem can be considered in the following form:

$$\begin{matrix}{max}_{x ∈ X} {\sum }_{c ∈ C} [ E \{ rev ( c , {x}_{c} , bids , {q}_{c} ) \} + {E}_{M} \{ bonus ( c , {x}_{c} , bids , {q}_{c} ) ] & ( objective ) \\ s . t . {x}_{c} ∈ {Feas}_{M} ( c , bids ) , ∀ c ∈ C & ( feasibility constraint 1 ) \\ x ∈ {Feas}_{M} ( bids ) & ( feasibility constraint 2 )\end{matrix}$$

where x=(x₁, . . . ,x_{C})ε X is factored into decisions for each class c ε C of queries and there are linking constraints Feas_{M}(bids) that ensure, for instance, that the overall budget-constraint for any one bidder is respected in expectation. Feas_{M}(c, bids) indicates a set of constraints implied by the bids and model M on the allocation x_{c} on query class c. Model M is the distributional information available to the optimizer. For instance the optimizer must have predictive information about the future supply and demand in order to make effective decisions. The terms in the objective can be interpreted as follows:
Revenue rev(c,x_{c}, bids, q_{c}) defines the revenue collected in the dispatcher from queries in class c given decision x_{c}, the set of bids bids and given some realized query q_{c}. The optimizer's goal is to maximize the expected revenue, given queries q_{c} as predicted in model M. Naturally, the expected revenue depends on the rules of the auction in the dispatcher module (e.g., second-price vs. first-price, etc.); and
Bonus bonus(c,x_{c},bids,q_{c}) defines the anticipated bonus payment collected in the optimizer from queries in class c given decision x_{c}, the set of bids bids and given some realized sequence of queries q_{c}. Again, this is defined in expectation with respect to model M. The bonus can be broken down into the components defined within the global expressiveness in each bid, for instance to include a bonus for meeting volume targets and exclusivity targets.

The problem can be fully instantiated by providing a concrete model for the terms of the objective and feasibility constraints 1 and 2 above. In order to use standard methods such as mixed-integer programming coupled with tree-search everything must be linearized. With regard to the first term in the objective, this captures the relationship between the payment realized by the dispatcher per query in each class and the parameters, for instance the weights assigned to each bid, the reservation price for a query class, and the target amount of queries allocated to each bid.

The dependence of revenue on parameters depends on the payment rules in the dispatcher. A first-price payment rule in the dispatcher provides the simplest form of optimizer decision. In this case, the optimizer's main decision is to determine the weight to assign to expressive bids vs. spot market bids (yet to be realized.) For instance, if spot market bids tend to be higher than expressive (long-term) bids but would prevent the volume targets and other forms of conditions in long-term bids from being satisfied, then the optimizer will choose to weight in favor of long-term bids. First, given the current bids and the model (or estimate) of future demand (and supply) of spot market bids the optimizer can compute the expected revenue in the dispatcher with default parameters (i.e., all weights set to one, no reserve price, no targets, etc.) This provides the base revenue. The expected revenue given a parameterization can then be determined as a linear adjustment from the base revenue. For instance, model the effect of incrementing or decrementing the weight on each bid with a piecewise linear objective function with breakpoints to model the discrete points at which a bid no longer competes because its weighted price is below that of enough other bids such that it receives no supply.

The second term in the objective captures the one-time payments that will be made by bids if certain targets are achieved. For example, a bid can state a willingness to pay $100 if 100 queries are allocated over the next 24 hours. Given the current bids and the model of future demand and queries in the spot market, the optimizer can compute the probability with which each the target on each bid will be achieved: multiplied with the payment this becomes expected revenue. The expected bonus given a particular parameterization can then be determined as a linear adjustment from the base revenue. For instance, model the effect of incrementing or decrementing the weight on each bid with a piecewise linear objective function with breakpoints to model the discrete points at which a bid no longer competes because its weighted price is below that of enough other bids such that it receives no supply.

The feasibility constraints hide considerable complexity. For example, part of the feasibility is related to the budget constraints specified by a bidder. For instance, given model M and decision x*_{c}, and breaking down revenue and bonus to a particular bidder and to a set of bids j ε Bᵢ submitted by that bidder, the following constraint can be included in Feas_{M}(c, bids):

$${γ}_{1} \cdot [ {\sum }_{j ∈ {B}_{i}} {E}_{M} \{ {rev}_{ij} ( c , {x}_{c}^{*} , bids , {q}_{c} ) \} + {E}_{M} \{ {bonus}_{ij} ( c , {x}_{c}^{*} , bids , {q}_{c} ) \} ] \leq {B}_{i} ( c ) , ∀ i ,$$

where γ₁≧1 is some parameter to tune how risk-averse the optimizer is in its interpretation of the model. Similar constraints can be expressed for the other possible forms of budget constraints. For instance, the global linking constraints in Feas_{M}(bids) can include overall budget constraints that are expressed at the bidder level:

$${γ}_{2} \cdot [ {\sum }_{C ∈ C} {\sum }_{j ∈ {B}_{i}} E \{ {rev}_{ij} ( c , {x}_{c}^{*} , bids , {q}_{c} ) \} + {E}_{M} \{ {bonus}_{ij} ( c , {x}_{c}^{*} , bids , {q}_{c} ) \} ] \leq {B}_{i} , ∀ i ,$$

where γ₂≧1 is another parameter to tune how risk-averse the optimizer is in its interpretation of the model, and Bᵢ is used here to denote the overall budget constraint of bidder i. More details are provided hereinafter about budget constraint modeling in applications to ad auctions.

Additional feasibility constraints capture requirements such as exclusivity: if bid 1 requires exclusive access to queries in class c if selected as a winner, than a constraint is required to capture the logic “assigning non-zero weight to bid 1 on class c implies that zero weight is assigned to all other bids on this class.” Such constrains are readily captured within MIPs. To provide another example: if bid 1 requires that its bid receives at least 50% of the queries in class c if accepted as a winner then this can be captured within the MIP as a constraint “assigning non-zero weight to bid 1 on class c implies that the expected fraction of supply received by bid 1 given the weights is at least 50%.”

In associating virtual prices with each expressive bid selected as a winner (i.e., allocated at least one query), the optimizer considers the amount of bonus payment associated with a bid and also the remaining number of queries needed to achieve the bonus. The payment is amortized across the residual number of queries. For instance, if the bid is willing to pay $100 for 30 queries in some class then this becomes a virtual price of $10/3 per-query. Later, if the optimizer refines the decision when only 20 queries remain to be allocated, this virtual price will be refined to $100 for 20 units and thus $5 per query. This represents that the quantity previously allocated is now a sunk cost but the bonus has not yet been received.

In the context of the present invention to ad auctions, the details of the MIP formulation can be further expanded as follows.

Let Bonus(x, j, Bids) denote the bonus payment associated with bid j because of allocation decision x. This can be broken down into the components defined in the bid information, for instance:

$$\begin{matrix}Bonus ( x , j , Bids ) = {\sum }_{t ∈ TargetClasses ( j )} vBonus ( t , j , countB ( j , t , x , Bids ) ) + \\ {\sum }_{( t , bs ) ∈ NotWin ( j )} vNotWin ( t , bs , j , countN ( bs , t , x , Bids ) ) + \\ {\sum }_{t ∈ TargetClasses ( j )} vE ( t , j , isExclusive ( t , j ) )\end{matrix}$$

Functions countB, countN and isExclusive(t) are defined as follows:
1. countB(j, t, x, Bids): the number of click-throughs that will be achieved on searches in set t for adverts associated with bid j given optimizer decision x and given the submitted bids, Bids. This is an estimate, and computed in terms of the statistical model of the search engine and user context.
2. countN (bs, t, x, Bids): the number of click-throughs that will be achieved on searches in set t for adverts associated with bids in set bs given optimizer decision x and given bids, Bids.
3. isExclusive(t, j)ε{0, 1}: set to one if the bid j gets exclusive advertising rights on searches in set t, and set to zero otherwise.

The budget constraints at the bidder level, are in turn decomposed as follows:
Σ_{θεΘ}Σ_{jεBid(i)}(Revⱼ(θ, x, Bids)+Bonus(x, j, Bids))≦Budget(i), for all i ε Bidders
Σ_{θεt}Σ_{jεBid(i)}Revⱼ(θ, x, Bids)≦Budget(i, t), for all i ε Bidders, for all t ε BidderTargetClasses(i)

The budget constraints at the bid level, are in turn decomposed as follows:
Σ_{θεΘ}Revⱼ(θ, x, Bids)+Bonus(x, j, Bids)≦Budget(i, j), for all i ε Bidders, j ε Bid(i)
Σ_{θεt}Revⱼ(θ, x, Bids)≦Budget(j, t), for all j ε Bids, for all t ε TargetClasses(j)

Moreover, distributional information in the context of ad auctions can be more specific. The kind of information that can be used to guide decisions made by the optimizer in this context includes:
A model to predict the frequency of particular search queries and contexts, perhaps conditioned on environment E, where the environment might define information such as the time-of-day, or the country that defines a user population; and
A model to predict the probability that an advert will be clicked on given a query and given the context of the search query.

In collecting information to be able to learn such a model there is a potential sampling bias: as some bids win and adverts are displayed, then more data is collected on the click-through rate on these bids and these bids might continue to win while the model for the click-through rate on other adverts remains uncertain. This can be handled by always including some random exploration, to ensure that the statistical model is sufficiently accurate. Fairness can be ensured during exploration, for instance by simply not charging for adverts that are displayed while the system is collecting statistics and having phases of exploration and exploitation. The model must be initialized for new adverts, so that it can provide reasonable predictions of the click-through rates on new adverts even before the advert has been displayed. For this, one can include features about adverts in the statistical model (e.g., words in the advert, the domain, semantic key words), and also couple this with exploration where new ads are showed pro-actively to a subset of the user population to collect initial statistics.

A parameterized dispatch auction on a small example from the ad auction domain will now be described. A variation on the same example will be revisited hereinafter in connection with other variations of optimize and dispatch. Initially, assume:
bids are for search terms of queries, perhaps on logical combinations of terms;
only one winner is selected per search term;
the optimizer has a time horizon of three hours and is used every hour to reconfigure the parameters in the dispatcher;
the dispatch period, therefore, is one hour;
the optimizer sets a weight on each bid, a target quantity for each bid, and assigns a price to each bid (important for bids with only long-term payments given that the bids compete in a sequence of dispatch auctions for instantaneous supply);
for simplicity, assume that no expressive bids extend beyond the next three hours; and
for simplicity, assume no budget constraints

Assume also that there are the following two expressive bids A and B Bid A is valid for three periods and bid B for two periods and model for the following bids in the spot market, i.e., the short-term non-expressive bids, both active from period one (the first hour).
Bid A pays $300 if it receives 20 (or more) queries including the terms “Football+Betting” over the next three hours;
Bid B pays $100 if it receives 30 queries including term “Football” over the next two hours, and will pay a bonus of $5 per query including the terms “Football & Tickets” over the next two hours whether or not that target is reached; and
Spot market contains an ample supply of bids for around $1 per query in the market. (There could be some variance in the actual spot market bid prices.)

In addition, assume the following distributional data. Based on past observations, there exists for any period (i.e., hour interval) a distribution over the number of queries for any specific search term. Rather than give the actual distribution, for the purpose of this example only the expected number of queries in each class are provided.

For each of the first two periods, assume the distribution over the number of queries in each of the following four classes has the stated mean: (F=football, B=betting, T=tickets; [symbol] w means w is not in the query):

| | | | | |
|---|---|---|---|---|
| Class 1 (C1) = | F | B | T: | 2 |
| Class 2 (C2) = | F | B | [symbol] T: | 8 |
| Class 3 (C3) = | F | [symbol] B | T: | 6 |
| Class 4 (C4) = | F | [symbol] B | [symbol] T: | 10 |

For period three, the mean number of queries in each class is the same except for (FB [symbol] 7), which has 15 expected queries (e.g., later in the evening so more “betting” queries expected.

| | | | | |
|---|---|---|---|---|
| Class 1 (C1) = | F | B | T: | 2 |
| Class 2 (C2) = | F | B | [symbol] T: | 15 |
| Class 3 (C3) = | F | [symbol] B | T: | 6 |
| Class 4 (C4) = | F | [symbol] B | [symbol] T: | 10 |

Note that the expected total number of football queries is 26 per period in the first two periods. Note also that in period 1, not enough queries are expected to fulfill either of the major conditions of the expressive bids, so a myopic dispatcher (one that did not consider the impact of future allocations on the value of a bid) would have no reason to assign any queries to either bid (since it would not expect to see any revenue, except in the case of the bonus in bid B, which can be treated as a nonexpressive bid). Thus, it is critical that some information be provided to the dispatcher that enables it to consider the expected value of assigning queries in a way that accounts for future assignment of queries to those bids.

Furthermore, note that there is considerable uncertainty in the number of queries to be received, so that a decision to assign a certain percentage of queries to a specific bid in a given period does not necessarily realize an assumed target. This means that the allocation of queries at any period should be contingent on the actual, realized allocation of queries in previous periods. (Or if not contingent, the optimizer should be called frequently to allow for replanning when the future does not play out as expected.)

Next, an parameterized dispatch method will be described.

In this example the optimizer is allowed to assign the following information in parameterizing the dispatcher at the start of each period:
1. a target volume of allocation of queries to each bid in each supply class;
2. a virtual price per query assigned to each bid in each query class; and
3. a weight to each bid in each query class

The virtual price is assigned to allow bids that only include bonus payment terms to nevertheless compete in the dispatch auctions. The total payment is divided across the different queries that must be allocated in order to achieve the bonus. Realize that the virtual price associated with a bid in this way is not collected by the dispatcher—the bonus payment, if achieved, is finally collected in the optimizer. But, the virtual price is used to guide the decision making of the dispatcher.

Suppose the optimizer assigns the following targets and weights at period 1, expressed as (target, weight) pairs, for each class of supply to bids A, B and the spot market (S). A pseudo-bid (B′) is also introduced to represent the marginal value to bid B for allocation of supply above and beyond that which achieves the 300 volume target required for the $100 bonus. Beneath the target quantity and weight is the bid price assigned to long-term bids by the optimizer.

| | A | B | B′ | S |
|---|---|---|---|---|
| C1 | (0, 0) | (*, 1) | (0, 0) | (0, 0) |
| | 15 | 8.3 | 5 | — |
| C2 | (4, 1) | (4, 5) | (0, 0) | (0, 0) |
| | 15 | 3.3 | 0 | — |
| C3 | (0, 0) | (*, 1) | (0, 0) | (0, 0) |
| | 0 | 8.3 | 5 | — |
| C4 | (0, 0) | (4, 1) | (0, 0) | (6, 3) |
| | 0 | 3.3 | 0 | — |

The targets are 4 for class C2 to each of bid A and bid B, 4 and 6 of class C4 to bid B and S respectively, and ‘*’ indicates that bid B is allocated as much as possible of classes C1 and C3. The weights are zeros for bids with no target in a class and one on a bid that is the exclusive target in a class. For classes in which a particular target split is required of supply (e.g., C2 and C4) the weights are assigned to make the weighted bid prices of the active bids similar so that the dispatcher will be able to achieve good enough control through the throttle algorithm.

The price assigned by the optimizer is 15 per query given to bid A (since 300/20=15), and then 5+(100/30)≈8.3 to bid B on classes C1 and C3 and 100/30≈3.3 to bid B on classes C2 and C4. Similarly, the price is 5 to bid B′ for C1 and C3 and zero otherwise. (Note that there is no target volume set for B′ in this period though, since bid B will not yet have acquired the required total volume of 30 queries.) To understand the weight of 5 to bid B in class C2, notice that this makes the price on B roughly competitive with that on bid A; similarly for the weight of 3 on spot bids in class C4 (recall that spot bid prices around $1.)

While the precise optimization is not described (which will generally depend on details including the specific distribution over number of queries), which can readily be formulated by one of ordinary skill in the art, the rationale for such an assignment, which tends to give priority to bid B is as follows:
1. Bid B has a shorter time horizon than bid A (two periods rather than three), so to meet the quota of 30 queries, we prefer to assign queries earlier to bid B;
2. Even though bid A has higher value for meeting its quota, the longer horizon, and the fact that expected queries allocated to bid A will increase during the third period further lessens the incentive to assign queries in period 1 to bid A rather than bid B;
3. The targets are defined to allow the bids to reach, in expectation, around 10% above the target quantity required to achieve their targets. For bid A this means 22 in class C1 or C2 by the end of period 3. With 15 coming in period 3, this requires 7, or around 4 additional queries, in each of periods 1 and 2. C2 is assigned to bid A instead of C1 because bid B has more value for C1 than for C2; and
4. For bid B, the safety margin of 10% gives a required total quantity of 33, which is around 16 per period. The quantity target is designed to provide around 16 this period.

This information calculated by the optimizer is handed off to the dispatcher. The dispatcher can then use throttling to achieve the targets specified. Classes C1 and C3 are trivial because there is a single agent with non-zero weight. Bid B is the only bid that competes for supply in C1 and C3: no throttling is required. For class C2 the goal is to achieve a 50/50 split of queries. To realize this split the throttling parameter are initialized α_{A}(C2)=α_{B}(C2)=1.0. Given the illustrated weights, bid B will win the first time supply (query) C2 is realized (since 5×3.33>15). The dispatcher will then estimate the probability that bid B wins conditional on it participating in the auction as 1.0 and drop α_{B}(C2)=3/7 to achieve the required total volume of 4. If bid B is not throttled in 3 more times this achieves the volume target.

For class C4 the goal is a 40/60 split between bid B and the spot market. Initialize α_{B}(C4)=1 and α_{S}(C4)=1 so that they both compete in the first auction for class C4. Suppose the spot market wins. Set α_{S}(C4)=5/9. Next time, if the spot market loses, the dispatcher will update its estimate of the probability that the spot market wins conditional on its participating in the auction as 0.5 and it will set α_{S}(C4)=1 to achieve the target of 6 in expectation (and perhaps also drop α_{B}(C4) slightly to provide a further boost to the spot market.)

Next, realizations in period 1 and the impact of these realization on the parameters defined for period 2 will be described.

Given the uncertainty in the receipt of queries, many possible outcomes are possible. Several scenarios and their implications are now considered:

SCENARIO I: Suppose the expected number of queries are realized in each query class in period 1 (note that the odds of this happening can be extremely low).

| | A | B | B′ | S |
|---|---|---|---|---|
| C1 | 0 | 2 | 0 | 0 |
| C2 | 4 | 4 | 0 | 0 |
| C3 | 0 | 6 | 0 | 0 |
| C4 | 0 | 4 | 0 | 6 |

In this scenario, bid B received 16 football queries in period 1 and requires only 14 in period 2 to meet its payment target of 30. Bid A received 4 queries contributing towards its target of 20. The optimizer will make about the same decisions because the allocation was as expected and because the optimizer had already planned on a smooth allocation of queries across time. The revised target, weight, and bid price information passed to the define parameters in the dispatcher module are:

| | A | B | B′ | S |
|---|---|---|---|---|
| C1 | (0, 0) | (*, 1) | (0, 0) | (0, 0) |
| | 18.8 | 12.1 | 5 | — |
| C2 | (3, 1) | (5, 3) | (0, 0) | (0, 0) |
| | 18.8 | 7.1 | 0 | — |
| C3 | (0, 0) | (*, 1) | (0, 0) | (0, 0) |
| | 0 | 12.1 | 5 | — |
| C4 | (0, 0) | (3, 1) | (0, 0) | (7, 8) |
| | 0 | 7.1 | 0 | — |

For some justification for this: (a) bid A needs 16 more queries, and 18 to be safe, and for this reason 3 more queries of C2 are allocated; (b) bid B needs 14 more queries, and so 16 to be safe, and thus supply of at least 16 queries is allocated (with more of C1 and C3 because of their value). Again, the weights are assigned (to bid B for class C2 and to the spot bids for class C4) to allow for some control in throttling, by making bids approximately competitive in the short-term when they are judged competitive in the long-term by the optimizer module. The price of 18.8 is assigned to bid A for classes C1 and C2 because 300/16≈18.8. A price of 12.1 is assigned to bid B for classes C1 and C3 because 5+100/14≈12.1. For classes C2 and C4, price 7.1≈100/14.

SCENARIO II: Suppose the number of queries in each query class in period 1 is much lower than the expected value (50% lower):

| | A | B | B′ | S |
|---|---|---|---|---|
| C1 | 0 | 1 | 0 | 0 |
| C2 | 2 | 2 | 0 | 0 |
| C3 | 0 | 3 | 0 | 0 |
| C4 | 0 | 2 | 0 | 3 |

In this scenario, bid B received only 8 football queries in period 1 and requires 22 in period 2 to meet its payment target of 30. Bid A has received only 2 queries contributing towards its target of 20.

How the dispatcher should alter its allocations depends on several factors, specifically the variance in the distribution over queries. In this scenario we assume that variance on the number of queries that will be received in period 3 is known to be very low.

For this reason, the optimizer continues to aim to achieve both the targets of bid A and bid B. This is only reasonable if it is very likely that bid A will receive 15 units of class C2 in the third period. The updated parameters become:

| | A | B | B′ | S |
|---|---|---|---|---|
| C1 | (0, 0) | (*, 1) | (0, 0) | (0, 0) |
| | 16.7 | 9.5 | 5 | — |
| C2 | (3, 1) | (5, 4) | (0, 0) | (0, 0) |
| | 16.7 | 4.5 | 0 | — |
| C3 | (0, 0) | (*, 1) | (0, 0) | (0, 0) |
| | 0 | 9.5 | 5 | — |
| C4 | (0, 0) | (*, 1) | (0, 0) | (0, 0) |
| | 0 | 4.5 | 0 | — |

The price of 16.7 assigned to bid A comes from 300/18≈16.7 (since bid A needs 18 more units of supply). The price of 9.5 assigned to bid B for classes C1 and C3 comes from 5+100/22≈9.5; and similarly for bid B in classes C2 and C4. If the expected quantity is realized then 23 queries will be allocated to bid B and it will realize its target (22 more are needed for this.) Also, if bid A achieves 3 queries, then bid A can still achieve the final target of 20 with 15 more in the next period. The weights on bid A and bid B for class C2 are set to achieve a good parity between bid prices in order to enable control via throttling in the dispatcher.

Throttling would work in this scenario as follows. Throttling is only non-trivial for class C2 because that is the only class where some balance of queries must be allocated across bids. The dispatch module can assign throttling parameter α_{A}(C2)=1 and α_{B}(C2)=1 initially. Suppose bid B wins. Then bid B needs another 4/7 of the remaining supply to meet the target and if the dispatcher updates its model to assume that bid B will win with 100% likelihood when it competes with bid A (as is true because the weighted price of bid B is 18, greater than 16.7 from bid A), then it will set α_{B}(C2)=4/7. If the expected supply is realized the dispatcher meets the target.

SCENARIO III: Suppose the number of queries in each query class in period 1 is much lower than the expected value (50% lower):

| | A | B | B′ | S |
|---|---|---|---|---|
| C1 | 0 | 1 | 0 | 0 |
| C2 | 2 | 2 | 0 | 0 |
| C3 | 0 | 3 | 0 | 0 |
| C4 | 0 | 2 | 0 | 3 |

In this scenario, bid B received only 8 football queries in period 1 and requires 22 in period 2 to meet its payment target of 30. Bid A has received only 2 queries contributing towards its target of 20.

How the dispatcher should alter its allocations depends on several factors, specifically the variance in the distribution over queries. In this scenario we assume that variance on the number of queries that will be received in period 3 is known to be very high.

This means that even if we assign a large fraction of “Football & Betting” queries (classes C1 and C2) in period 3 to bid A, there is a good chance that the expected value of 17 in classes C1 and C2 queries for bid A in period 3 may not be achieved. Thus the only way to reach bid A's targets is to ensure it gets a reasonable fraction of C1 and C2 queries at period 2.

If this is the case, the dispatcher should “abandon” bid B's targets, since the revenue associated with bid B is much smaller than that for bid A. As a consequence, classes C2 and C4 assigned to bid B should be reduced to zero (since they have no bonus) and it is most likely that these queries will be “wasted” if assigned to bid B. All (or most) C2 queries should then be assigned to bid A, and all C4 queries to the spot market. Classes C1 and C3 (which accrue the “ticket” bonus) may still be assigned to bid B depending on the specific odds and expected bids on the spot market. To be specific, suppose that the dispatcher assigns the following new parameters:

| | A | B | B′ | S |
|---|---|---|---|---|
| C1 | (1, 1) | (0, 0) | (1, 4) | (0, 0) |
| | 16.7 | 0 | 5 | — |
| C2 | (8, 1) | (0, 0) | (0, 0) | (0, 0) |
| | 16.7 | 0 | 0 | — |
| C3 | (0, 0) | 0, 0) | (*, 1) | (0, 0) |
| | 0 | 0 | 5 | — |
| C4 | (0, 0) | (0, 0) | (0, 0) | (*, 1) |
| | 0 | 0 | 0 | — |

Notice that supply is allocated to bid B′ and not bid B because the bonus (one-time payment) associated with bid B is no longer valid. Thus bid B′ receives the allocation of supply (representing the constant ticket price provided in the actual bid B regardless of meeting the target.)

To justify the specific decision in the above parameterization: (a) suppose it is quite possible that bid A would receive as few as 10 queries from class C2 in period 3, even though the quantity is 15 in expectation (i.e., high variance). For this reason, bid A gets 8 queries now and thus allocate 9 in total to provide a safety margin. First class C2 is provided to bid A, and the one query of class C1. Bid B′ gets the remaining queries of class C1 and all queries of class C3 because the per-query price is greater than that from the spot market.

In this case the dispatcher would throttle as follows: α_{A}(C1)=α_{B′}(C1)=1 initially. Now, if bid A wins the first unit then α_{A}(C1)=0 and the future unit will go to bid B′. Vice versa if bid B is the first winner.

SCENARIO IV: Suppose the number of queries in each query class in period 1 is much higher than expected (50% higher):

| | A | B | B′ | S |
|---|---|---|---|---|
| C1 | 0 | 3 | 0 | 0 |
| C2 | 6 | 6 | 0 | 0 |
| C3 | 0 | 9 | 0 | 0 |
| C4 | 0 | 6 | 0 | 9 |

In this scenario, bid B received 24 football queries in period 1 and requires only 6 more in period 2 to meet its payment target of 30. Bid A has received 6 queries contributing towards its target of 20.

For throttling in period 1 in this case: the dispatcher module can be designed to keep the relative allocation in proportion to the targets set by the optimizer module in the case that more queries are received then was anticipated. For instance, once bids A and B have received 4 queries each of class C2, then the dispatcher can set incremental targets, e.g., in incremental (balanced) amounts of 2 units of class C2 each, to bids A and B. (Alternatively the optimizer could provide the dispatcher with a target schedule, with adjustments made in the case that unexpected supply was received.)

In this case, the dispatcher would alter its targets so that six more queries (in classes C1 and C3) are allocated to bid B, followed by the remaining queries in those categories to bid B′. (The optimizer could also be modified to provide the dispatcher with information to allocate queries to satisfy the bid B target and then allocate queries to satisfy the bid B′ target only when the bid B target is achieved. In this case, since bid B′ is simply a shadow bid to represent the “ticket” bonus in bid B this is not necessary). For bid A, recognizing that 14 more queries are required in total and working with a 10% safety margin, 1 query of C2 is allocated in this period to join the 15 to be allocated next period. The remaining queries (for classes C2 and C4) are allocated to the spot market.

The parameterized target, weight and price information passed to the dispatcher could look as follows:

| | A | B | B′ | S |
|---|---|---|---|---|
| C1 | (0, 0) | (1, 1) | (1, 4) | (0, 0) |
| | 21 | 21.7 | 5 | — |
| C2 | (1, 1) | (0, 0) | (0, 0) | (7, 20) |
| | 21 | 16.7 | 0 | — |
| C3 | (0, 0) | (5, 1) | (1, 4) | (0, 0) |
| | 0 | 21.7 | 5 | — |
| C4 | (0, 0) | (0, 0) | (0, 0) | (*, 1) |
| | 0 | 16.7 | 0 | — |

Here, the price set for bid A in classes C1 and C2 is 21≈300/14, and the price for bid B in classes C1 and C3 is 21.7≈5+100/6, and just 16.7≈100/6 in classes C2 and C4. Weights are assigned to bids in classes with split allocations to provide the throttle control some power: For class C2, the weights would be initially α_{A}(C2)=1 and α_{S}(C2)=1. Suppose that bid A wins the first query of class C2. Then α_{A}(C2)=0, and remaining queries are allocated to the spot market. Similarly for class C1 and C3. The period 3 decision would look as in period 3 in the standard case.

Next, realizations in period 2 and the Impact of these realizations on Parameters in period 3 will be described.

Consider again the case in which exactly the queries that were expected occurred (recall this is very unlikely.) Then at the end of period II, the total (cumulative) allocation to each bid would be:

| | A | B | B′ | S |
|---|---|---|---|---|
| C1 | 0 | 4 | 0 | 0 |
| C2 | 7 | 9 | 0 | 0 |
| C3 | 0 | 12 | 0 | 0 |
| C4 | 0 | 7 | 0 | 13 |

Bid B achieved 32 queries and met the target of 30. The total payment received by the auctioneer would be $100 and an additional 16 @ $5, i.e., $90, for the queries allocated in class C1 and C3. Running the optimizer again for period III could yield settings like the following for bid A and the spot market:

| | A | S |
|---|---|---|
| C1 | (0, 0) | (*, 1) |
| | 23.1 | — |
| C2 | (15, 1) | (0, 0) |
| | 23.1 | — |
| C3 | (0, 0) | (*, 1) |
| | 0 | — |
| C4 | (0, 0) | (*, 1) |
| | 0 | — |

Here, the price set by the optimizer for bid A in classes C1 and C2 is 23.1≈300/13. To reason about these parameters notice that bid A has 13 queries to go in order to achieve its goal of 20. For a 10% safety margin the optimizer proposes to allocate 15 queries to bid A (i.e., all of the expected supply in class C2). The spot market receives the rest of the supply. trivial weights of 1 or 0 are sufficient here and so dispatch is especially easy.

As another illustration of period 3 decisions, consider a continuation of Scenario II, above, in which only a small supply had been realized in period 1. Further suppose that bid A did not achieve the required target of 3 queries in class C2 during period 2. For example, if the number of queries was less than expected and the bid received no allocation of queries then it would go into the third period requiring an additional allocation of 18 queries. If the supply of queries in class C2 is low variance (i.e., almost definitely 15) in period 3, coupled with the number of queries in class C1 likely to be 2, then the optimizer would abandon bid 1 in this final period and direct the dispatcher to place all remaining supply into the spot market.

The foregoing examples illustrate the importance of adjusting the parameters utilized by the dispatcher based on the receipt of queries. One way to address this is to provide the dispatcher with contingent parameters, e.g., a tree of parameters whereby the dispatcher follows events in the decision tree (e.g., supply was less than 50% that expected, etc.) and reconfigures parameters during one or more dispatch periods. Another way, as shown in the example, is to call the optimizer at the end of dispatch periods (i.e., after each hour) and reoptimize the parameters.

Realize that when queries are allocated to the spot market, there is not a single bid in the spot market, but rather all spot bids for a particular query class compete online for the right to a query.

The optimizer assigns a “virtual price” with each expressive bid to represent the per-query willingness-to-pay of the bid based on an expectation about a final bonus payment being received by the optimizer. This price is used to enable the bids to compete in the dispatch auctions even when the only component of a bid's price is a one-time payment. The virtual price is adjusted across periods based on the received queries and tends to increase, representing the fact that fewer and fewer additional queries are required to complete a contract and achieve the bonus.

Should another expressive bid arrive, that bid is incorporated into the decision that will be made by the optimizer, e.g., if a bid arrives at the start of period 2 that offers $200 for 10 units of class C4 then there is not enough remaining queries to satisfy bid B in the expected case (since bid B needs 14 more queries and there is only 13 more queries once 3 are allocated to bid A to ensure it will meet its target in period 3, and pay $300.) Thus, bid B would be abandoned in favor of the new bid (since $200 is a larger payment than the bonus of $100 offered by bid B.)

In another variation of optimize-and-dispatch called Long-Term And Spot Market, the optimizer decides which long-term expressive bids to allocate queries to and which portions of future queries to allocate to competition in the spot market. The spot market contains bids that are either non-expressive or have limited sequential expressiveness. For instance, the spot market may include bids with constant willingness-to-pay per query allocated (e.g., “$0.10 per betting query”), but can also include bids with a budget constraint (e.g., “but no more than $100 per day”). Spot market bids can also be defined with contingent payments that depend on observable outcomes of allocations, for instance click-throughs or exposures in the context of ad auctions. The long-term, expressive bids, are those with conditions on payments that must be interpreted with a longer time horizon, for instance payments that depend on a sequence of allocation decisions (e.g., “$100 for the exclusive rights to receive queries in class C1 for a week.”)

The optimizer defines simple, non-contingent rules, to define the allocation decisions that will be made within the dispatcher. Thus, the dispatcher is especially simple in this variation: it uses the (deterministic) rules set by the long-term market (implemented by the optimizer) to decide whether each received query goes to the long-term bids or to the spot market. For instance, a dispatch rule could be “assign 10 queries in class C1 to bid B”. The optimizer defines simple rules that completely define the allocation decisions made by the dispatcher.

The long-term market is run periodically and includes standing bids to represent the spot market. For instance, in the context of ad auctions, a long-term bid could be from a car rental company and state that it will “pay $1000 if it receives the top slot on all queries that mention the term ‘car rental’ over the next month.” Another bid might ask for 30% of the supply of all car rental queries on Thursdays for the next month, and be willing to pay $500 (and be willing to be in the second slot.) A third bid might be from a company willing to “pay $5000 for exclusive advertising rights in response to ‘car rental’ queries over the next 2 weeks.” The long-term market (cleared by the optimizer) also has standing bids representing spot market bids for car rental. For instance, a standing bid might be “pay $0.30 for any of the top four slots in response to a ‘car rental’ query.”

The task facing the optimizer is to decide what fraction of supply, in each class of queries, to allocate to each long-term bid and what fraction to leave to the spot market. Once this decision is made (and it requires that the optimizer has a model or estimate of the realization of queries during the dispatch period and also future realization of bids, both in the spot market and for expressive bids), the rules are passed to the dispatcher. The dispatcher module includes a competitive spot market, whereby non-expressive (spot) bids compete for supply allocated to the spot market.

In this instantiation of the optimize-and-dispatch architecture, the rules provided to the dispatcher form a non-contingent policy that will be implemented until the next period of optimization. The optimizer might be run once an hour, once a day, or some other period, as appropriate to the variance in the supply and demand in the market. One method to perform optimization is to replace distributional information with expectations over supply and demand and treat these expectations as if they are guaranteed to be realized.

The decision facing the optimizer is then a binary decision for each expressive bid i.e., whether to accept the bid or not, and thus commit the requested supply capacity to the bid. Some specific details are provided hereinafter on the “rule based” optimize-and-dispatch architecture, which operates like the long-term and spot market design except potentially with contingent plans provided to the dispatcher. At a high-level, the optimization problem is formulated for the long-term and spot market design can be solved in the following sequence of steps:
1. Identify the query classes that are relevant given the statement of long-term expressive bids. Each bid identifies a class of queries (Cᵢ per bid.) A set of classes of queries is then formed by taking the union of all intersections of query class, as specified in each bid. For example, if one query class is for “hot dogs” and another is for “hot dogs and relish” then there will be two classes of query formed: “hot dogs” and “relish”. The expressive bid for “hot dogs and relish” would require an allocation of a query that covers both of these subclasses. Temporal constraints also come into play. For instance, if one bid is for “all hot dog queries” and another is for “hot dog queries on Fridays” then the appropriate subclasses are “hot dog queries on days other than Fridays” and “hot dog queries on Fridays.”
2. Construct standing bids to represent queries in the spot market in each one of these subclasses of queries. For instance, if the final set of classes as defined by taking the intersection of all queries in the expressive bids is some set C, then the value of the spot market for each query in each class should be represented by a standing bid for each class (e.g., “$0.50 per query in class ‘hot dog’.”)
3. Form expectations about the total supply in each class to be able to convert all bids, both those representing the spot market and those representing the expressive long-term bids (which could also include per-unit-of-supply payments) into single, lump sum, payments (calculated in expectation), when different fractions of queries are allocated e.g., the standing bid for hot dog queries in the spot market can be converted into a bid of “$800 per percentile of the hot dog market over the next month” to allow it to be compared against expressive bids with one-time payments.
4. Construct a mixed-integer program (MIP) to solve the problem: associate decision variables zᵢⱼε[0,1] to define the fraction of query class j assigned to bid i, and constraints Σᵢzᵢⱼ≦1 for each query class j. Associate zero-one (binary) variables with expressive bids (e.g. xᵢ ε{0,1}) to indicate whether the conditions of the bid are met, and write constraints (using indicator variables as necessary) to capture the logic underlying the bids. Also, include constraints to capture conditions such as budget constraints, exclusivity constraints, limitations on the kind of allocation (e.g., the rank of the slot in the case of ad auctions), etc. The objective of the MIP contains the expected revenue that will be achieved from allocating some fraction of supply to each bid.
5. Use a tree-search method, such as branch-and-bound search of the type disclosed in U.S. Pat. No. 6,272,473 to Sandholm, which is incorporated herein by reference, to solve the MIP and construct a non-contingent allocation of queries to expressive bids and the spot market to be implemented within the dispatcher.

The dispatcher uses the following sequence of steps to make dispatch decisions.
1. Each time a query is received, the dispatcher inspects the rules from the optimizer and determines which rule, if any, applies. Specifically: the dispatcher identifies which query class contains this query, if any. If no class is identified, then the query defaults to the spot market. Otherwise, go to step 2.
2. The dispatcher considers all rules that apply to this query class, e.g., if this is a hot-dog query then one rule might say “give 10% of the supply to bid A.” The other rules could say: “give 80% of the supply to bid B, and 10% of the supply to the spot market.” Given this, the dispatcher allocates the queries to each bid to satisfy these fractions, i.e., to bid A, bid B and the spot market with probability 0.1, 0.8 and 0.1, respectively.
3. In the case that queries are allocated to the spot market, then the dispatcher finds all spot market bids associated with this class of queries (e.g., all spot bids for ‘hot dogs.’) The dispatcher can then run various variations on auctions for that class of queries with the spot market bids in competition (e.g., a first price auction, second-price auction, first-price multi-unit auction, etc.).

This continues until the end of the dispatch period with the dispatcher monitoring hard constraints such as budget constraints and removing bids from consideration when constraints are violated. (They may be returned in the next dispatch period.)

Consider the following example, which is a variation on the example used to illustrate the parameterized dispatch auction instantiation of optimize-and-dispatch. First, suppose that the optimizer has the following two expressive bids:
Bid A states “payment of $300 if 70% of the ‘Football+Betting’ queries are allocated over the next 3 hours.”;
Bid B states “payment of $100 if 30% of the ‘Football’ queries are allocated over the next 2 hours;
Bid C states “payment of $5 per unit of supply on ‘Football+Tickets’ over the next 2 hours, if receives exclusivity on ‘Football+Tickets’.”; and
Bid S (representing the spot market) states “$1 per unit of supply on any combination of ‘Football’, ‘Betting’+‘Tickets’.”

Suppose also the expected supply is as before (with B for betting, T for tickets, F for football, and [symbol] w for ‘not w’):

| | period 1 | period 2 | period 3 |
|---|---|---|---|
| F B T | 2 | 2 | 2 |
| F B [symbol] T | 8 | 8 | 15 |
| F [symbol] B T | 6 | 6 | 6 |
| F [symbol] B [symbol] T | 10 | 10 | 10 |

Notice that the classes stated in the bids (F,B), F and (F, T) necessitates enumerating these four supply classes to represent the intersection of the supply in each bid. Given this, the optimizer can reason that the following solution is possible:
Bid A will receive 70% of the queries for (F,B, T) and (F,B, [symbol] T);
Bid B will receive 100% of the queries for (F, [symbol] B, [symbol] T) over the next 2 hours, which is (in expectation) more than 30% of the total quantity of football queries;
The spot market bids will receive the rest of the supply; and
Bid C, which requested exclusive rights to (F, T) queries is unsuccessful.

Realize that a model of supply is required so that the optimizer can determine that it is possible (in expectation) to satisfy both bid A and bid B.

Now, suppose that bid D is also available to the long-term market. Bid D states “$6/query if exclusive rights on all football queries that mention either tickets or betting for the next 3 hours.”

In this case, the optimizer would reason that it is not possible to achieve the conditions of bid A in combination with accepting bid D, but that bid B can be accepted in combination (by allocating F, [symbol] B, [symbol] T to bid B.) Thus, whether or not the optimizer accepts bid D depends on considering whether the expected revenue from bid D is greater than or less than from bid A, which is determined by comparing 6(6+31+18)=$330 with the $300 from bid A, and so bid D would be successful and the decision of the optimizer would change to:
Bid D will receive 100% of the allocation on (F, B, T), (F,B, [symbol] T) and (F, [symbol] B, T) for periods 1-3;
Bid B will receive 100% of the allocation on (F, [symbol] B, [symbol] T); and
Bids A, C and the spot market receive no allocation in the long-term market.

Next, is a simple example to illustrate revenue advantages from using the optimize—and-dispatch architecture.

| query | bidder A | bidder B | bidder C |
|---|---|---|---|
| hotdog | $0.99 | $1.00 | — |
| hamburger | — | $1.00 | $0.98 |

Bidder B also has a $10 overall budget constraint. Consider a query stream of 10 queries ‘hot dog’ followed by 10 queries of ‘hamburger.’ Assume a reservation price of $0.05. Now consider solving this in the optimizer and determine a generalized second price auction: solving offline, each ‘hot dog’ query goes to bidder A (to avoid exhausting bidder B's budget) and each ‘hamburger’ query goes to bidder B and the payment made by each of bidder A and B is $9.80, since they displace bidder C. Solving this within the dispatcher, with no guidance from the optimizer, first bidder B would compete against bidder A on each ‘hot dog’ query and pay $9.90. Then, bidder B's budget would be unable to compete against bidder C for each ‘hamburger’ query and the supply of ‘hamburger’ would go to bidder C for 10($0.05)=$0.50, i.e., bidder C would incur the reservation price.

Next, consider the following first-price example. This is also illustrative of the revenue advantages of the optimize-and-dispatch method. Again, there are three bids:

| query | bidder A | bidder B | bidder C |
|---|---|---|---|
| hotdog | $0.99 | $1.00 | — |
| hamburger | — | $1.00 | $0.10 |

Bidder B still has a $10 budget constraint and the query stream is still 10 queries of ‘hot dog’ followed by 10 queries of ‘hamburger.’ Solved within the optimizer, the solution would be to assign the ‘hot dog’ supply to bidder A and the ‘hamburger’ supply to bidder B, for a total revenue of $19.90. Without this guidance from the optimizer, the dispatcher would allocate the ‘hot dog’ supply to bidder B and then the ‘hamburger’ queries to bidder C, for a total revenue of $11.

The third instantiation of optimize-and-dispatch called rule-based optimize and dispatch extends the idea in ‘long-term and spot market’ to construct a contingent plan to be executed by the dispatcher. Again, the optimizer defines the rules of a policy that will completely define the allocation of queries to bids for all possible received queries and bids (until the optimizer is called again to refresh the rules.) Again, the dispatcher module is simple because it just follows the explicit allocation rules provided by the optimizer. The difference here is that the rules provided to the dispatcher can be contingent and thus are more complex to compute and more complex to express. The method is described with respect to ad auctions but is not limited to the allocation of queries to bids in the context of a search engine: it applies to the general setting of expressive bids and sequential auctions.

Since queries and bids for queries are uncertain, an optimal allocation at period T may be contingent on the realization or receipt of queries in period T−1, and thus an optimal policy conditions the allocation decision made by the dispatcher in period T on the history of allocations in previous periods. For example, 10% of queries in class C may have been assigned to bid B at period T−1. If the realized queries at T−1 was very low, the optimal assignment of new queries to bid B at period T may be 50%. If the realized queries in class C was very high at period T−1, then the optimal assignment at period T may be 0%. This will also be impacted by the state of other bids. Since the optimizer must compute this policy prior to realization or receipt of queries, the policy information will be conditional or contingent, and take the form: “if the state of all bids is X, then assign portion Y of the queries in class C to bid B.”

As a result, the parameterization of the dispatch module is potentially very large. For example, let X be the joint state of all active bids (active bids can include online or spot bids). The parameters of the dispatch module allow the definition of an allocation rule for each joint state x ε X, i.e., each possible state of bids (e.g., progress towards meeting volume targets, etc.) combined with the current realization or receipt of queries. Without further simplification, this is not computationally scalable to provide for a dispatcher that can run in fractions of a second, i.e., essentially in real-time.

For example, note that such a policy need not be expressed explicitly in this form; in particular, the same allocation rule may be assigned to many different states (e.g., those states satisfying a specific property). For example: if bid B has received between x and y queries in class C and has one period remaining before it becomes inactive, then assign all supply in class C to bid B.

For full contingency plans (policies), the optimizer's problem can be formalized as one of computing the optimal policy to a full Markov Decision Process (MDP). Although there are standard algorithmic techniques for this (including formulating as Mixed Integer Program (MIP) and using tree-search algorithms), solving an MDP can be computationally quite difficult.

Instead, a deterministic simplification can be used where distributional information is replaced by treating expectations over queries and bids for queries as if they are guaranteed to be realized. This also reduces the parameter space because policies are no-longer contingent. Instead, the optimizer can be run more frequently to allow for replanning when the realized queries and bids for queries is not a good match for the queries and bids for queries that would be expected.

The underlying decision problem of rule-based optimize and dispatch, ignoring issues of computational complexity and data access (obtaining model parameters), can best be formulated as a fully observable Markov Decision Process (MDP).

The state of the MDP and its dynamics are given by changes in the underlying supply of the query “real estate” and demand (bids) for this query by bidders. Supply is dictated by “real estate” in which ads can be placed. For instance in a query based model, supply is simply the number of queries of a given class. In a subscription site, supply is given by the number of logins of a specific class of user. Hereinafter, the model will be discussed in terms of queries, but it can apply to subscription as well.

Let q₁, . . . , qₖ be query classes of interest. Query classes will be defined by the properties of both queries and the users. A query class may be defined using reference to particular keywords, collections of keywords, phrases, etc.; and it may also refer to possible conditions on the properties of the user issuing the query (e.g., demographic information, navigation history, etc.)

At any point in time t, the actual of queries is given by a vector (s^{t}=s₁^{t}, . . . , sₖ^{t}) indicating the number of available advertising slots on a user's web browser of class i at time t. These can be further distinguished if necessary (e.g., if a query allows multiple ads, sᵢ^{t} might be a vector of available slots distinguished by rank, etc.

Let C_{q} be a random variable reflecting the query context. This can be discrete or continuous—for simplicity, assume C_{q} is discrete, taking on values c₁, . . . cₘ. The context reflects any information available that will help predict future queries. Context may be as simple as time of day, day of week, etc.; or it may be more complex (e.g., the occurrence of a specific newsworthy event, which could bias queries and traffic patterns). Query context is assumed to be fully observable.

Query dynamics will then be given by a distribution Pr(S^{t}|C^{t}), where C^{t} is the context variable at time t. To predict variations in future queries, a transition distribution over query context is provided: Pr(C^{t}+1|C^{t}). This provides a relatively simply factorization of the query dynamics. For instance, if C¹ reflects time of day, then the transition model will be deterministic and only the densities over S^{t} given C^{t} need be expressed.

Graphically, query dynamics can be captured using a graphical model (dynamic Bayesian network) as sketched below:

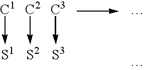

In this simplification, the queries in period t depend only on the current queries and is thus Markovian: it does not depend on previous queries.

Demand for queries is given by the bids expected. Unfortunately, with more expressive bidding, demand cannot be specified in the same Markovian fashion as supply. For instance, a bidder may want some minimum number of ad exposures over a specific time period, but may not care about the specific times within that period at which the ad exposures occur. This has the potential to render the process non-Markovian, but with suitable modeling this can be overcome. Specifically, the demand model can be broken into two components E^{t} and D^{t}. E^{t} refers to the state of existing bids at time t while D^{t} is a random variable denoting new bids that will arise at time t.

To simplify the model, assume that existing long-term bids are the only ones that will exist over the horizon of interest; that is, no prediction (stochastically) is made regarding the “structure” of new long-term bids. Instead new demand that may arise will be modeled in a Markovian fashion as if it were all spot demand. Note that this model can be used to anticipate the fact that new bids will be received in the future; it simply cannot capture any of the non-Markovian structure of a potential bid in the dynamics. Let context C^{t} influence distribution over instantaneous demand D^{t}. Breaking E^{t} out separately allows the state of existing bids (and their nonMarkovian structure) to be modeled at a more precise level of detail.

Overall, the following elements are required: Pr(D^{t}|C^{t}), and a stochastic model that specifies the updated state of existing bids E^{t} as a function of E^{t-1} (bids existing at the prior stage), S^{t} (the supply available at time t) and A^{t-1} (the actions taken at the previous stage—these influence how the state of existing bids evolve.)

Under certain conditions, the dynamics of E^{t} may in fact be deterministic. For instance, suppose that bids only refer to exposures to specific queries. If a particular number of queries are assigned to each bid during the current period, then the state of the bid will evolve deterministically. Or if a certain percentage of specific query types are assigned to each bid, then the “distribution” Pr(E^{t}|A^{t-1}, S^{t}, E^{t-1}) is deterministic as well.

The updated state of the contact cannot be predicted a priori when choosing action A^{t-1}, but given supply level S^{t}, the percentage is enough to determine the exact state of the bid. Uncertainty lies in S^{t} at time t−1, not in how E^{t} will evolve. However, if bids can require click-throughs, or offer bonuses for purchases, or rewards for “lingering,” then the outcome (w.r.t. the state of the bid) is not totally controllable. As a result, Pr(E^{t}|A^{t-1}, S^{t}, E^{t-1}), will generally be genuinely stochastic. (Alternatively, a stochastic variable could be added reflecting user behavior, that in turn influences the state of a bid. Such user behavior variables would reflect the probability of click-thru, etc. given an exposure of a particular type to a particular query.)

To model existing bids, a suitable language is needed to reflect how the “state” of a bid evolves. This can be straightforward, though the details will depend on the expressiveness that a bid allows. For example, if a bid requires 50000 exposures over the next 30 time periods among query classes q₁ and q₂, and pays a bonus for every 10 click-throughs on queries of class q₁, then the state of the bid at any stage would simply be the number of exposures within q₁∪q₂ and the number of q₁ click-throughs to this point. Note: if the bid paid for every click-thru, then the state would not have to include the number of click-throughs so far (reward/revenue would be obtained with each click-thru and that aspect of the reward would be Markovian). Of course, the same kind of language can be used if bids are specified in terms of the volume allocated and not in terms of additional properties, such as the number of click-throughs that result from the allocation.

Tractability of this model, especially the ability to solve it sequentially offline (i.e., by the optimizer) or quickly reoptimize online (i.e., by the dispatcher) in response to observed contingencies (see Solution Techniques below) requires the demand for queries and the supply of queries be aggregated at suitable level of time granularity. To this end, a discrete time model is used where periods are defined so as to permit a reasonable commitment to a course of action with that period. For instance, if time is discretized into one hour periods, then rule-based optimize and dispatch must be willing to “commit” to a particular course of action during any given hour (e.g., assign 20% of all queries of class q to bidder A over the next hour; possibly capped at some maximum number).

Given a time aggregation of this type, actions of the form “allocate the next query of class q to bidder A” are impossible. Instead, actions that are suitable for specific periods of time must be defined. Possibilities include assigning absolute numbers of queries from specific classes q to particular bids (or bidders) or to spot demand. Of course, given the stochastic nature of received queries, such actions may not be implementable. Such absolute actions could instead be arranged in terms of priorities (e.g., the first 1000 queries of class q go to bid A, the next 500 go to bid B, etc.). Another possibility is to assign a percentage of queries in specific classes over the period to specific bids (e.g., 20% of all queries in class q go to bid A). This latter form of action is adopted in the approaches that follow.

A bid specifies a set of queries that satisfy the conditions for its associated payment to be valid. For each such constraint associated with a bid, the MDP state should keep a sufficient statistic on the history of allocations of queries to the bid so that it can always be determined whether the constraint has been satisfied, together with additional information such as the probability with which the constraint can be satisfied in the future. Enough information should be stored to make the process Markovian. For instance, suppose we have a query that requests 100 queries of type “football and betting” between 9 am and 12 pm. Then, the state information associated with the bid at time t must count the number of queries that have been allocated to the bid between 9 am and time t. Just storing in the state whether a query was allocated in the previous period, t−1, is insufficient information while storing in the state the exact time at which previous queries were allocated is too much information.

Given this MDP formulation, there are several approaches that can be used to solve the problem of optimal allocation of queries to bids and the spot market, these range from “simpler” to more “complex,” where simpler approaches are more easily handled computationally, but do construct policies and will generally be of lower quality (i.e., further from optimal).

As in all of the models, it is assumed that queries have been broken down into the “relevant” query classes for the bid in mind.

The simplest model assumes away all stochasticity by assuming deterministic dynamics. Specifically, the three elements of the model that are inherently stochastic—queries, spot demand, and the effect of actions (e.g., exposures or click-throughs for given exposures) are assumed to be deterministic. This can be realized by using expected values for all three elements. More precisely, it is assumed that:
queries at time t will be exactly E(S^{t}) (where S^{t} is itself a vector variable S^{t}=(S₁^{t}, . . . , Sₖ^{t}));
demand at time t will be exactly E(D^{t});
the state of each bid (or set of bids by a specific bidder) may also evolve based on the expected reaction of users. click-throughs For instance, consider the case of bids defined in terms of observable properties such as click-through. Then, if percentage r of queries of class qᵢ are allocated to a bid c during period t, the probability of click-through on an ad for bid c given query type qᵢ is p, and the expected supply of queries of type qᵢ is sᵢ during the period, then the state of the bid will evolve deterministically based on prⁱsⁱ click-throughs of type qⁱ; and
context evolves deterministically (how so will depend on the specific context variables being modeled).

Under this assumption, the optimization can be easily formulated as a MIP and solved using state-of-the-art MIP solvers. For each (relevant) query class qᵢ, each time period t, and each bid cⱼ, a decision variable Rᵢⱼ^{t} can be defined which determines the fraction of the supply of query class qᵢ at period t that will be allocated to bid j. Next, constrain ΣⱼRᵢⱼ^{t}≦1 and assume that all excess queries are allocated to the spot market. Any assignment to decision variables K*T*N determines all relevant quantities for the state of any specific bid, where K is the number of query classes, T the number of periods over which the “latest” bid extends, and N is the number of bids.

Specifically, from variables {K, T, N} it can be determined the volume of queries allocated, number of click-throughs, and other observables properties such as the number of purchases, during any (possibly aggregate) time period for (possibly aggregate) query class relevant to any bid. This in turn allows formulation of the value of this allocation for any specific contract directly in the objective.

For example, suppose a long term bid cⱼ is in place which will pay as follows for queries of class q₁ and q₂:
1. nothing for queries of class q₁ if fewer than τ click-throughs;
2. $10,000 if at least τ click-throughs are achieved on queries of class q₁ by period t;
3. $8,000 if at least τ click-throughs are achieved on queries of class q₁ by period t′>t;
4. $0.50 per click-throughs on q₁ queries after τ click-throughs have been achieved;
5. $0.25 per exposure to queries of class q₂;

We would then encode as part of the objective in the MIP:
10000I₁+8000I₂+0.5T₁+0.25X₂
where I₁ is an indicator variable denoting that τ click-throughs are achieved (in expectation) by t, I₂ denotes that τ click-throughs are achieved by t′ (but not t), T₁ denotes how many click-throughs beyond τ have been achieved, and X₂ denotes the number of exposures to queries in class q₂.

Note also that the objective must also reflect the value expected from the use of unallocated queries to service the spot market. This means we must have not only predictions about the demand for queries on the spot market, but also the number of expected bids.

One difficulty with the pure deterministic approach is that it fails to account for variations in the stochastic nature of the queries and outcomes of allocations (e.g., number of click-throughs, which is a stochastic function of the ad “real estate” associated with a bid). A simple approach to dealing with this, without requiring explicitly modeling stochasticity in the allocation problem, is to reoptimize before the start of each time period after observing the realized allocations of queries to bids in the previous time period.

This needn't be done strictly between two consecutive time periods. If the optimizer's computation time required for optimization does not allow “real time” response, then the actual state of bids observed at time period t can be used to reoptimize the allocation based on the expected outcomes of the old allocation at time period t+1 (which will be implemented while reoptimizing) but allowing for new allocations to be decided upon for time period t+2 and beyond.

More precisely, let allocation parameters Rᵢⱼ^{t} be computed by the optimizer at time t′ for all time periods t≧t′. Only the specific allocations parameters Rᵢⱼ^{t′} for the current period t′ alone will actually be implemented in the dispatcher. Once these allocation parameters are taken by the dispatcher, the resulting state of each bid can be observed. A new MIP will be formulated to reflect the updated state of each bid and solved by the optimizer to produce a new set of allocation parameters decisions for periods t≧t′+1. The new MIP will have its objective and constraints changed to reflect the marginal value of newly allocated queries to specific bids given the current state of each bid.

For instance, suppose in the example above that bid cⱼ was assigned 35% of all class q₁ queries during period t, which resulted in 5000 click-throughs. Then the objective above would stay the same, but the variables I₁, I₂, T₂ would be redefined to reflect the fact that fewer click-throughs are now needed to reach the threshold τ. If the period t allocation had resulted in 11,000 click-throughs, then the terms involving I₁, I₂ would be removed from the objective (as they would if the relevant time horizon had passed).

An example of the rule-based optimize and dispatch method from the ad auction domain will now be described. In this example, rather than run the optimizer after each hour, the optimizer is run once at the start of the first hour whereupon a contingent plan that instantiates the behavior of the dispatcher for three hours is computed. In this example:
bids are for queries, perhaps on logical combinations of query terms;
only one winner is selected per query;
decision periods are equated with hours: every hour the dispatcher makes a new decision about what fraction of queries to assign to each bid (or to the spot market of short-term bids) for that hour;
the rules implemented by the dispatcher allocate a specific percentage of queries in each query class to a bid (e.g., an expressive bid), or allocate queries to short-term bids in the spot market;
the rules implemented in the dispatcher can be conditional, for example allowing the dispatcher to change the way supply is allocated in a manner that is contingent on the realization of supply;
the optimizer makes decisions over some horizon of k periods (i.e., hours), and thus provides new rules to the dispatcher every k hours. (in a special case, k=1 so that the rules are reconfigured every hour;
for simplicity, it is assumed that no expressive bids extend beyond the next three hours (so the optimizer need only optimize over three periods); and
no budget constraints

Assume that there are two expressive bids, both active from period one. Bid A is valid for three periods and bid B for two periods.
Bid A pays $300 if it is allocated 20 (or more) queries that include the terms “Football+Betting” over the next three hours;
Bid B pays $100 if it is allocated 30 queries that include the term “Football” over the next two hours, and will pay a bonus of $5 query including terms “Football+Tickets” over the next two hours whether or not that target is reached; and
Spot market contains an ample supply of bids for $1 per query in the market

In addition, for each of the first two periods, assume the following distribution over the mean number of queries in each of the following four classes, wherein: (F=football, B=betting, T=tickets; [symbol] w means w is not in the query):
Class 1 (C1)=F B T: 2
Class 2 (C2)=F B [symbol] T: 8
Class 3 (C3)=F [symbol] B T: 6
Class 4 (C4)=F [symbol] B [symbol] T: 10

For period three, the mean number of queries in each class is the same except for (FB [symbol] T), which has 15 expected queries (e.g., later in the evening so more “betting” queries expected.
Class 1 (C1)=F B T:2
Class 2 (C2)=F B [symbol] T: 15
Class 3 (C3)=F [symbol] B T: 6
Class 4 (C4)=F [symbol] B [symbol] T: 10

Note that the expected total number of football queries is 26 per period in the first two periods. Note also, that period 1, not enough queries are expected to fulfill either of the major conditions of the expressive bids, so a myopic dispatcher (one that did not consider the impact of future allocations on the value of a bid) would have no reason to assign any queries to either bid (since it would not expect to see any revenue, except in the case of the bonus in bid B, which can be treated as a nonexpressive bid). Thus, it is critical that some information be provided to the dispatcher that allows it to consider the expected value of assigning queries in a way that accounts for future assignment of queries to those bids.

Furthermore, note that there is considerable uncertainty in the queries to be received, so that a decision to assign a certain percentage of search terms to a specific bid in a given period does not necessarily realize an assumed target. This means that the allocation of queries at any period should be contingent on the actual, realized allocation of queries in previous periods. (Or if not contingent, the optimizer should be called frequently to allow for replanning when the future does not play out as expected.)

Next, rule-based optimize and dispatch will be described in connection with allocation occurring in period 1.

Suppose the optimizer makes the following fractional assignments for PERIOD 1 to bids A, B, and the spot market (S) for each of the four classes above:

| | A | B | S |
|---|---|---|---|
| C1 | 0% | 100% | 0% |
| C2 | 50% | 50% | 0% |
| C3 | 0% | 100% | 0% |
| C4 | 0% | 80% | 20% |

While the precise optimization will not be described, which can readily be formulated by one of ordinary skill in the art, the rationale for such an allocation, which tends to give priority to bid B is as follows:
1. Bid B has a shorter time horizon than bid A (two periods rather than three), so to meet the quota of 30 queries, there is a preference to assign queries earlier to bid B; and
2. Even though bid A has higher value for meeting its quota, the longer horizon, and the fact that expected number of queries will increase during the third period further lessens the incentive to assign queries in period 1 to bid A rather than bid B.

Next, realizations in Period 1 and the impact of said realizations on allocations in period 2 will be discussed.

Given the uncertainty in received queries, many possible outcomes are possible. Several scenarios and their implications are considered next:

SCENARIO I: Suppose the expected number of queries are realized in each query class at period 1 (note that the odds of this happening can be extremely low).

| | A | B | S |
|---|---|---|---|
| C1 | 0 | 2 | 0 |
| C2 | 4 | 4 | 0 |
| C3 | 0 | 6 | 0 |
| C4 | 0 | 8 | 2 |

In this scenario, bid B received (was allocated) 20 football queries in period 1 and requires only 10 in period 2 to meet its payment target of 30. (It also pays its “ticket” bonus for queries in classes C1 and C3 whether or not it meets this target.) Bid A has received 4 queries contributing towards its target of 20.

If this is the case, the dispatcher should assign a somewhat lower percentage of generic football queries to bid B in period 2, since in expectation, a much lower percentage will be needed to realize the target. (The same assignment would lead to 40 total expected exposures.) Relaxing the number of queries of class C4 assigned to bid B would allow further queries to be assigned to the spot market (but without impacting the bonus associated with classes C1 and C3). Relaxing the number of queries of class C2 assigned to bid B would allow further queries to be assigned to bid A (thus reducing the risk associated with not meeting bid A's target in period 3).

SCENARIO II: Suppose the number of queries in each query class at period 1 is much lower than expectation (50% lower):

| | A | B | S |
|---|---|---|---|
| C1 | 0 | 1 | 0 |
| C2 | 2 | 2 | 0 |
| C3 | 0 | 3 | 0 |
| C4 | 0 | 4 | 1 |

In this scenario, bid B received (was allocated) only 10 Football queries in period 1 and requires 20 in period 2 to meet its payment target of 30. Bid A has received only 2 queries contributing towards its target of 20.

How the dispatcher should alter its allocations depends on several factors, i.e., the variance in the distribution over queries. First, suppose that there is very little uncertainty in the period 3 numbers. This means that if a large fraction of “Football+Betting” queries (class C1 and C2) in period 3 are assigned to bid A, it is likely to achieve the expected value of 17 C1 and C2 queries for bid A in period 3.

If this is the case, the dispatcher should assign a much higher percentage of “football” queries to bid B in period 2, since there is considerable risk of not realizing bid B's target. Because there is little risk associated with putting off most of bid A's requirements until period 3, the dispatcher should be more aggressive in attempting to meet bid B's targets in period 2. Specifically, the percentage of class C4 should be increased to 100% (since it has no implications for bid A), and the percentage of class C2 may be increased, while respecting the need to possibly still make some contributions to bid A. For instance without any class C2 then bid A would expect to have 17+2 queries in total and be one query short. This suggest that something like 25% of class C2 may need to be allocated to bid A, with the rest to bid B.

SCENARIO III: As in Scenario II, suppose the number of queries in each query class at period 1 is much lower than expectation (50% lower):

| | A | B | S |
|---|---|---|---|
| C1 | 0 | 1 | 0 |
| C2 | 2 | 2 | 0 |
| C3 | 0 | 3 | 0 |
| C4 | 0 | 4 | 1 |

In this scenario, bid B received (was allocated) only 10 football exposures (queries) in period 1 and requires 20 in period 2 to meet its payment target of 30. A has received only 2 queries contributing towards its target of 20.

Again, how the dispatcher should alter its allocations depends on several factors, specifically the variance in the distribution over queries. This time, however, suppose that there is considerable uncertainty in the period 3 numbers.

This means that even if we assign a large fraction of “Football+Betting” queries (class C1 and C2) are allocated in period 3 to bid A, there is a good chance the expected value of 17 class C1 and C2 queries for bid A in period 3 might not be achieved. Thus, the only way to reach bid A's targets is to ensure it gets a reasonable fraction of class C1 and C2 queries in period 2.

If this is the case, the dispatcher should “abandon” bid B's targets, since the revenue associated with bid B is much smaller than that for bid A. As a consequence, the class C2 and C4 queries assigned to bid B should be reduced to zero (since they have no bonus) and it is most likely that these queries will be “wasted” if assigned to bid B. All (or most) of class C2 queries should then be assigned to bid A, and all class C4 queries to the spot market. Classes C1 and C3 (which accrue the “ticket” bonus) may still be assigned to bid B depending on the specific odds and expected bids on the spot market.

SCENARIO IV: Suppose the number of queries in each query class at period 1 is much higher than expected (50% higher):

| | A | B | S |
|---|---|---|---|
| C1 | 0 | 3 | 0 |
| C2 | 6 | 6 | 0 |
| C3 | 0 | 9 | 0 |
| C4 | 0 | 12 | 3 |

In this scenario, bid B received (was allocated) 30 football queries in period 1 and requires none in period 2 to meet its payment target of 30. Bid A has received 6 queries contributing towards its target of 20.

In this case, the dispatcher should alter its targets so that no queries are assigned to bid B except, possibly, those that attract the “ticket” bonus. Specifically, all queries in class C4 should be assigned to the spot market, and all queries in class C2 should be assigned to bid A (or possibly to the spot market).

This example illustrates the importance of adjusting the queries to bids in any period in a contingent fashion based on realized supply in previous periods. One way to address this is for the dispatcher to be provided with:
1. contingent/conditional rules: for example, the rules might be:
   “Assign supply to specific bids according to table T1 at period one.
   If scenario A is realized at period 1, then assign supply using table T2A.
   If scenario B is realized at period 1, then assign supply using table T2B. . . . ”
2. an algorithm that can adjust the assignment (possibly implicitly) based on the state of each bid and summary information provided by the optimizer.

Another way to address this is to allow the optimizer to be called frequently enough that replanning can be performed in response to shifts in received queries. For example, if the optimizer could be called every hour in the above example then the optimizer would be able to respond to the need to change the rules.

This example also illustrates the need for the optimizer to provide summary information or guidance that will influence the dispatch process based on anticipated future contingencies.

Next, value-based optimize and dispatch will be described.

The amount of information required to express a complete policy above makes the parameterization of a simple dispatcher complex. Furthermore, computing an optimal policy of this form (even offline, i.e., with the optimizer) can be difficult.

An alternative is to provide approximate value information. Roughly, the optimizer is charged with determining an estimate of the long-term value of a specific allocation of each query to a specific bid in a particular period, without considering the precise state of other bids. Each value is conditioned on the state of the bid and on other environment variables, and will anticipate future contingencies in some form. This information is provided as a value schedule.

Thus the parameters or decision variables provided to the dispatcher by the optimizer are for every possible allocation of queries to each bid conditioned on the state of that bid. The ideas in this section are described in the context of ad auctions but can be applied to the general problem of sequential expressiveness in online auctions with uncertain queries and bids.

The parameters in the dispatcher for each bid can be represented implicitly and approximately whereupon the overall number of parameters is reduced since there is no need to consider the joint space of all bid states. For this heuristic decomposition approach, the optimizer faces the problem of computing parameters for each bid. This is similar to the problem of solving a full MDP, but with a much reduced state space.

The dispatcher will use these parameters in determining an allocation rule for the current period by considering the current state of each bid. The optimization by the dispatcher can be approached in several different ways. However, the dispatcher need only reason ”myopically” since information regarding future contingencies is summarized in the parameters. There are several approaches to this problem. For instance, one can use a greedy model such a gradient ascent to assign supply to each bid based on the estimated values. The optimization can also be formulated as a MIP. Other methods can also be considered.

While reoptimization after observing various contingencies does allow one to track the optimal policy more closely, it still suffers from the difficulty that the original allocations are not being made in a way that accounts for stochasticity. One way around this is to solve the problem as a full blown Markov Decision Process (MDP), but this is unlikely to scale except for reasonably small problems. An alternative is to adopt a task decomposition approach, in which “stochastically optimal” decisions are computed for each bid in isolation, and heuristic techniques are used to piece these solutions together.

In such task decomposition, the “tasks” (i.e., the bids to be allocated queries) are completely decoupled except for resource constraints—namely, the fact that there is a finite amount of a specific resource (ad space) to be allocated. Specifically, the state of a bid depends only on the queries allocated to it, and the reward/revenue associated with a bid is independent of the state of other bids.

The basic idea is as follows:
For each bid i, compute a time-dependent value function Vᵢ (a “value schedule”) that denotes the expected value (revenue) of assigning a specific fraction of the total (estimate) of supply of queries to that bid over some time horizon. The allocation will actually take the form a resource vector dictating how much of each query class relevant to bid i has been assigned to bid i in each period. Since the number of queries is stochastic, the focus is on allocating fractions of received queries to bids rather than specific amounts. This value function Vᵢ will reflect the long-term expected value bid i will obtain, but where in this calculation it is assumed that the bid will be allocated queries optimally over the time horizon. These values, however, do not reflect the potential for query allocation to other bids: there may be conflict between the sequence of allocations assumed in computing Vᵢ for each bid.
With these local value functions Vᵢ in hand, the next task is to optimally allocate queries in a way that accounts for: distributions over queries (i.e., ad space/context) over time; the competing demands of existing bids; and expected new bids (new bids or spot bids). Several heuristic techniques are now considered for doing so.

Initially the form, intent, and computation of the local value functions Vᵢ for each bid i is described These functions will be time- and state dependent, and reflect the expected value of allocating a specific fraction of the total queries to bid i. More precisely, let Vᵢ^{t} (f,eᵢ) denote the expected value to bid i of being assigned fraction f of the total queries from time t onward in each (relevant) query classes to bid i. Here f=(f₁, . . . , fₖ) where fⱼ is the fraction of the queries in class qⱼ assigned to bid i. This vector can be aggregated; for example, while query classes q₁ and q₂ may need to be distinguished for the purposes of some bid, they may have exactly the same effect on bid i. Thus the allocation vector can treat these as identical and the value function need only depend on the fraction of the class q₁∪q₂ allocated to bid i. This can be computed by dynamic programming using the following recurrence:

$${V}_{i}^{t} ( f , {e}_{i} ) = {max}_{{f}^{t}} {\sum }_{{e}_{i}^{′}} {E}_{{S}^{t}} [ {R}^{t} ( {e}_{i} , {f}^{t} ) ] + Pr ( {e}_{i}^{′} \vert {e}_{i} , {f}^{t} ) {V}_{i}^{t + 1} ( {B}^{t} ( {f}^{t} , f ) , {e}_{i}^{′} ) \qquad ( 7 )$$

where:
f^{t} is the fraction of the current queries S^{t} that is given to bid i;
E_{S}_{^{t}}[R^{t}(eᵢ, f^{t})] is the expected immediate reward (revenue) obtained in state eᵢ when bid i is allocated f^{t} at time t;
Pr(eᵢ′|eᵢ, f^{t}) is the probability of bid i moving to state eᵢ′ given current allocation f^{t (this is taken with respect to expectation over actual queries S}^{t}, but also with respect to click-through probability, etc.);
B^{t}(f^{t}, f) is a “balance” function: given that f^{t} has been allocated to bid i at time t;
B^{t}(f^{t}, f) is the fraction of the remaining (expected) queries from t+1 that will have to be allocated to bid i to ensure that the total fraction of the queries from time t is f.

This latter function is continuous in argument f and the state eᵢ of bid i may be quite large (possibly combinatorial in structure) but is likely to have integer or real-valued components, (e.g., the amount of queries allocated so far on a class, or the number of click-throughs so far on class qⱼ). Thus a number of function approximation models can be used to help solve this. For instance, sampling the value function computation at a small number of points in each dimension fᵢ and using linear interpolation as needed in the dynamic programming step to do lookahead may prove very helpful. The appropriate approach depends critically on the form of the value function.

Also note that the combinatorics of bid states (and allocation vectors) can be broken down quite readily. If a bid offers independent payments for various conditions being met, then these independent conditions can each be viewed as a subbid that can be optimized independently. For instance, if bid i offers payments (however complicated) involving queries of classes q₁ and q₂, and quite separate payments for queries of classes q₃ and q₄, these can be viewed as two separate bids. Even if a total budget constraint is in place, this can be accounted for when these two solutions are “pieced” together.

With these local value functions in hand, queries can be allocated in the current time period in a fashion that optimizes the sum of these local value functions. This makes the optimistic assumption that the true MDP value function is given by the sum of the local functions computed without considering interaction. An advantage of this approach is that the allocation of queries can be made given the current state eᵢ of each bid i, without dealing with the combinatorial blowup associated with considering optimal allocations for all combinations of contract states.

The basic model for online allocation is as follows:
1. At time t, let state of the bids be e^{t}. The local values Vᵢ^{t}(f, eᵢ^{t}) are used to determine a feasible allocation F^{t}=(f₁^{t}, . . . , fₙ^{t}) of the current queries to each bid; and
2. At the end of period t, the new state e^{t+1} is observed and the process repeated at time t+1.

The goal is to find a feasible allocation of total queries that maximizes the sum of the local values:

$${max}_{{F}^{t}} {\sum }_{i} {V}_{i}^{t} ( {f}_{i}^{t} , {e}_{i}^{t} )$$

where F^{t} ranges over the collection of feasible allocations (so no more than fraction 1.0 of any query class is allocated in total).

Gradient ascent dispatch is one way of determining the current allocation given the current state e^{t}. Specifically, start with no allocation to any bid. Then, start allocating groups of queries to various bids based on local improvements. Whatever function approximation architecture is used, it will be assumed that the gradient is easy to access, specifically that

$$\frac{\partial {V}_{i}^{t} ( f , {e}_{i} )}{\partial {f}_{i}}$$

is known. Standard constrained gradient-based optimization techniques can then be used to allocate supply to the various resources.

Greedy dispatcher allocation is a simple variation on gradient ascent dispatched. Here, queries are allocated in discrete groups. For instance, the entire supply of query qⱼ may be allocated in 0.01 units. Given the current allocation (say 0.22 of the entire supply of query qⱼ has been assigned to bid 1, 0.07 to bid 2 and none to bid 3), the improvement in local value to each bid i can be evaluated given its current state eᵢ, and it current (partial) allocation fᵢ. Then the next “unit” of for the entire supply of query qⱼ is allocated to that bid i that has the largest increase in value Vᵢ^{t}(fᵢ′,eᵢ)−Vᵢ^{t}(fᵢ,eᵢ), where fᵢ′ is the current allocation to bid i increased by 0.01 in dimension j. This continues until 100% of the entire supply of queries has been allocated to the bids.

Both of these strategies run into difficulties when there are large plateaus (as may exist when complementarities are present, even in the form of simple thresholds for payments). One possibility is to sample the value function in suitable dimensions and have the optimizer attempt global optimization based on the sampled points (note: the evaluation at these sampled points may be trivial, since they may exist in the value function approximation representation already). For instance, given a collection of samples, a piecewise linear objective can be constructed and solved as a MIP, where the total supply of queries is assigned making suitable global tradeoffs.

There is one key assumption implicit in the formulation that will cause difficulties when “piecing” these solutions together (in contrast to Markov task decomposition). When Eq. 7 is solved for a specific bid i, no account is taken of the fact that the value function makes certain assumptions about how the total supply of queries f is distributed over time. Specifically, Eq. 7 allows bid i to choose an optimal “split” of its allocation f—into queries allocated “now,” i.e. f^{t} and queries allocated later B^{t}(f^{t}, f)—without regard to how others may choose to split up the queries. For example, if both bid i and bid j are given 50% of the total remaining supply of query class q^{k}, each may “decide” to use 60% of the current queries, and some amount less than 50% of the future queries starting at time t+1. This leads to an excess demand at the current time (and less demand later). Conversely, each may only require 40% of the current queries, leaving excess queries at the current point in time. Several solutions can be considered to this problem.
1. Greedy allocation (in case of unused queries) or deallocation (in case of excess demand) of the current queries. While there may be conflicts at future time points as well, these will be addressed in the dispatchers reallocation at those future time points. The only concern here is effective use of queries at time t. Once again, the local value functions can be used to measure the impact (using one-step lookahead) of allocating or deallocating one-time-period queries rather than “global” queries.
2. Constraining the scope of Eq. 7 so that the same fraction of queries is used at all future points in time. Specifically, do not permit the maximization to split the global supply of queries into “different rates.” Instead, compute the value (by dynamic programming) of allocating a fixed fraction of queries across all points in time:

$${V}_{i}^{t} ( f , {e}_{i} ) = {\sum }_{{e}_{i}^{′}} {E}_{{S}^{t}} [ {R}^{t} ( {e}_{i} , f ) ] + Pr ( {e}_{i}^{′} \vert {e}_{i} , f ) {V}_{i}^{t + 1} ( f , {e}_{i}^{′} ) \qquad ( 8 )$$

At any point in time, the supply of queries will be allocated to each bid based on the assumption that this fraction of the queries will remain fixed over time. Of course, once the current time period is over and we observe the resulting state vector, we will reallocate (so the allocation does not actually remain fixed over time).

Next, the value-based approach on the same example used to illustrate the rule-based dispatch method will be described.

Assume that there are two expressive bids, both active from period one. Bid A is valid for three periods and bid B for two periods. Bids in the spot market, i.e., the short-term non-expressive bids, are also considered.
Bid A pays $300 if it receives (is allocated) 20 (or more) queries including the terms “Football+Betting” over the next three hours;
Bid B pays $100 if it receives (is allocated) 30 queries including the term “Football” over the next two hours, and will pay a bonus of $5 per query including terms “Football+Tickets” over the next two hours whether or not that target is reached; and
Spot market containing an ample supply of bids for around $1 per query in the market. (There could be some variance in the actual spot market bid prices.)

In addition, for each of the first two periods, assume the distribution over the number of queries in each of the following four classes has the stated mean: (F=football, B=betting, T=tickets; [symbol] w means w is not in the query):

| | | | | |
|---|---|---|---|---|
| Class 1 (C1) = | F | B | T: | 2 |
| Class 2 (C2) = | F | B | [symbol] T: | 8 |
| Class 3 (C3) = | F | [symbol] B | T: | 6 |
| Class 4 (C4) = | F | [symbol] B | [symbol] T: | 10 |

For period three, the mean number of queries in each class is the same except for (FB [symbol] T), which has 15 expected queries (e.g., later in the evening so more “betting” queries expected), are assumed:

| | | | | |
|---|---|---|---|---|
| Class 1 (C1) = | F | B | T: | 2 |
| Class 2 (C2) = | F | B | [symbol] T: | 15 |
| Class 3 (C3) = | F | [symbol] B | T: | 6 |
| Class 4 (C4) = | F | [symbol] B | [symbol] T: | 10 |

Note that the expected total number of football queries is 26 per period in the first two periods.

The first step is to construct value functions Vᵢ(f) for each bid. It is convenient to decompose bid B into two bids (B and C), where bid C represents the incremental payment that bid B is willing to make per ticket query allocated, over-and-above the 30 queries that satisfy the supply requirements for the $100 one-time-payment.

Suppose that the following value functions are constructed:
V_{A}(f)=270 for 6 f₁^{A}+31 f₂^{A}≧24; 1.
V_{B}(f)=90+30 f₁^{B}+90 f₃^{B}, for 6 f₁^{B}+31 f₂^{B}+18 f₃^{B}+30 f₄^{B}≧36, with constraints f₁^{B}≦2/3, f₂^{B}≦16/31, f₃^{B}≦2/3, f₄^{B}≦2/3 2.
V_{C}(f)=30 f₁^{C}+90 f₃^{C}, with contraints f₁^{C}≦2/3, f₃^{C}≦⅔. 3.
Vₛ(f)=6 f₁^{S}+31 f₂^{S}+18 f₃^{S}+30 f₄^{S} 4.

Here, f₁^{A} describes the total fraction of allocation in class C1 to bid A over the next three periods, and similarly for the other fraction variables. The details of how these functions are constructed depend on the variance of future supply and other factors. Here's some intuition for these value functions:
1. Bid A needs 20 queries altogether but because of variance places a constraint that will provide 24 queries in expectation and associates this with a value of 270 (10% less than $300), to represent the remaining chance of failure;
2. Bid B needs 30 queries altogether and asks for 20% in addition to provide a safety margin, and discounts the one-time payment by 10% to state an expected value of $90 if a fraction of queries satisfying the demand constraint is provided. Moreover, bid B includes the additional terms for supply of class C1 and C3 together with constraints on the fractions for which the value function is valid. Namely, bid B notes that an allocation beyond ⅔ of the total fraction on classes C1, C3 and C4 is not useful. This is because bid B intends to take all of the supply early, i.e., if ⅔ is allocated then bid B intends to consume all of this supply in the initial two periods. As such, more than ⅔ of class C1 is not useful. Similarly for class C2, except this is a constraint of 16/31 because 15 units of the supply on class C2 occur in period 3—after the end of the period of interest for bid B. The value function adjustment 30 f₁^{B}+90 f₃^{B} can be interpreted in these terms: given f₁^{B}=⅔ then bid B receives 4 units of C1 in periods 1 and 2, with value $20 (equal to 30·⅔.) For supply in class C3, f₃^{B}=⅔ provides supply of 12 units in periods 1 and 2 and thus a value of 60=90·⅔;
3. Bid C's value function represents the per-unit value of each fraction of total queries allocated from classes C1 and C3, assuming that the bid is able to consume the queries during periods 1 and 2; and
4. Bid S's value represents the value of the spot market, and is simply $1 for the expected number of queries based on the fractional assignment.

The second step is to run the optimizer and allocate fractions across these bids to maximize the total expected value. The problem to solve is:

$${max}_{f} 270 {x}_{A} + 90 {x}_{B} + 30 ( {f}_{l}^{B} + {f}_{l}^{C} ) + 90 ( {f}_{3}^{B} + {f}_{3}^{C} ) + 6 {f}_{1}^{S} + 31 {f}_{2}^{S} + 18 {f}_{3}^{S} + 30 {f}_{4}^{S} \qquad ( 9 )$$

such that
6 i f₁^{A}+31 f₂^{A}≧24 x_{A} (10)
6 f₁^{B}+31 f₂^{B}+18 f₃^{B}+30 f₄^{B}≧36 x_{B} (11)
f₁^{B}, f₃^{B}, f₄^{B}, f₁^{C}, f₃^{C}≦⅔ (12)
f₂^{B}≦16/31 (13)
f₁^{A}+f₁^{B}+f₁^{C}f₁^{S}≦1 (14)
f₂^{A}+f₂^{B}+f₂^{S}≦1 (15)
f₂^{B}+f₃^{C}+f₃^{S}≦1 (16)
f₄^{B}+f₄^{S}≦1 (17)
f₁^{A}, f₂^{A}, f₁^{B}, f₂^{B}, f₃^{B}, f₄^{B}, f₁^{C}, f₃^{C}, f₁^{S}f₂^{S}, f₃^{S}, f₄^{S}≧0 (18)
x_{A}, x_{B}ε{0,1} (19)

Constraints (10) and (11) ensure that the one-time payments associated with bids A and B are only realized within the optimizer when the conditions expressed in the value functions are met. Constraints (12) and (13) reflect the constraints placed on the fractional allocation by bids B and C. Constraints (14-17) are query constraints and provide for feasibility of the fractional allocation. Constraints (18) and (19) require that fractions are non-negative and define bids A and B as zero-one variables.

The optimal solution to this MIP is:
Bid A: f₁^{A}=0, f₂^{A}=24/31, x_{A}=1
Bid B: f₁^{B}=⅔, f₂^{B}=0, f₃^{B}=⅔, f₄^{B}=⅔, x_{B}=1
Bid C: f₁^{C}=⅓, f₃^{C}=⅓
Bid S: f₂^{S}= 7/31, f₄^{S}=⅓

Bid A receives most of the allocation of class C2, bid B receives most of the allocation in class C1, C3 and C4, and bids C and S take the rest.

Realize that the independence assumption made in the heuristic value functions can already be seen to introduce an approximation here: both bids B and C are allocated supply of classes C1 and C3, but both intend to take their supply in the first two periods which will not in practice be possible. (Recall the decomposition will only be optimal when the local schedules assumed by each bid happen to fit together such that the solution required by each bid is simultaneously implementable.)

The third step is dispatch. For this, the goal solution as determined in the optimizer can be used to derive linearized value functions for each bid.

The one-time payment in bids A and B is now represented as a linear function for each dispatcher allocation of a fraction. The following linearized value functions are constructed and (i) input to the dispatcher:
1. Bid A: V′_{A}(f)=349 f₂^{A}, and constraint f₂^{A}≦24/31. Here, multiplier 349 is adopted because 349≈270/(24/31) so that the function adopts the value of the one-time payment when supply (queries) f₂^{A}=24/31 is (are) provided upon dispatch. The constraint ensures that the bid does not receive too much allocation during dispatch; and
2. Bid B: V′_{B}(f)=45 f₁^{B}+135 f₃^{B}+75 f₄^{B} and constraints f₁^{B}≦⅔, f₃^{B}≦⅔ and f₄^{B}≦⅔. Bid B can also be associated with an expiration time to indicate that it is not valid in period 3.
   Here, multiplier 45=((4/36)(90)+20)/(⅔) to indicate that the $90 one-time bonus is distributed in proportion (4/36) to the number of required units (36 after the safety margin of 20%) that is provided by class C1, this is then summed with the 4 payments of $5 a piece for C1, and then divided by (⅔) so that when fraction f₁^{B}=⅔ is allocated the total value will equal (4/36)90+20. Similar expressions explain 135=((12/36)90+60)/(⅔) and 75=((20/36)90)/(⅔).
3. Bid C: V′_{C}(f)=30 f₁^{C}+90 f₃^{C} with constraints f₁^{C}<⅔ and f₃^{C}≦⅔. Bid C can also be associated with an expiration time to indicate that it is not valid in period 3. The multipliers 30=(20/(⅔)) and 90=(60/(⅔)), so that the correct total value is associated with a fractional assignment of ⅔ from class C1 and C3 respectively; and
4. Spot market: V′_{S}(f)=6 f₁^{S}+31 f₂^{S}+18 f₃^{S}+30 f₄^{S} (this is unchanged from the initial value function associated with the spot market.)

These value functions can be represented in the following tabular form to provide an overview of the online dispatch decision now facing the dispatcher.

| | A | B | C | S |
|---|---|---|---|---|
| C1 | 0 | 45 | 30 | 6 |
| C2 | 349 | 0 | 0 | 31 |
| C3 | 0 | 135 | 90 | 18 |
| C4 | 0 | 75 | 0 | 30 |

Given the forgoing input, the dispatcher will then make the following sequence of decisions in allocating online queries to maximize the value functions:
1. In periods 1 and 2, Allocate 100% of the queries in class C1 to bid B until ⅔ has been assigned and then allocate to bid C and then to bid S. (Bid S gets all supply of C1 in period 3.)
2. Allocate 100% of the queries in class C2 to bid A until 24/31 has been assigned in total, at which point allocate the remaining supply to the bid S.
3. In periods 1 and 2, allocate 100% of the queries in class C3 to bid B until ⅔ has been assigned and then to bid C and then to bid S. The spot market (bid S) gets all supply of the queries in class C3 in period 3.
4. In periods 1 and 2, allocate 100% of the queries in class C4 to bid B until ⅔ has been assigned and then assign the remaining supply to bid S. The spot market bid S gets all supply of the queries in class C4 in period 3.

Conceptually, think about the value functions associated with each bid competing for queries as they are received. The value-based instantiation of optimize-and-dispatch makes good decisions about how to allocate supply: bid B gets priority in early rounds, with bid A getting enough supply to meet its targets, and with the spot market being allocated excess supply. By the end of period 3, if the supply was realized as expected, then the following fractional allocations would have been achieved:

| | A | B | C | S |
|---|---|---|---|---|
| C1 | 0 | 2/3 | 0 | 1/3 |
| C2 | 24/31 | 0 | 0 | 7/31 |
| C3 | 0 | 2/3 | 0 | 1/3 |
| C4 | 0 | 2/3 | 0 | 1/3 |

The value-based instantiation of optimize-and-dispatch can be further illustrated through the following variations.

Variation I: Suppose that the bid price in the spot market was $1.50 for queries in class C4 instead of $1. Then the solution to the dispatcher changes to provide the following fractional assignments (listing only the non-zero entries): f₂^{A}=24/31, f₁^{B}=⅔, f₃^{B}=⅔, f₂^{B}=7/31, f₄^{B}=13/30, f₄^{B}32 17/30, f₁^{C}=⅓, f₃^{C}=⅓. The change is that bid B is now shifted to receive some queries from class C2 instead of class C4 to free capacity in class C4 for bid S. The resulting linearized value functions can be represented in the following tabular form:

| | A | B | C | S |
|---|---|---|---|---|
| C1 | 0 | 45 | 30 | 6 |
| C2 | 349 | 78 | 0 | 31 |
| C3 | 0 | 135 | 90 | 18 |
| C4 | 0 | 75 | 0 | 45 |

Realize that the total values of the entries for bid B have increased because bid B is now allocated a smaller fraction (7/31 and 31/30) from each query class and therefore the value, when normalized for an allocation of 100%, is expressed as a larger multiplier.

A problem can arise from a mismatch between the decisions made locally by each bidder in this scenario. What should happen in dispatch is that the allocation goes to bid B for class C2 before it goes to bid A because bid B will depart the system after period 2.

Instead, the dispatcher will initially allocate queries as in the previous example: with queries in class C2 going to bid A. Moreover, when the queries of class C4 to bid B hits 13/30 then queries of class C4 will be switched to bid S. The ultimate effect is that bid B will have insufficient queries by the end of period 2 to meet its target: with 4 queries of class C1, 16 queries of class C3 and 13 queries of class C4, leaving it one query shy of the target of 30 required for the bonus of $100 that predicated the values in the linearized function.

Variation II: The above problem is due to inconsistencies between the local plans formed by each bid in solving for the value function of the bid. The problem can be addressed by placing a constraint on the local bids that requires that the value assigned be defined in terms of a uniform supply throughout the complete period of time horizon. In the case just discussed, this would result in the following changes:
Value functions
   V_{A}(f)=270 for 6 f₁^{A}+31 f₂^{A}≧24 1.
   V_{B}(f)=90+2 f₁^{B}+60 f₃^{B}, for 4 f₁^{B}+16 f₂^{B}+12 f₃^{B}+20 f₄^{B}≧36 2.
   V_{C}(f)=20 f₁^{C}+60 f₃^{C} 3.
   V_{S}(f)=6 f₁^{S}+21 f₂^{S}+18 f₃^{S}+45 f₄^{S} _b 4.
   The changes are in the value functions of bids B and C. The demand constraint is now stated assuming a uniform fraction f^{B} and f^{C} of queries, which leads to lower expectations on the total supply of queries received for the same fractions. (Previously the bid had expected to take the ⅔ of total supply of queries in the first two periods, i.e., receiving 100% of the actual supply of queries in the first two periods and no supply of queries in the third period.)
Optimizer solution. The optimal fractions given these constraints are (omitting the zero fractions): f₂^{A}=24/31, f₁^{B}=1, f₂^{B}=7/31, f₃^{B}=1, f₄^{B}=0.82, and f₄^{S}=0.18. As linearized value functions, this provides
   V′_{A}(f)=349 f₂^{A}, with f₂^{A}≦24/31 1.
   V′_{B}(f)=30 f₁^{B}+40 f₂^{B}+90 f₃^{B}+50 f₄^{B} with f₂^{B}≦7/31 and f₄^{B}≦0.82 2.
   V′_{C}(f)=0 3.
   V′_{S}(f)=60 f₄^{S} 4.
Dispatcher. The dispatcher is now constrained to allocate queries at any point in time based on the assumption that this fraction will remain fixed over time. Accounting for the linear functions, and also for the constraints, the dispatcher determines (by solving a linear program-which is very fast) that it should assign exactly the fractions of queries determined in the optimizer. These then provide for a solution to the problem because the value functions were constructed assuming such a constant fractional assignment.

Variation III: For a final, simple variation where smoothness is enforced so that the individual value functions can be pieced together, assume that there are two bids and one class of queries being supplied.
1. Bid A has a value of $100 for 50 queries of class C1 in the morning; and
2. Bid B has a value of $150 for 50 queries of class C1 in the morning or the afternoon.

Suppose that the estimated supply is 60 queries of class C1 in the morning and another 60 queries of class C1 in the afternoon. The value functions of each bid would look as follows:
1. Bid A: V_{A}(f)=100 for f^{A}≧ 50/120; and
2. Bid B: V_{B}(f)=150 for f^{B}≧ 50/120.

The optimizer would solve this, assigning f^{A}= 50/120 and f^{B}= 50/120, which satisfies f^{A}+f^{B}≦1.

Now consider dispatch and the linearized value functions:
1. Bid A: V′_{A}(f)=100/( 50/120) and constraint f^{A}≦ 50/120; and
2. Bid B: V′_{B}(f)=150/( 50/120) and constraint f^{B}≦ 50/120.

The dispatcher will now give the first 50 units in the morning to bid B and then the remaining supply to bid A. This achieves total value of $150, but not the value of $250 that would be possible if the supply in the morning goes to bid A and not bid B.

Consider what happens if uniform-supply constraints are incorporated in the value function of each bid. The new value functions in the optimizer are:
1. Bid A: V_{A}(f)=100 for f^{A}≧ 50/60; and
2. Bid B: V_{B}(f)=150 for f^{B}≧ 50/120.

Bid A requires a constant allocation of 50/60 to ensure that it receives 50 units during the morning period. (Previously, a fraction 50/120 was predicated on the 50 queries being provided initially.) The optimizer will now solve and assign f^{B}= 50/120 and f^{A}=0. The linearized value functions passed to the dispatcher become:
1. Bid A: V′_{A}(f)=0;
2. Bid B: V′_{B}(f)=150/( 50/120) and f^{B}≦ 50/120.

Now, the dispatcher can implement this plan correctly and assigns the first 50 units of supply to bid B. Again, we see that introducing the requirement of a uniform allocation into the definition of value functions and thus into the decision making in the optimizer ensures consistency between the optimizer and the dispatcher.

As can be seen, the present invention provides a new per-query bid language that is more expressive, and new forms of expressiveness in ad auctions that enables expressiveness at the level of an advertising campaign, versus at the level of individual searches. The present invention provides a new architecture for optimizing decisions about which queries to allocated to which bidder in a dynamic environment, wherein long-term optimization problems are solved periodically within the optimizer to facilitate short-term decision making within the dispatcher.

The present invention has been described with reference to the preferred embodiments. Obvious modifications and alterations will occur to others upon reading and understanding the preceding detailed description For example, while the present invention has been described in connection with ad auctions to be displayed on displays of a computer network, one skilled in the art would appreciate that the invention can be applied to other application domains including by way of example and not limitation:
(a) (flexible-manufacturing) auctions for the allocation of flexible manufacturing capacity to competing firms;
(b) (on-demand computing) auctions for the allocation of computational and network resources to bidders, e.g., the dynamic allocation of a server farm in support of the e-commerce business of various bidders;
(c) (virtual organizations) auctions for the allocation of temporary staff to various clients of a staffing agency; and
(d) (call dispatch) reverse auctions for the allocation of calls received by a call center to fulfill contracts provided by bidders, e.g. firms may bid for the right to perform some volume of some particular kind of call over some period of time.

In addition to the allocation of ad auctions in response to queries entered into a search engine, ad auctions can also be performed for the right to display an advert given general kinds of context information about a user, for instance the physical location of a user, information about a store that a user has just visited, or a product just purchased, etc. Similarly, ad auctions can be performed for the right to display adverts given information about the content that a user is currently reading or viewing (e-mail, online content, internet TV, satellite TV, etc.), or listening-to (pod cast, satellite radio, itunes). Furthermore, realize that in addition to conditioning payments and constraints in bids on the click-through by a user on a displayed advert, that such conditioning and constraints can be defined in terms of any events caused by the display of an advert, including the eventual purchase of an item, completion of a transaction, eye movement to an advert, etc.

The present invention can also be extended to allow for the incorporation of seller preferences, i.e. preferences and constraints provided by a seller to additional control the allocation of the right to display adverts in response to queries received from users on a computer network. As discussed above, a seller in the application of ad auctions is a party such as Google or Yahoo, or a third party serving content that is used to provide context information to guide the provision of adverts in the web browsers of its customers. For instance, a seller might wish to prevent bidders from displaying adverts in response to particular kinds of queries, perhaps those for socially or politically-sensitive search terms, or might want to state a preference for some forms of content over others (e.g. plain text ads are preferred over graphical banner-ads). The seller might also wish to state business preferences: e.g., to state that a preference to allocate supply (queries) to bids from bidders with whom the seller has a long term business relationship.

It is intended that the invention be construed as including all such modifications and alterations insofar as they come within the scope of the appended claims or the equivalents thereof.

The invention claimed is:

1. A method of conducting an ad auction comprising:
(a) receiving a plurality of bids via a computer network, wherein:
each bid is for the right to display at least one advert associated with the bid on at least one display of the computer network in response to the bid being allocated at least one query;
each bid includes at least one word, term, phrase or string of characters that is used as a basis for allocating at least one query to the bid; and
each bid further includes at least one constraint on a sequential allocation of queries to the bid;
(b) determining at time t at least one rule or decision variable for allocating queries to bids, wherein the at least one rule or decision variable is determined based on the bids received before time t and at least one of the following: an estimate of queries to be received after time t; an estimate of events to occur in response to the display of adverts after time t; and/or an estimate of bids to be received after time t;
(c) receiving a query via the computer network after time t; and
(d) allocating the query received in step (c) to at least one of the bids based on the at least one rule or decision variable and the at least one word, term, phrase or string of characters.

2. The method of claim 1, further including:
(e) in response to allocating the query in step (d) and in response to the satisfaction of the at least one constraint, causing an advert associated with the bid allocated the query to be displayed on the display.

3. The method of claim 2, wherein:
step (d) includes allocating the query to a plurality of bids; and
step (e) includes displaying an advert associated with each bid allocated the query on the display.

4. The method of claim 3, wherein at least one advert is displayed at a position on the display based on a position constraint associated with the bid that is associated with the advert.

5. The method of claim 1, wherein:
the query includes at least one of the following properties: at least one word, term, phrase or string of characters; time of day; date; and demographic data regarding a submitter of the query; and
the allocation in step (d) is further based on at least one of the properties of the query.

6. The method of claim 2, wherein:
step (c) further includes sequentially receiving at least one query via each of a plurality of different displays of the computer network during a time period p;
step (d) further includes allocating each sequentially received query to at least one of the bids during the time period p;
step (e) further includes causing an advert associated with each bid allocated at least one sequentially received query to be displayed on the display of the computer from which the query was received; and
the method further includes:
(f) repeating step (b) at least once during the time period p to determine at least one new rule or decision variable that is utilized for allocating a query received after said at least one new rule or decision variable has been determined.

7. The method of claim 6, wherein in step (d) each sequentially received query is allocated substantially in real-time.

8. The method of claim 1, wherein each bid has associated therewith:
at least one word, term, phrase or string of characters that is used as a basis for allocating a query to the bid; and
at least one of the following:
at least one constraint on the bid; and
a value for at least one of the following:
for causing at least one advert associated with the bid to be displayed; or
for receiving a click-through on at least one advert associated with the bid that was caused to be displayed in response to the allocation of a query to the bid.

9. The method of claim 8, wherein the at least one constraint includes at least one of the following:
an aggregate volume constraint on the total volume of queries that can be allocated to the bid;
a temporal constraint on the bid or on one or more constraints associated with the bid;
a demographic constraint on the demographic(s) of a user of the computer that must be valid for a query received from the computer to be allocated to the bid;
a budget constraint on the payment of a total value associated with the bid;
a frequency constraint on the frequency that queries are allocated to the bid;
a joint allocation constraint on the allocation of one or more queries to the bid based on the allocation of said one or more queries to at least one other bid;
a user volume constraint that has at least one prerequisite that must be satisfied as a condition to payment of the value;
a query volume constraint that has at least one prerequisite that must be satisfied as a condition to payment of the value; and
a value-adjustment constraint that has at least one prerequisite that must be satisfied as a condition to adjusting the value.

10. The method of claim 9, wherein:
a payment associated with a bid is determined based on the value associated with the bid, and a least one of the following: (a) a number of queries allocated to the bid; (b) a value associated with at least one other bid; (c) at least one constraint associated with the bid; and
the payment associated with the bid includes at least one of the following: a fixed payment, a payment that changes incrementally with each allocation, and a payment that changes in response to satisfaction of the at least one constraint.

11. The method of claim 9, further including at least one seller determining at least one of the following on the sequential allocation of queries to at least one bid:
at least one constraint on at least one attribute of at least one bidder;
at least one constraint on at least one property of a query;
at least one temporal constraint;
at least one volume constraint;
at least one frequency constraint; and
a value for satisfying at least one constraint on the sequence of allocations of queries, wherein each seller is an entity that receives payment in response to allocating queries to bids.

12. The method of claim 9, wherein the user volume constraint includes the prerequisite that a user of the computer submit a predetermined number of queries, each of which includes at least one word, term, phrase and/or string of characters of a predetermined set of word(s), term(s), phrase(s) and/or string(s) of characters, as a condition of payment of the value.

13. The method of claim 9, wherein the query volume constraint includes the prerequisite that the bid be allocated a number of queries that is greater than, less than and/or equal to a predetermined number of queries or a predetermined percentage of queries received from computers of the computer network as a condition of payment of the value.

14. The method of claim 13, wherein the predetermined percentage of queries are queries in a particular class.

15. The method of claim 13, wherein the query volume constraint is used in combination with the temporal constraint that prerequisites that the bid be allocated queries during a predetermined period of time.

16. The method of claim 8, wherein the at least one word, term, phrase or string of characters includes at least one of the following:
a first set of word(s), term(s), phrase(s) and/or string(s) of characters that a query must contain for it to be allocated to the bid;
a second set of word(s), term(s), phrase(s) and/or string(s) of characters that the query may contain for it to be allocated to the bid; and
a third set of word(s), term(s), phrase(s) and/or string(s) of characters that disqualify the query from being allocated to the bid.

17. The method of claim 16, wherein the string(s) of characters of at least one of the first, second and third sets includes a URL.

18. The method of claim 16, wherein the one or more constraints include a bonus value constraint that prerequisites the payment of a bonus value included in the bid on at least one query allocated to the bid having at least one word, term, phrase and/or string of characters that is also in the second set of word(s), term(s), phrase(s) and/or string(s) of characters.

19. The method of claim 1, wherein:
the at least one rule or decision variable includes at least one of the following parameters:
a budget target for a total payment associated with at least one bid;
a query volume target associated with a predetermined number of queries to be allocated to at least one bid;
a virtual price associated with at least one bid; and
at least one weight associated with at least one bid to adjust a priority assigned to the bid for making an allocation of a query to the bid; and
the allocation is step (d) is made based on an auction for the query that is based on at least one of the parameters.

20. The method of claim 1, wherein:
the at least one rule or decision variable includes at least one rule for allocating a first percentage of the queries to at least one bid of a first set of bids and a second percentage of the queries to at least one bid of a second set of bids;
each bid of the first set of bids requires plural allocations of queries to satisfy its constraint(s);
each bid of the second set of bids requires a single query allocation to satisfy its constraint(s);
step (d) includes allocating the query to either a bid of the first set of bids or a bid of the second set of bids based on the at least one rule for allocating; and
when the query is allocated to a bid of the second set of bids, said allocation is made based on an auction among bids of the second set of bids.

21. The method of claim 1, wherein:
the at least one rule or decision variable includes a plurality of rules for allocating a first percentage of the queries to at least one bid of a first set of bids and a second percentage of the queries to at least one bid of a second set of bids;
each bid of the first set of bids requires plural allocations of queries to satisfy its constraint(s);
each bid of the second set of bids requires a single query allocation to satisfy its constraint(s);
step (d) includes allocating the query to either a bid of the first set of bids or a bid of the second set of bids based on at least one of the plurality of rules, the selection of which is contingent on events caused by allocation(s) occurring after time t and before allocation of the query; and
when the query is allocated to a bid of the second set of bids, said allocation is made based on an auction among bids of the second set of bids.

22. The method of claim 1, wherein:
the at least one rule or decision variable includes at least one of the following:
a value schedule to be associated with a bid that conditions the total value of the bid on the fractional allocation of the total supply of queries, over some period of time;
a value schedule to be associated with a bid that conditions the total value of the bid on the uniform fractional allocation of the total supply of queries, over some period of time; and/or
a value schedule that is contingent on events caused by allocation; and
the allocation is step (d) is made based on at least one of the value schedules.

23. A method of conducting an ad auction comprising:
(a) receiving via a computer network a bid for the right to display at least one advert associated with the bid on a display of a computer of the computer network in response to the bid being allocated a query received from the computer, wherein said bid includes a value and a constraint that prerequisites payment of the value based on satisfaction of a condition associated with the constraint;
(b) receiving queries from computers of the computer network;
(c) allocating a subset of the received queries to the bid; and
(d) making or withholding payment of the value based on the condition being satisfied or dissatisfied, respectively.

24. The method of claim 23, wherein the condition requires the bid be allocated some number of queries that is greater than, less than and/or equal to a predetermined number of queries or a predetermined percentage of a total number of queries received from computers of the computer network.

25. The method of claim 23, wherein the bid further includes at least one of:
a constraint that queries be allocated to the bid only during a predetermined period of time; and
a constraint that only queries in a predetermined query class be allocated to the bid.

26. The method of claim 23, wherein step (c) includes allocating the subset of queries to the bid based on at least one rule or decision variable, wherein the at least one rule or decision variable is determined based on:
bids received before the queries in step (b); and
at least one of the following:
an estimate of queries to be received after the at least one rule or decision variable is determined;
an estimate of click-throughs on adverts to be displayed after the at least one rule or decision variable is determined; and/or
an estimate of the bids to be received after the at least one rule or decision variable is determined.

27. A system of conducting an ad auction comprising:
means for electronically receiving a plurality of bids via a computer network, wherein each bid is for the right to display at least one advert associated with the bid on at least one display of the computer network in response to the bid being allocated at least one query; each bid includes at least one word, term, phrase or string of characters that is used as a basis for allocating at least one query to the bid; and each bid further includes at least one constraint on a sequential allocation of queries to the bid;
means for electronically determining at a time t at least one rule or decision variable for allocating queries to bids, wherein the at least one rule or decision variable is determined based on the bids received before time t and at least one of the following: an estimate of queries to be received after time t; an estimate of events to occur in response to the display of adverts after time t; and/or an estimate of bids to be received after time t;
means for electronically receiving one or more queries via the computer network after time t; and
means for electronically allocating each query received after time t to at least one of the bids based on the at least one rule or decision variable and the at least one word, term, phrase or string of characters.

28. The system of claim 27, further including means responsive to the allocation of at least one query to at least one bid and to the satisfaction of the at least one constraint associated with the bid for electronically causing an advert associated with the bid to be displayed on the display.

29. The system of claim 28, wherein the means for electronically allocating allocates at least one query to a plurality of bids.

30. The system of claim 29, wherein the means for electronically causing an advert to be displayed causes at least one advert to be displayed at a position on the display based on a position constraint included in the bid associated with the advert.

31. The system of claim 27, wherein:
each query includes at least one of the following properties: at least one word, term, phrase or string of characters; time of day; date; and demographic information regarding a user of the computer; and
the means for electronically allocating allocates each query based on at least one of the properties of the query.

32. The system of claim 28, wherein:
the means for electronically receiving queries sequentially receives at least one query via each of a plurality of different displays of the computer network during a time period p;
the means for electronically allocating allocates each sequentially received query to at least one of the bids during the time period p; and
the means for electronically determining determines at least one new rule or new decision variable during the time period p that the means for electronically allocating utilizes for allocating at least one query received after said at least one new rule or new decision variable has been determined.

33. The system of claim 32, wherein the means for electronically allocating allocates each sequentially received query substantially in real-time.

34. The system of claim 27, wherein each bid has the following associated therewith that the means for electronically allocating utilizes for allocating each query:
at least one word, term, phrase or string of characters that is used as a basis for allocating a query to the bid; and
at least one of the following:
at least one constraint on the bid; and
a value for at least one of the following:
for causing at least one advert associated with the bid to be displayed; or
for receiving a click-through on at least one advert associated with the bid that was caused to be displayed in response to the allocation of a query to the bid.

35. The system of claim 34, wherein the one or more constraints include at least one of the following:
an aggregate volume constraint on the total volume of queries that can be allocated to the bid;
a temporal constraint on the bid or on one or more constraints associated with the bid;
a demographic constraint on the demographic(s) of a user of the computer that must be valid for a query received from the computer to be allocated to the bid;
a budget constraint on the payment of a total value associated with the bid;
a frequency constraint on the frequency that queries are allocated to the bid;
a joint allocation constraint on the allocation of one or more queries to the bid based on the allocation of said one or more queries to at least one other bid;
a user volume constraint that has at least one prerequisite that must be satisfied as a condition to payment of the value;
a query volume constraint that has at least one prerequisite that must be satisfied as a condition to payment of the value; and
a value-adjustment constraint that has at least one prerequisite that must be satisfied as a condition to adjusting the value.

36. The system of claim 35, further including means for determining a payment associated with a bid is determined based on the value associated with the bid, and a least one of the following: (a) a number of queries allocated to the bid; (b) a value associated with at least one other bid; (c) at least one constraint associated with the bid, wherein the payment associated with the bid includes at least one of the following: a fixed payment, a payment that changes incrementally with each allocation, and a payment that changes in response to satisfaction of the at least one constraint.

37. The method of claim 35, further including means for enabling at least one seller to impose at least one of the following on the sequential allocation of queries to at least one bid:
at least one constraint on at least one attribute of at least one bidder;
at least one constraint on at least one property of a query;
at least one temporal constraint;
at least one volume constraint;
at least one frequency constraint; and
a value for satisfying at least one constraint on the sequence of allocations of queries, wherein each seller is an entity that receives payment in response to allocating queries to bids.

38. The system of claim 34, further including means for determining at least one of the following on the sequential allocation of queries to at least one bid apart from any bid:
at least one constraint on at least one attribute of at least one bidder;
at least one constraint on at least one property of a query;
at least one temporal constraint;
at least one volume constraint;
at least one frequency constraint; and
a value for satisfying at least one constraint on the sequence of allocations of queries.

39. The system of claim 34, wherein the user volume constraint includes the prerequisite that a user of the computer submit a predetermined number of queries, each of which includes at least one word, term, phrase and/or string of characters of a predetermined set of word(s), term(s), phrase(s) and/or string(s) of characters, as a condition of payment of the value.

40. The system of claim 34, wherein the query volume constraint includes the prerequisite that the bid be allocated a number of queries that is greater than, less than and/or equal to a predetermined number of queries or a predetermined percentage of queries received from computers of the computer network as a condition of payment of the value.

41. The system of claim 40, wherein the predetermined percentage of queries are queries in a particular class.

42. The system of claim 40, wherein the query volume constraint further includes the prerequisite that the bid be allocated queries during a predetermined period of time.

43. The system of claim 34, wherein the at least one word, term, phrase or string of characters includes at least one of the following:
a first set of word(s), term(s), phrase(s) and/or string(s) of characters that a query must contain for it to be allocated to the bid;
a second set of word(s), term(s), phrase(s) and/or string(s) of characters that the query may contain for it to be allocated to the bid; and
a third set of word(s), term(s), phrase(s) and/or string(s) of characters that disqualify the query from being allocated to the bid.

44. The system of claim 43, wherein the string(s) of characters of at least one of the first, second and third sets includes a URL.

45. The system of claim 43, wherein the at least one constraint includes a bonus value constraint that prerequisites the payment of a bonus value included in the bid on at least one query allocated to the bid having at least one word, term, phrase and/or string of characters that is also in the second set of word(s), term(s), phrase(s) and/or string(s) of characters.

46. The system of claim 27, wherein:
the at least one rule or decision variable includes at least one of the following parameters:
a budget target for a total payment associated with at least one bid;
a query volume target associated with a predetermined number of queries to be allocated to at least one bid;
a virtual price associated with at least one bid; and
at least one weight associated with at least one bid to adjust a priority assigned to the bid for making an allocation of a query to the bid; and
the allocation is step (d) is made based on an auction for the query that is based on at least one of the parameters.

47. The system of claim 27, wherein:
the at least one rule or decision variable includes at least one rule for allocating a first percentage of the queries to at least one bid of a first set of bids and a second percentage of the queries to at least one bid of a second set of bids;
each bid of the first set of bids requires plural allocations of queries to satisfy its constraint(s);
each bid of the second set of bids requires a single query allocation to satisfy its constraint(s);
step (d) includes allocating the query to either a bid of the first set of bids or a bid of the second set of bids based on the at least one rule for allocating; and
when the query is allocated to a bid of the second set of bids, said allocation is made based on an auction among bids of the second set of bids.

48. The system of claim 27, wherein:
the at least one rule or decision variable includes a plurality of rules for allocating a first percentage of the queries to at least one bid of a first set of bids and a second percentage of the queries to at least one bid of a second set of bids;
each bid of the first set of bids requires plural allocations of queries to satisfy its constraint(s);
each bid of the second set of bids requires a single query allocation to satisfy its constraint(s);
step (d) includes allocating the query to either a bid of the first set of bids or a bid of the second set of bids based on at least one of the plurality of rules, the selection of which is contingent on events caused by allocation(s) occurring after time t and before allocation of the query; and
when the query is allocated to a bid of the second set of bids, said allocation is made based on an auction among bids of the second set of bids.

49. The system of claim 27, wherein:
the at least one rule or decision variable includes at least one of the following:
a value schedule to be associated with a bid that conditions the total value of the bid on the fractional allocation of the total supply of queries, over some period of time;
a value schedule to be associated with a bid that conditions the total value of the bid on the uniform fractional allocation of the total supply of queries, over some period of time; and/or
a value schedule that is contingent on events caused by allocation; and
the allocation is step (d) is made based on at least one of the value schedules.

50. A method of conducting an expressive auction in a dynamic environment comprising:
(a) receiving a plurality of bids via a computer network, wherein each bid is for the right to be allocated units of a supply of a differentiated resource, wherein each bid further includes at least one constraint on a sequential allocation of units of supply to the bid;
(b) determining at a time t at least one rule or decision variable for allocating the units of supply to at least one bid, wherein the at least one rule or decision variable is determined based on bids received before time t and at least one of the following: an estimate of the units of supply to be received after time t; an estimate of events to occur in response to allocation of units of supply after time t; and/or an estimate of bids to be received after time t;
(c) following step (b), receiving one or more units of supply; and
(d) allocating the one or more units of supply received in step (c) to at least one of the bids based on the at least one rule or decision variable.

51. The method of claim 50, further including:
(e) responsive to allocating the one or more units of supply in step (d) and to satisfaction of the at least one constraint, causing an event to occur.

52. The method of claim 50, wherein:
the at least one rule or decision variable includes at least one of the following parameters:
a budget target for a total payment associated with at least one bid;
a query volume target associated with a predetermined number of queries to be allocated to at least one bid;
a virtual price associated with at least one bid; and
at least one weight associated with at least one bid to adjust a priority assigned to the bid for making an allocation of a query to the bid; and
the allocation is step (d) is made based on an auction for the query that is based on at least one of the parameters.

53. The method of claim 50, wherein:
the at least one rule or decision variable includes at least one rule for allocating a first percentage of the queries to at least one bid of a first set of bids and a second percentage of the queries to at least one bid of a second set of bids;
each bid of the first set of bids requires plural allocations of queries to satisfy its constraint;
each bid of the second set of bids requires a single query allocation to satisfy its constraint;
step (d) includes allocating the query to either a bid of the first set of bids or a bid of the second set of bids based on the at least one rule for allocating; and
when the query is allocated to a bid of the second set of bids, said allocation is made based on an auction among bids of the second set of bids.

54. The method of claim 50, wherein:
the at least one rule or decision variable includes a plurality of rules for allocating a first percentage of the queries to at least one bid of a first set of bids and a second percentage of the queries to at least one bid of a second set of bids;
each bid of the first set of bids requires plural allocations of queries to satisfy its constraint;
each bid of the second set of bids requires a single query allocation to satisfy its constraint;
step (d) includes allocating the query to either a bid of the first set of bids or a bid of the second set of bids based on at least one of the plurality of rules, the selection of which is contingent on events caused by allocation(s) occurring after time t and before allocation of the query; and
when the query is allocated to a bid of the second set of bids, said allocation is made based on an auction among bids of the second set of bids.

55. The method of claim 50, wherein:
the at least one rule or decision variable includes at least one of the following:
a value schedule to be associated with a bid that conditions the total value of the bid on the fractional allocation of the total supply of queries, over some period of time;
a value schedule to be associated with a bid that conditions the total value of the bid on the uniform fractional allocation of the total supply of queries, over some period of time; and/or
a value schedule that is contingent on events caused by allocation; and
the allocation is step (d) is made based on at least one of the value schedules.

56. A method of conducting an ad auction comprising:
(a) receiving a plurality of bids via a computer network, wherein each bid is for the right to display at least one advert associated with the bid on at least one display of the computer network, and each bid further includes a constraint on a sequential allocation of the right to display based on context data associated with at least one user accessing the computer network to the bid;
(b) determining at a time t at least one rule or decision variable for allocating the right to display an advert on at least one display associated with the computer network in response to receiving the context data, wherein the at least one rule or decision variable is determined based on the bids received before time t and at least one of the following: an estimate of context data to be received after time t; an estimate of events to occur in response to displaying adverts after time t; and/or an estimate of bids to be received after time t;
(c) following step (b), receiving context data from the computer network; and
(d) allocating the right to display based on the context data received in step (d) and the at least one rule or decision variable.

57. The method of claim 56, further including:
(e) responsive to allocating the right to display in step (d) and to satisfaction of the at least one constraint, causing an advert associated with the bid allocated the right to display to be displayed on the display.

58. The method of claim 56, wherein:
the at least one rule or decision variable includes at least one of the following parameters:
a budget target for a total payment associated with at least one bid;
a query volume target associated with a predetermined number of queries to be allocated to at least one bid;
a virtual price associated with at least one bid; and
at least one weight associated with at least one bid to adjust a priority assigned to the bid for making an allocation of a query to the bid; and
the allocation is step (d) is made based on an auction for the query that is based on at least one of the parameters.

59. The method of claim 56, wherein:
the at least one rule or decision variable includes at least one rule for allocating a first percentage of the queries to at least one bid of a first set of bids and a second percentage of the queries to at least one bid of a second set of bids;
each bid of the first set of bids requires plural allocations of queries to satisfy its constraint;
each bid of the second set of bids requires a single query allocation to satisfy its constraint;
step (d) includes allocating the query to either a bid of the first set of bids or a bid of the second set of bids based on the at least one rule for allocating; and
when the query is allocated to a bid of the second set of bids, said allocation is made based on an auction among bids of the second set of bids.

60. The method of claim 56, wherein:
the at least one rule or decision variable includes a plurality of rules for allocating a first percentage of the queries to at least one bid of a first set of bids and a second percentage of the queries to at least one bid of a second set of bids;
each bid of the first set of bids requires plural allocations of queries to satisfy its constraint;
each bid of the second set of bids requires a single query allocation to satisfy its constraint;
step (d) includes allocating the query to either a bid of the first set of bids or a bid of the second set of bids based on at least one of the plurality of rules, the selection of which is contingent on events caused by allocation(s) occurring after time t and before allocation of the query; and
when the query is allocated to a bid of the second set of bids, said allocation is made based on an auction among bids of the second set of bids.

61. The method of claim 56, wherein:
the at least one rule or decision variable includes at least one of the following:
a value schedule to be associated with a bid that conditions the total value of the bid on the fractional allocation of the total supply of queries, over some period of time;
a value schedule to be associated with a bid that conditions the total value of the bid on the uniform fractional allocation of the total supply of queries, over some period of time; and/or
a value schedule that is contingent on events caused by allocation; and
the allocation is step (d) is made based on at least one of the value schedules.

62. The method of claim 56, wherein the context data includes data regarding at least one of the following:
a location of a user associated with the context data; and
an activity a user associated with the context data is engaged in.

63. A method of conducting an ad auction comprising:
(a) receiving a plurality of bids via a computer network, wherein each bid is for the right to display at least one advert associated with the bid on at least one display of the computer network, and each bid further includes a constraint on a sequential allocation of the right to display based on content data regarding content begin displayed on a display of the computer network and/or being reproduced by an audio device associated with the display to the bid;
(b) determining at a time t at least one rule or decision variable for allocating the right to display an advert on at least one display associated with the computer network in response to receiving the content data, wherein the at least one rule or decision variable is determined based on the bids received before time t and at least one of the following: an estimate of content data to be received after time t; an estimate of events to occur in response to displaying adverts after time t; and/or an estimate of bids to be received after time t;
(c) following step (b), receiving content data from the computer network; and
(d) allocating the right to display based on the content data received in step (d) and the at least one rule or decision variable.

64. The method of claim 63, further including:
(e) responsive to allocating the right to display in step (d) and to satisfaction of the at least one constraint, causing an advert associated with the bid allocated the right to display to be displayed on the display.

65. The method of claim 63, wherein:
the at least one rule or decision variable includes at least one of the following parameters:
a budget target for a total payment associated with at least one bid;
a query volume target associated with a predetermined number of queries to be allocated to at least one bid;
a virtual price associated with at least one bid; and
at least one weight associated with at least one bid to adjust a priority assigned to the bid for making an allocation of a query to the bid; and
the allocation is step (d) is made based on an auction for the query that is based on at least one of the parameters.

66. The method of claim 63, wherein:
the at least one rule or decision variable includes at least one rule for allocating a first percentage of the queries to at least one bid of a first set of bids and a second percentage of the queries to at least one bid of a second set of bids;
each bid of the first set of bids requires plural allocations of queries to satisfy its constraint;
each bid of the second set of bids requires a single query allocation to satisfy its constraint;
step (d) includes allocating the query to either a bid of the first set of bids or a bid of the second set of bids based on the at least one rule for allocating; and
when the query is allocated to a bid of the second set of bids, said allocation is made based on an auction among bids of the second set of bids.

67. The method of claim 63, wherein:
the at least one rule or decision variable includes a plurality of rules for allocating a first percentage of the queries to at least one bid of a first set of bids and a second percentage of the queries to at least one bid of a second set of bids;
each bid of the first set of bids requires plural allocations of queries to satisfy its constraint;
each bid of the second set of bids requires a single query allocation to satisfy its constraint;
step (d) includes allocating the query to either a bid of the first set of bids or a bid of the second set of bids based on at least one of the plurality of rules, the selection of which is contingent on events caused by allocation(s) occurring after time t and before allocation of the query; and
when the query is allocated to a bid of the second set of bids, said allocation is made based on an auction among bids of the second set of bids.

68. The method of claim 63, wherein:
the at least one rule or decision variable includes at least one of the following:
a value schedule to be associated with a bid that conditions the total value of the bid on the fractional allocation of the total supply of queries, over some period of time;
a value schedule to be associated with a bid that conditions the total value of the bid on the uniform fractional allocation of the total supply of queries, over some period of time; and/or
a value schedule that is contingent on events caused by allocation; and
the allocation is step (d) is made based on at least one of the value schedules.

69. The method of claim 63, wherein the context data includes data in at least one of the following:
a search engine query;
an email; and
an article.

70. A bidding language for an ad auction comprising:
at least one query, each query having associated therewith at least one of the following: at least one word, term, phrase or string of characters; time of day; date; and demographic information; and
at least one bid, each bid having associated therewith: at least one advert for display on a display of a computer in response to allocation of at least one query to the bid; a value; and a constraint that prerequisites payment of the value based on satisfaction of a condition associated with the constraint.

71. A user interface for an ad auction displayable on the display of each of a plurality of bidder's computer of a computer network having a server computer, said user interface for enabling a user of the corresponding bidder's computer to create at least one bid for processing by the server computer, the user interface comprising at least one data entry field for:
associating at least one word, term, phrase or string of characters with the bid;
associating with the bid at least one advert for display on the display of a query computer in response to allocation of at least one query received from the query computer to the bid based on the at least one word, term, phrase or string of characters associated with the bid;
associating a value with the bid; and
associating with the bid a constraint on allocation of the bid.
